(19) United States
(12) Patent Application Publication
(10) Pub. No.: US 2005/0187398 A1
(43) Pub. Date: Aug. 25, 2005

(54) Single component cationic palladium proinitiators for the latent polymerization of cycloolefins

(76) Inventors: Andrew Bell, Lakewood, OH (US); Dino Amoroso, Medina, OH (US); John D. Protasiewicz, Cleveland Heights, OH (US); Natesan Thirupathi, Delhi (IN)

Correspondence Address: Nestor W. Shust;Hudak, Shunk & Farine Co. L.P.A., Suite 307, 2020 Front Street, Cuyahoga Falls, OH, 44221, US

(21) Appl. No.: 10/976,350

(22) Filed: Oct. 28, 2004

Related U.S. Application Data
(60) Provisional application No. 60/516,054, filed on Oct. 31, 2003.

(51) Int. Cl. C07F 15/00

(52) U.S. Cl. 556/136

(57) ABSTRACT

Palladium compound compositions are provided in accordance with Formulae [((R)₃E)ₐPd(Q)(LB)_{b}]ₚ [WCA]ᵣ, where ((R)₃E) is a Group 15 electron donor ligand, Q is an anionic ligand, LB is a Lewis base, WCA is a weakly coordinating anion, a is 1, 2 or 3, b is 0, 1 or 2, the sum of a and b is 1, 2 or 3 and each of p and r is an integer such that the molecular charge is zero, or [(E(R)₃)(E(R)₂R*)Pd(LB)]ₚ[WCA]ᵣ where E(R)₂R* represents a Group 15 neutral electron donor ligand and where R* is an anionic hydrocarbyl containing moiety, bonded to the Pd and having a β hydrogen with respect to the Pd center. Such compound composition exhibits latent polymerization activity in the presence of polycyclic olefins.

### CROSS REFERENCE TO RELATED U.S. APPLICATION

This application claims priority to U.S. Provisional Application Ser. No. 60/516,054 entitled “Single Component Cationic Palladium Proinitiators For The Latent Polymerization Of Cycloolefins,” filed Oct. 31, 2003.

### TECHNICAL FIELD

The present invention relates generally to palladium compound compositions useful for forming a polymerization initiator and its stable intermediates and more specifically to cationic palladium proinitiator compositions for forming latent palladium catalyst compositions useful in the polymerization of polycycloolefin monomers.

### BACKGROUND

The prior art contains many disclosures of catalysts that are useful in polymerizing cycloolefin monomers. These disclosures include catalysts encompassing a Group 10 metal cation and a weakly coordinating anion. However such prior art catalysts have certain limitations in their use. For example, they must be prepared in situ and thus immediately act to initiate the polymerization of the monomers present.

U.S. Pat. No. 6,455,650, entitled “Catalyst and Method for Polymerizing Cycloolefins,” is one such prior art reference that discloses catalysts that having a Group 10 metal cation and a weakly coordinating anion. The Group 10 metal cation of the '650 patent contains an anionic hydrocarbyl ligand that is pivotal in the formation of the active catalyst species. The '650 patent discloses various methods of preparing a catalyst having a Group 10 metal complex containing an anionic hydrocarbyl ligand in the presence of a cycloolefin monomer(s) such that the resulting catalytic mixture immediately initiates polymerization of the monomer(s). Thus catalysts prepared in the manner of the '650 patent can not be isolated. In addition, the '650 patent does not suggest that any catalyst disclosed therein may be isolated and used thereafter in polymerizing cycloolefin monomers.

Laid open Japanese Patent Application (Kokai) JP 1996-325329A also discloses catalysts obtained from mixing a Group 10 transition metal compound with an optional triarylphosphine ligand and a co-catalyst. Exemplary co-catalysts include an alkylaluminum, a Lewis acid or a compound to form an ionic complex which includes a weakly coordinating anion (WCA) salt. Specifically, the aforementioned Kokai discloses that a reaction liquid consisting of (a) a liquid monomer(s) to be polymerized, (b) a Group 10 transition metal compound and (c) a co-catalyst are injected into a mold to form an in-mold polymer. Thus, like the '650 patent this publication teaches that an active catalyst is formed in the presence of a cycloolefin monomer (in situ) and that it immediately initiates the polymerization of the monomer(s). Also like the '650 patent, the Kokai does not suggest that the catalyst may be isolated.

In addition to the solution polymerizations disclosed in the '650 patent and in JP 1996-325329A, polymerization of cycloolefins can be accomplished with little or no solvent(s) present. Such polymerizations are often referred to as Mass Polymerizations and are useful for applications such as forming a chip encapsulant. Typically, a mass polymerization system encompasses two parts that are kept separate from one another, where each of the two parts has a catalyst precursor and one or more monomers. When polymerization is desired, the two separate parts are mixed to form the active catalyst species and to immediately begin polymerization of the monomer(s) that are present. Since, unlike a solution polymerization, excess catalyst and/or catalyst precursors cannot be removed, mass polymerization systems require strict formulation parameters to insure that the catalyst components are present in the proper stoichiometric amounts for the efficient polymerization reactions and ideal physical property profiles of the polymer product. In addition, since once the two part system is mixed, the mixture is often dispensed in portions, the “working life” of the mixture for such dispensing can become problematic since the monomer(s) begin(s) to polymerize as soon as the catalyst components are brought together and thus will become too viscous for dispensing.

Therefore, for mass polymerizations, it would be advantageous to have a one part, latent system (i.e., a single component proinitiator in monomer that can be triggered to start substantial polymerization). Such a system would have considerable advantages over currently known two part systems in that they would be easier to use since there would be not requirement for mixing multiple parts and could be dispensed over a longer period of time without significant viscosity change. In addition, such a one part system would not suffer from the attendant difficulties associated with the formulation of two separate parts, errors in mixing those parts just prior to use, and the potentially excessive waste that results when the working life of the mixture expires before the amount mixed is consumed. It should also be apparent that an isolable, latent proinitiator for use in solvent polymerization systems can be advantageous. For example, such an isolable proinitiator could be made in large quantities thus reducing manufacturing costs, and its activity could be determined before its use to initiate a polymerization thereby reducing the cost of the desired polymer by eliminating the need to employ excess initiator to insure the desired conversion ratio. Further, such a single component proinitiator would allow for better control of metered polymerizations. Accordingly, there is a need for such a single component latent proinitiator system to at least provide the advantages mentioned above.

### BRIEF DESCRIPTION OF THE DRAWINGS

Embodiments of the invention are described below with reference to the following accompanying drawings.

FIG. 1 is a representation of suggested mechanisms and reactions for the formation of various triisopropylphosphine derivatives (A, B, C, D, E, F, G, H, and I) in accordance with the present invention; and

FIGS. 2, 3 and 4 are structural representation of palladium complexes in accordance with embodiments in accordance with the present invention.

### DETAILED DESCRIPTION

Exemplary embodiments in accordance with the present invention will be described. Such embodiments are directed to latent, single component, cationic palladium proinitiators useful for solution and/or mass polymerization of cycloolefins. Various modifications, adaptations or variations of such exemplary embodiments described herein may become apparent to those skilled in the art as such are disclosed. It will be understood that all such modifications, adaptations or variations that rely upon the teachings of the present invention, and through which these teachings have advanced the art, are considered to be within the scope and spirit of the present invention.

Embodiments of the present invention encompass latent, single component palladium compositions that have a ligated palladium metal cation and a weakly coordinated anion. Advantageously, it is found that such ligated palladium metal cations with weakly coordinated anions are useful as latent polymerization initiators for cycloolefin monomer compositions. In some embodiments, such ligated palladium metal cations with weakly coordinated anions are useful for forming latent polymerization initiators, such as metalated ligands and hydride palladium cations with weakly coordinating anions. Other exemplary embodiments in accordance with the present invention encompass the preparation of palladium hydride and deuteride materials via the thermolysis of such ligated palladium metal cations and a weakly coordinated anions as well as by appropriate alternate reaction sequences, as will be discussed hereinafter. Some exemplary embodiments of the present invention encompass palladium cations having a Group 15 neutral electron, donor ligand, an anionic ligand, and a weakly coordinated anion. Other exemplary embodiments encompass palladium metal cations having a Group 15 neutral electron donor ligand, an anionic ligand, a Lewis base ligand, and a weakly coordinated anion. Still other exemplary embodiments encompass palladium metal cations having an anionic ligand, a chelated coordinated phosphine ligand, a Lewis base ligand, and a weakly coordinated anion.

Advantageously, the active initiator species of proinitiators in accordance with the present invention are not derived from a neutral hydrocarbyl species. Nor are they derived from any organometallic additive or protonation at the metal center. Rather, without wishing to be bound by any theory, it believed that the active initiator species of such proinitiators are formed via abstraction of an intramolecular hydride, or deuteride, from a supporting Group 15 ligand to generate a desired cationic palladium hydride. Thus, the proinitiators of the present invention are particularly advantageous because they do not have to be formed in situ. Rather, they can be added to a monomer polymerization medium well in advance of polymerization and the intramolecular hydride abstraction started when desired.

Thus, the proinitiators of the invention are latent, that is to say, they are essentially inactive in the presence of a cycloolefin monomer(s) until they are specifically activated. Typically activation is accomplished by subjecting the proinitiator(s) to an energy source. Exemplary energy sources include, but are not limited to, heat (an increase to or above a specific temperature), actinic radiation (but also including x-ray and electron beam radiation) and sonic energy. Furthermore, since the palladium hydride initiator is, as will be described below, a product of a ligand derived metallation step and subsequent elimination sequences, it is possible to extend further initiator latency by utilizing the deuterium kinetic isotope effects to slow down reactivity even further. Additionally, latent intermediates of the proinitiator(s) can be isolated and employed as equivalent species.

Initiator System Description

Proinitiators in accordance with the invention contain a palladium metal cation and a weakly coordinating anion as represented by Formulae Ia and Ib, below:
[(E(R)₃)ₐPd(Q)(LB)_{b}]ₚ[WCA]ᵣ (Ia)
[(E(R)₃)(E(R)₂R*)Pd(LB)]ₚ[WCA]ᵣ (Ib)

In Formula Ia, E(R)₃ represents a Group 15 neutral electron donor ligand where E is selected from a Group 15 element of the Periodic Table of the Elements, and R independently represents hydrogen (or one of its isotopes), or an anionic hydrocarbyl containing moiety; Q is an anionic ligand selected from a carboxylate, thiocarboxylate, and dithiocarboxylate group; LB is a Lewis base; WCA represents a weakly coordinating anion; a represents an integer of 1, 2, or, 3; b represents an integer of 0, 1, or 2, where the sum of a+b is 1, 2, or 3; and p and r are integers that represent the number of times the palladium cation and the weakly coordinating anion are taken to balance the electronic charge on the structure of Formula Ia. In an exemplary embodiment, p and r are independently selected from an integer of 1 and 2.

In Formula Ib, E(R₃) is as defined for Formula Ia, and E(R)₂R* also represents a Group 15 neutral electron donor ligand where E, R, r and p are defined as above and where R* is an anionic hydrocarbyl containing moiety, bonded to the Pd and having a β hydrogen with respect to the Pd center. In an exemplary embodiment, p and r are independently selected from an integer of 1 and 2.

As stated herein, a weakly coordinating anion (WCA) is defined as a generally large and bulky anion capable of delocalization of its negative charge, and which is only weakly coordinated to a palladium cation of the present invention and is sufficiently labile to be displaced by solvent, monomer or neutral Lewis base. More specifically, the WCA functions as a stabilizing anion to the palladium cation but does not transfer to the cation to form a neutral product. The WCA anion is relatively inert in that it is non-oxidizing, non-reducing, and non-nucleophilic.

The importance of WCA charge delocalization depends, to some extent, on the nature of the transition metal comprising the cationic active species. It is advantageous that the WCA either does not coordinate to the transition metal cation, or is one which is only weakly coordinated to such cation. Further, it is advantageous that the WCA not transfer an anionic substituent or fragment to the cation so as to cause it to form a neutral metal compound and a neutral by-product from such transfer. Therefore, useful WCAs in accordance with embodiments of this invention are those which are compatible, stabilize the cation in the sense of balancing its ionic charge, and yet retain sufficient lability to permit displacement by an olefinically unsaturated monomer during polymerization. Additionally, such useful WCAs are those of sufficient molecular size to partially inhibit or help to prevent neutralization of the late-transition-metal cation by Lewis bases other than the polymerizable monomers that may be present in the polymerization process. While not wishing to be bound by any theory, it is believed that the WCAs in accordance with embodiments of the present invention can include anions (listed more to less coordinating), such as trifluoromethanesulfonate (CF₃SO₂⁻), tris(trifluoromethyl)methine ((CF₃SO₂)₃⁻), triflimide, BF₄⁻, BPh₄⁻, PF₆⁻, SbF₆⁻, tetrakis(pentafluorophenyl)borate (herein abbreviated FABA), and tetrakis[3,5-bis(trifluoromethyl)phenyl]borate ([BAr^{f}]⁻). Furthermore, it is believed the catalytic activity of the proinitiators of this invention increases with decreasing coordination of the WCA and that formulation latency increases with increasing coordination of the WCA. Hence, it is believed that in order to obtain a desired balance between catalytic activity and latency, a WCA and ER₃ should be selected in concert with one another.

As stated herein, a neutral electron donor is defined as any ligand which when removed from the palladium metal center in its closed shell electron configuration, has a neutral charge.

As stated herein, an anionic hydrocarbyl moiety is defined as any hydrocarbyl group which when removed from ‘E’ (see Formulae Ia) in its closed shell electron configuration, has a negative charge.

As stated herein, a Lewis base is defined as “a basic substance furnishing a pair of electrons for a chemical bond,” hence it is a donor of electron density.

In embodiments in accordance with the present invention, E is selected from a Group 15 element of the Periodic Table of the Elements and, more specifically, phosphorus (P), arsenic (As), antimony (Sb), and bismuth (Bi). In Formula Ia, the anionic hydrocarbyl containing moiety R is independently selected from, but not limited to, H, linear and branched (C₁-C₂₀)alkyl, (C₃-C₁₂)cycloalkyl, (C₂-C₁₂)alkenyl, (C₃-C₁₂)cycloalkenyl, (C₅-C₂₀)polycycloalkyl, (C₅-C₂₀)polycycloalkenyl, and (C₆-C₁₂)aryl, and two or more R groups taken together with E can form a heterocyclic or heteropolycyclic ring containing 5 to 24 atoms. In Formula Ib, the anionic hydrocarbyl containing moiety R* is selected from, but not limited to, linear and branched (C₂-C₂₀) alkyl, (C₃-C₁₂) cycloalkyl, (C₂-C₁₂) alkenyl, (C₃-C₁₂) cycloalkenyl, (C₅-C₂₀) polycycloalkyl, (C₅-C₂₀) polycycloalkenyl with the proviso that such anionic hydrocarbyl containing moiety, when bonded to the Pd, will have at least one β hydrogen with respect to the Pd center.

Representative alkyl groups include, but are not limited to, methyl, ethyl, propyl, isopropyl, n-butyl, isobutyl, sec-butyl, tert-butyl, pentyl, and neopentyl. Representative alkenyl groups include, but are not limited to, vinyl, allyl, iso-propenyl, and iso-butenyl. Representative cycloalkyl groups include, but are not limited to, cyclopropyl, cyclobutyl, cyclopentyl, cyclohexyl, cycloheptyl, and cyclooctyl. Representative polycycloalkyl groups include, but are not limited to, norbornyl and adamantyl. Representative polycycloalkenyl groups include, but are not limited to, norbornenyl and adamantenyl. Representative aryl and aralkyl groups include, but are not limited to, phenyl, naphthyl, and benzyl.

In some exemplary embodiments of the present invention, the Group 15 neutral electron donor ligand is a phosphine ligand. Advantageous exemplary phosphine ligands include di-t-butylcyclohexylphosphine, dicyclohexyl-t-butylphosphine, tricyclohexylphosphine, tricyclopentylphosphine, dicyclohexyladamantylphosphine, cyclohexyldiedamantylphosphine, triisopropylphosphine, di-tert-butylisopropylphosphine, and diisopropyl-tert-butylphosphine.

Exemplary phosphine ligands also include tri-n-propylphosphine, tri-t-butylphosphine, di-n-butyladamantylphosphine, dinorbornylphosphine t-butyldiphenylphosphine, isopropyldiphenylphosphine, dicyclohexylphenylphosphine, di-tert-butylisopropylphosphine, diisopropyl-tert-butylphosphine, di-tert-butylneopentylphosphine, and dicyclohexylneopentylphosphine.

And still other exemplary phosphine ligands include, but are not limited to, trimethylphosphine, triethylphosphine, tri-i-propylphosphine, tri-n-butylphosphine, tri-sec-butylphosphine, tri-i-butylphosphine, tricyclopropylphosphine, tricyclobutylphosphine, tricycloheptylphosphine, isopropylenyldi(isopropyl)phosphine, cyclopentenyldi(cyclopropenyl)phosphine, cyclohexenyldi(cyclohexyl)phosphine, triphenylphosphine, trinaphthylphosphine, tribenzylphosphine, benzyldiphenylphosphine, di-n-butyladamantylphosphine, allyldiphenylphosphine, vinyldiphenylphosphine, cyclohexyldiphenylphosphine, di-t-butylphenylphosphine, diethylphenylphosphine, dimethylphenylphosphine, diphenylpropylphosphine, ethyldiphenylphosphine, tri-n-octylphosphine, tribenzylphosphine, 4,8-dimethyl-2-phosphabicyclo[3.3.1]nonane and 2,4,6-tri-i-propyl-1,3-dioxa-5-phosphacyclohexane.

In other exemplary embodiments of the invention, the Group 15 neutral electron donor ligand is an arsine ligand. Advantageous exemplary arsine ligands include tricyclohexylarsine, tricyclopentylarsine, di-t-butylcyclohexylarsine, dicyclohexyl-t-butylarsine, triisopropylarsine, di-tert-butylisopropylarsine, and diisopropyl-tert-butylarsine.

Exemplary arsine ligands also include dicyclohexyladamantylarsine, cyclohexyldiadamantylarsine, di-n-butyladamantylarsine, dinorbornylarsine t-butyidiphenylarsine, isopropyldiphenylarsine, dicyclohexylphenylarsine, and dicyclohexylneopentylarsine.

And still other exemplary arsine ligands include, but are not limited to, trimethylarsine, triethylarsine, tri-n-propylarsine, tri-isopropylarsine, tri-n-butylarsine, tri-sec-butylarsine, tri-i-butylarsine, tri-t-butylarsine, tricyclopropylarsine, tricyclobutylarsine, tricycloheptylarsine, isopropylenyldi(isopropyl)arsine, cyclopentenyldi(cyclopropenyl)arsine, cyclohexenyldi(cyclohexyl)arsine, triphenylarsine, trinaphthylarsine, tribenzylarsine, benzyldiphenylarsine, allyldiphenylarsine, vinyldiphenylarsine, cyclohexyldiphenylarsine, di-t-butylphenylarsine, diethylphenylarsine, dimethylphenylarsine, diphenylpropylarsine, ethyldiphenylarsine, tri-n-octylarsine, tribenzylarsine, di-t-butylisopropylarsine, diisopropyl-tert-butylarsine, and di-tert-butylneopentylarsine.

In still other exemplary embodiments of the invention, the Group 15 neutral electron donor ligand is a stibine ligand. Advantageous exemplary stibine ligands include tricyclohexylstibine, di-t-butylcyclohexylstibine, cyclohexyldi-t-butylstibine, triisopropylstibine, di-t-butylisopropylstibine, and diisopropyl-t-butylstibine.

Exemplary stibine ligands also include dicyclohexyladamantylstibine, cyclohexyldiadamantylstibine, dicyclohexyl-t-butylstibine, dinorbornylstibine, t-butyldistibine, isopropyldiphenylstibine, dicyclohexylphenylstibine, and dicyclohexylneopentylstibine.

And still other exemplary stibine I ligands include, but are not limited to, trimethylstibine, triethylstibine, tri-n-propylstibine, tri-isopropylstibine, tri-n-butylstibine, tri-sec-butylstibine, tri-i-butylstibine, tri-t-butylstibine, tricyclopropylstibine, tricyclobutylstibine, tricyclopentylstibine, tricycloheptylstibine, isopropylenyldi(isopropyl)stibine, cyclopentenyldi(cyclopropenyl)stibine, cyclohexenyldi(cyclohexyl)stibine, triphenylstibine, trinaphthylstibine, tribenzylstibine, benzyldiphenylstibine, di-n-butyladamantylstibine, dinorbornylstibine t-butyldiphenylstibine, allyldiphenylstibine, vinyldiphenylstibine, cyclohexyldiphenylstibine, di-t-butylphenylstibine, diethylphenylstibine, dimethylphenylstibine, diphenylpropylstibine, ethyldiphenylstibine, tri-n-octylstibine, tribenzylstibine, di-tert-butylisopropylstibine, diisopropyl-tert-butylstibine, and di-tert-butylneopentylstibine.

In yet other exemplary embodiment of the invention, the Group 15 neutral electron donor ligand is a bismuthine ligand. Advantageous exemplary bismuthine ligands include tricyclohexylbismuthine and diisopropyl-tert-butylbismuthine.

Exemplary bismuthine ligands also include dicyclohexyladamantylbismuthine, cyclohexyldiadamantylbismuthine, dicyclohexyl-t-butylbismuthine, dinorbornylbismuthine, t-butyldibismuthine, isopropyldiphenylbismuthine, dicyclohexylphenylbismuthine, di-tert-butylisopropylbismuthine, diisopropyl-tert-butylbismuthine, and dicyclohexylneopentylbismuthine.

And still other exemplary bismuthine ligands include, but are not limited to, trimethylbismuth, triethylbismuth, tri-n-propylbismuth, tri-i-propylbismuth, tri-n-butylbismuth, tri-sec-butylbismuth, tri-i-butylbismuth, tri-t-butylbismuth, di-t-butylcyclohexylbismuth, dicyclohexyl-t-butylbismuth, tricyclopropylbismuth, tricyclobutylbismuth, tricyclopentylbismuth, tricyclohexylbismuth, tricycloheptylbismuth, isopropylenyldi(isopropyl)bismuth, cyclopentenyldi(cyclopropenyl)bismuth, cyclohexenyldi(cyclohexyl)bismuth, triphenylbismuth, trinaphthylbismuth, tribenzylbismuth, benzyldiphenylbismuth, dicyclohexyladamantylbismuth, cyclohexyldiadamantylbismuth, di-n-butyladamantylbismuth, dinorbornylbismuth t-butyldiphenylbismuth, allyldiphenylbismuth, vinyldiphenylbismuth, cyclohexyldiphenylbismuth, di-t-butylphenylbismuth, diethylphenylbismuth, dimethylphenylbismuth, diphenylpropylbismuth, ethyldiphenylbismuth, tri-n-octylbismuth, i-propyldiphenylbismuth, dicyclohexylphenylbismuth, tribenzylbismuth, di-tert-butylisopropylbismuth, diisopropyl-tert-butylbismuth, di-tert-butylneopentylbismuth, dicyclohexylneopentylbismuth, tris(4-methoxyphenyl)bismuth, tris(2-methylphenyl)bismuthine, and tris(4-fluorophenyl)bismuthine.

Exemplary Group 15 neutral electron donor ligands (ER₃) have been provided for embodiments in accordance with the present invention. However, the scope of the invention is not limited to such exemplary ligands as it is believed that the selection of advantageous ER₃ moieties can be understood in terms of three general concepts. These concepts are (1) ER₃ steric factors, (2) ER₃ electronic factors, and (3) hydrocarbyl metalation ability.

The common Tolman steric model deals with cone angle, θ, (a measure of the degree of the filling of a coordination sphere by a ligand) having values typically in the range of 100° to 185°. It is believed that the Tolman model, and specifically cone angle, applies equally well to P, As, Sb, and Bi as an effective way of predicting the catalytic activity of compounds in accordance with Formulae Ia and Ib. It is further believed that for embodiments of the present invention, the cone angle value for the ER₃ should be greater than 140° and that for some embodiments having a cone angle from 160° to 170° is advantageous and for other embodiments a cone angle of 170° or higher is particularly advantageous. It should be noted that a cone angle of 180° indicates that the ligand effectively protects (or covers) one half of the coordination sphere of the metal complex

Referring now to electronic factors, it is believed that the electronic donating ability (sigma (σ) and pi (π)) of the ligand relates to the reactivity of proinitiators in accordance with Formulae Ia and Ib. A number of different analytical methods can be used to access the electronic character of ER₃, these include the Tolman electronic parameter (X). pKₐ values of the conjugate acids of ER₃, viz., [ER₃H]⁺, molecular calculation methods such as molecular electrostatic potential minimum (V₍ₘᵢₙ₎, a quantitative measure of the sigma-donating ability of E), calorimetric measurements of binding affinity, for example Ni(CO)₃+PR₃→Ni(CO)₃(PR₃), and standard reduction potential as well as the enthalpy change corresponding to the electrochemical couple η-Cp(CO)(PR₃)(COMe)Fe⁺/η-Cp(CO)(PR₃)(COMe)Fe⁰. By means of example, for embodiments of the present invention where E=P, by employing the Tolman electronic parameter (X) as a metric, we believe [symbol] useful to employ an ER₃ moiety whose the ν_{co} symmetric (A₁) stretching band frequency of the nickel complex LNi(CO)₃ is lower than 2068 cm⁻¹, and advantageous when the value is in the range of 2060 to 2055 cm⁻¹, and, most advantageous, when lower than 2055 cm⁻¹. It is believed that the other analytical methods are related either directly or proportionally to the Tolman electronic parameter and thus, may be employed in generating proinitiators and initiators, in accordance with the present invention, thave have a desired level of activity.

In addition to combining the predictive electronic and steric components of the ER₃ as a way of estimating catalytic activity, it is also believed that certain hydrocarbyl groups can more readily metalate the palladium center than other groups, and that of these certain hydrocarbyl groups, some more readily undergo β-hydride elimination than others. Thus, by appropriately selecting the hydrocarbyl groups for ER₃, metalation of the Pd center and subsequent β-hydride elimination to generate a palladium hydride initiator can be controlled, or at least tailored for a specific level of reactivity. By way of example, triisopropylphosphine is more advantageous than diisopropylmethylphosphine which is more advantageous than isopropyldimethylphosphine.

In embodiments in accordance with the present invention, it can be advantageous for E(R)₃ to have some of the hydrogen of R (either R═H or R=hydrocarbyl) replaced with deuterium. When hydrogen in a reactant molecule is replaced by deuterium, there is often a change in reaction rate since the complete dissociation of a deuterium requires more energy than that for a corresponding hydrogen bond in the same environment. Such changes are known as deuterium isotope effects and can be expressed by the ratio kₕ/k_{d,} where kₕ and k_{d} are the dissociation rate constants for hydrogen and deuterium, respectively. The impact of isotopic substitution is to decrease the rate of the reaction for the more massive isotope, therefore slowing the rate of formation of the palladium hydride/deuteride, since a bond involving that isotope is involved in the rate determining step of palladium hydride formation and the Pd—H bond in the isotopically exchanged atom is stronger in the initiator in the transition state for polymerization. In one proposed, non-limiting mechanism, the rate determining step involves the dissociation of a carbon-hydrogen bond and therefore shows a significant deuterium isotope effect and the rate of polymerization, i.e., latency will be improved since the rate of initiation versus propagation will also be slowed. Deuterium isotope effects usually range from 1 (no isotope effect) to about 8, though in some cases, larger or smaller values have been reported. Thus, the use of such an isotopic substitution can be useful for improving reaction latency while the basic chemical identity (electronic configuration) and basic reactivity of the molecule is preserved.

As stated herein, the term deuterium isotope effect refers to both primary and secondary isotopic effects; the induced latency may occur from the substituting deuterium for hydrogen adjacent to the position of C—H bond breaking, thus slowing the reaction. The substitution of tritium for hydrogen gives even larger isotope effects therefore such tritium substituted initiators would be more latent than deuterium substituted initiators.

Representative examples of deuterated E(R)₃ include both perdeuterated and partially deuterated species. Exemplary perdeuterated species are E(d₇-C₃H₇)₃ and E(d₁₁-C₆H₁₁)₃; and partially deuterated species are E(d₁-C₃H₇)₃, E(d₁-C₆H₁₁)₃, and E(d₄-C₆H₁₁)₃, where E is selected from P, As, Sb, and Bi. Structural formulae of exemplary phosphorus containing species are shown as Structures A, below:

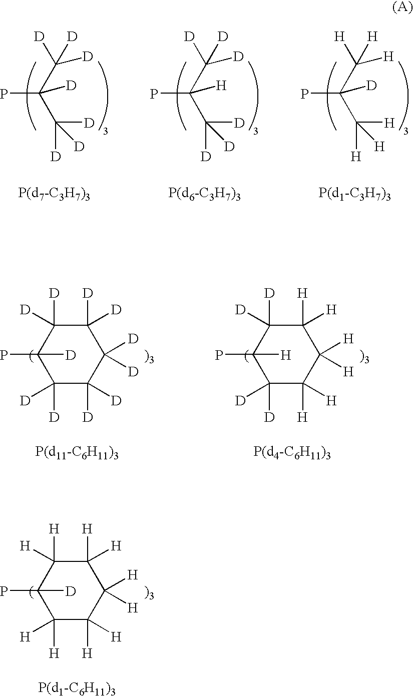

Referring again to Formula Ia, when a is 2, and E is phosphorus, two phosphine groups can be taken together to form a diphosphine chelating ligand. Exemplary diphosphine chelating ligands include, but are not limited to, bis(dicyclohexylphosphino)methane;
1,2-bis(dicyclohexylphosphino)ethane;
1,3-bis(dicyclohexylphosphino)propane;
1,4-bis(dicyclohexylphosphino)butane;
1,5-bis(dicyclohexylphosphino)pentane;
1,2-bis(di-isopropylphosphino)ethane;
1,3-bis(di-isopropylphosphino)propane; and
1,4-bis(di-isopropylphosphino)butane.

As mentioned with respect to Formula Ia, above, Q is an anionic ligand selected from a carboxylate, thiocarboxylate, and dithiocarboxylate group. Such ligands, in combination with the palladium metal center, can be unidentate, symmetric bidentate, asymmetric chelating bidentate, asymmetric bridging, or symmetric bridging. Representative structural representations include, but are not limited to, the following schematic Structures B, below: 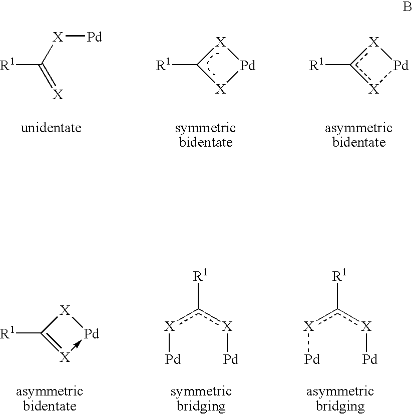
where X independently is oxygen or sulfur and R¹ is selected from hydrogen, linear and branched C₁-C₂₀ alkyl, C₁-C₂₀ haloalkyl, substituted and unsubstituted C₃-C₁₂ cycloalkyl, substituted and unsubstituted C₂-C₁₂ alkenyl, substituted and unsubstituted C₃-C₁₂ cycloalkenyl, substituted and unsubstituted C₅-C₂₀ polycycloalkyl, substituted and unsubstituted C₆-C₁₄ aryl, and substituted and unsubstituted C₇-C₂₀ aralkyl. As used here and throughout, the term haloalkyl means that at least one hydrogen atom on the alkyl group is replaced with a halogen atom selected from fluorine, chlorine, bromine, iodine, and combinations thereof. The degree of halogenation can range from at least one hydrogen atom on the alkyl radical being replaced by a halogen atom (e.g., a monofluoromethyl group) to full halogenation (e.g., perhalogenation) where all hydrogen atoms on the alkyl group have been replaced by a halogen atom.

As used herein, substituted is understood to mean that the substituted radical or substituent can contain one or more moieties selected from linear and branched C₁-C₅ alkyl, C₆-C₁₄ aryl, and a halogen atom selected from fluorine, chlorine, bromine, iodine, and combinations thereof. The forgoing moieties can also be substituted in the manner just described. Exemplary R¹ radicals are methyl, trifluoromethyl, propyl, iso-propyl, butyl, tert-butyl, isobutyl, neopentyl, cyclohexyl, norbornyl, adamantyl, phenyl, pentafluorophenyl, and benzyl. Advantageous exemplary anionic ligands include acetate (CH₃CO₂⁻) and Me₃CCO₂⁻. Other exemplary anionic ligands include CF₃CO₂⁻, C₆H₅CO₂⁻, C₆H₅CH₂CO₂⁻, and C₆F₅CO₂⁻. And still others include, but are not limited to, thioacetate (CH₃C(S)O⁻), dithioacetate (CH₃C(S)₂⁻), CF₃C(S)O⁻, CF₃C(S)₂⁻, Me₃CC(S)O⁻, Me₃CC(S)₂⁻, C₆H₅C(S)O⁻, C₆H₅C(S)₂⁻, C₆H₅CH₂(S)O⁻, C₆H₅CH₂(S)₂⁻, C₆F₅C(S)O⁻, and C₆F₅C(S)₂⁻. 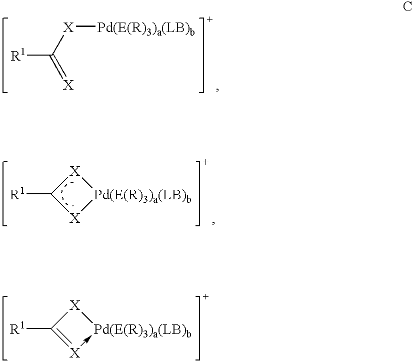
In symmetric and asymmetric bridging embodiments in accordance with the present invention, palladium proinitiator cations can exist as dimers. Representative structural representations include, but are not limited to, schematic Structures D, below: 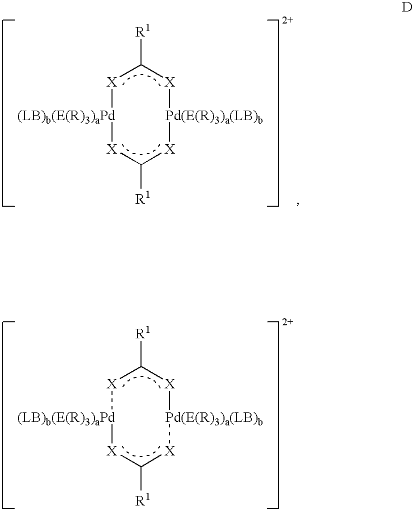
In the foregoing structures R, E, LB are as previously defined with respect to Formula I and R¹, and X are as defined with respect to Structures B.

Lewis base ligands in accordance with the present invention can be any compound that donates an electron pair. Exemplary Lewis base are water or are one of the following type of compounds: alkyl ethers, cyclic ethers, aliphatic or aromatic ketones, alcohols, amines, imines, amides, isocyanates, nitriles, isonitriles, cyclic amines especially pyridines and pyrazines, and trialkyl or triaryl phosphites.

More specifically, advantageous exemplary Lewis base ligands include acetonitrile, pyridine, 2,6-dimethylpyridine, 2,6-dimethylpyrazine, and pyrazine. Other exemplary Lewis base ligands include water, dimethyl ether, diethyl ether, tetrahydrofuran, benzonitrile, tert-butylnitrile, tert-butylisocyanide, xylylisocyanide, 4-dimethylaminopyridine, tetramethylpyridine, 4-methylpyridine, tetramethylpyrazine, triisopropylphosphite, triphenylphosphite, and triphenylphosphine oxide. And still others include, but are not limited to, dioxane, acetone, benzophenone, acetophenone, methanol, isopropanol, triethylamine, dimethylaniline, N-neopentylidene methylamine, 1,1-dimethyl-N-neopentylidene ethylamine, N-methyltrimethylacetamide, N-methyl-cyclohexanecarboxamide, dimethylaminopyridine, tetramethylpyrazine, and triphenylphosphite. Phosphines can also be included as exemplary Lewis bases so long as they are added to the reaction medium during the formation of the single component proinitiator of the invention. Examples of Lewis base phosphines include, but are not limited to, triisopropylphosphine, tricyclohexylphosphine, tricyclopentylphosphine, and triphenylphosphine.

Still referring to Formulae Ia and Ib, the WCA is selected from triflimide, borate and aluminate anions. Where such WCA is a triflimide it is represented by Formula II, below
N(S(O)₂R)₂³¹ II
and where such WCA is a borate or an aluminate, it is represented by Formulae III and IV below:
[M(R¹⁰)(R¹¹)(R¹²)(R¹³)]⁻ III
[M(OR¹⁴)(R¹⁵)(R¹⁶)(R¹⁷)]⁻ IV

Turning first to Formula II, R is as defined previously in Formula Ia and representative triflimides include but are not limited to bis(trifluoromethylsulfonyl)imide, triflimide ([N(S(O)₂C₄F₉)₂]⁻), bis(pentafluoroethanesulfonyl)imide ([N(S(O)₂C₂F₅)₂]⁻), and 1,1,2,2,2-pentafluoroethane-N-[(trifluoromethyl)sulfonyl]sulfonamide ([N(S(O)₂CF₃)(S(O)₂C₄F₉)]⁻). Alternatively, the WCA can be tris(trifluoromethanesulfonyl)methane anion ([C(S(O)₂CF₃)₃]⁻)

Turning now to Formula III, M is boron or aluminum and R¹⁰, R¹¹, R¹², and R¹³ independently represent fluorine, linear and branched C₁-C₁₀ alkyl, linear and branched C₁-C₁₀ alkoxy, linear and branched C₃-C₅ haloalkenyl, linear and branched C₃-C₁₂ trialkylsiloxy, C₁₈-C₃₆ triarylsiloxy, substituted and unsubstituted C₆-C₃₀ aryl, and substituted and unsubstituted C₆-C₃₀ aryloxy groups where R¹⁰ to R¹³ can not simultaneously represent alkoxy or aryloxy groups. When R¹⁰ to R¹³ is selected from a substituted aryl or aryloxy group, such group can be monosubstituted or multisubstituted, wherein the substituents are independently selected from linear and branched C₁-C₅ alkyl, linear and branched C₁-C₅ haloalkyl, linear and branched C₁-C₅ alkoxy, linear and branched C₁-C₅ haloalkoxy, linear and branched C₁-C₁₂ trialkylsilyl, C₆-C₁₈ triarylsilyl, and halogen selected from chlorine, bromine, iodine and fluorine.

Advantageous exemplary borate anions include tetrakis(pentafluorophenyl)borate and tetrakis(3,5-bis(trifluoromethyl)phenyl)borate. Other exemplary borate anions include tetrakis(2,3,4,5-tetrafluorophenyl)borate, tetrakis(3,4,5,6-tetrafluorophenyl)borate, tetrakis(1,2,2-trifluoroethylenyl)borate, tetrakis(4-tri-i-propylsilyltetrafluorophenyl)borate, tetrakis(4-dimethyl-tert-butylsilyltetrafluorophenyl)borate, (tetrakis[3,5-bis[1-methoxy-2,2,2-trifluoro-1-(trifluoromethyl)ethyl]phenyl]borate, tetrakis[3-[1-methoxy-2,2,2-trifluoro-1-(trifluoromethyl) ethyl]-5-(trifluoromethyl)phenyl]borate, and tetrakis[3-[2,2,2-trifluoro-1-(2,2,2-trifluoroethoxy)-1-(trifluoromethyl) ethyl]-5-(trifluoromethyl)phenyl]borate.

Yet other borate anions include, but are not limited to, tetrakis(2-fluorophenyl)borate, tetrakis(3-fluorophenyl)borate, tetrakis(4-fluorophenyl)borate, tetrakis(3,5-difluorophenyl)borate, tetrakis(3,4,5-trifluorophenyl)borate, methyltris(perfluorophenyl)borate, ethyltris(perfluorophenyl)borate, phenyltris(perfluorophenyl)borate, (triphenylsiloxy)tris(pentafluorophenyl)borate, (octyloxy)tris(pentafluorophenyl)borate, tetrakis[3,5-bis[1-methoxy-2,2,2-trifluoro-1-(trifluoromethyl)ethyl]phenyl]borate, and tetrakis[3-[1-methoxy-2,2,2-trifluoro-1-(trifluoromethyl)ethyl]-5-(trifluoromethyl)phenyl]borate.

Advantageous exemplary aluminate anions encompassed by Formula III are tetrakis(pentafluorophenyl)aluminate and tetrakis(3,5-bis(trifluoromethyl)phenyl)aluminate. Other exemplary aluminate anions include, but are not limited to, tris(perfluorobiphenyl)fluoroaluminate, (octyloxy)tris(pentafluorophenyl)aluminate, and methyltris(pentafluorophenyl)aluminate.

Referring now to Formula IV, M is boron or aluminum and R¹⁴, R¹⁵, R¹⁶, and R¹⁷ independently represent linear and branched C₁-C₁₀ alkyl, linear and branched C₁-C₁₀ haloalkyl, C₂-C₁₀ haloalkenyl, substituted and unsubstituted C₆-C₃₀ aryl, and substituted and unsubstituted C₇-C₃₀ aralkyl groups, subject to the proviso that at least three of R¹⁴ to R¹⁷ must contain a halogen containing substituent. When R¹⁴ to R¹⁷ is selected from a substituted aryl or aryloxy group, such group can be monosubstituted or multisubstituted, wherein the substituents are independently selected from linear and branched C₁-C₅ alkyl, linear and branched C₁-C₅ haloalkyl, linear and branched C₁-C₅ alkoxy, linear and branched C₁-C₁₀ haloalkoxy, and halogen selected from chlorine, bromine, and fluorine. The groups OR¹⁴ and OR¹⁵ can be taken together to form a chelating substituent represented by —O—R¹⁸—O—, wherein the oxygen atoms are bonded to M and R¹⁸ is a divalent radical selected from substituted and unsubstituted C₆-C₃₀ aryl and substituted and unsubstituted C₇-C₃₀ aralkyl. In an embodiment of the invention, the oxygen atoms are bonded, either directly or through an alkyl group, to the aromatic ring in the ortho or meta position. When substituted the aryl and aralkyl groups can be monosubstituted or multisubstituted, wherein the substituents are independently selected from linear and branched C₁-C₅ alkyl, linear and branched C₁-C₅ haloalkyl, linear and branched C₁-C₅ alkoxy, linear and branched C₁-C₁₀ haloalkoxy, and halogen selected from chlorine, bromine, and fluorine.

Representative structures of divalent R¹⁸ radicals are illustrated in Structures E below: 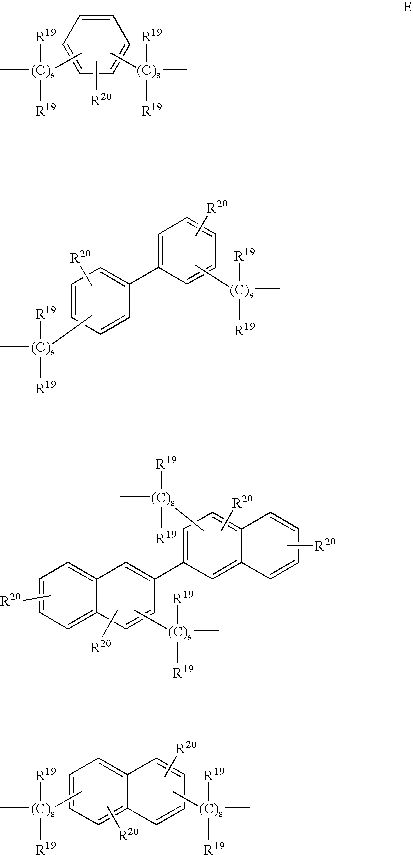
where R¹⁹ independently represents hydrogen, linear and branched C₁-C₅ alkyl, linear and branched C₁-C₅ haloalkyl, and halogen selected from chlorine, bromine, and fluorine; R²⁰ can be a monosubstituent or taken up to four times about each aromatic ring depending on the available valence on each ring carbon atom and independently represents hydrogen, linear and branched C₁-C₅ alkyl, linear and branched C₁-C₅ haloalkyl, linear and branched C₁-C₅ alkoxy, linear and branched C₁-C₁₀ haloalkoxy, and halogen selected from chlorine, bromine, and fluorine; and s independently represents an integer from 0 to 6. It should be recognized that when s is 0 the oxygen atom in the formula —O—R¹⁸—O— is bonded directly to a carbon atom in the aromatic ring represented by R¹⁸. In the above divalent structural formulae the oxygen atom(s) i.e., when s is 0, and the methylene or substituted methylene group(s), —(C(R¹⁹)₂)ₛ—, are advantageously located on the aromatic ring in ortho or meta positions. Representative chelating groups of the formula —O—R¹⁸—O— include, but are not limited to, are 2,3,4,5-tetrafluorobenzenediolate (—OC₆F₄O—), 2,3,4,5-tetrachlorobenzenediolate (—OC₆Cl₄O—), 2,3,4,5-tetrabromobenzenediolate (—OC₆Br₄O—), and bis(1,1′-bitetrafluorophenyl-2,2′-diolate).

Advantageous exemplary aluminate anions include [Al(OC(CF₃)₂Ph)₄]⁻, [Al(OC(CF₃)₂C₆H₄CH₃)₄]⁻, [Al(OC(CF₃)₂C₆H₄-4-t-butyl)₄]⁻, [Al(OC(CF₃)₂C₆H₃-3,5-(CF₃)₂)₄]⁻, [Al(OC(CF₃)₂C₆H₂-2,4,6-(CF₃)₃)₄]⁻, and [Al(OC(CF₃)₂C₆F₅)₄]⁻. Exemplary borate and aluminate anions include, but are not limited to, [Al(OC(CF₃)₃)₄]⁻, bis[3,4,5,6-tetrafluoro-1,2-benzenediolato-κO, κO′]borate ([B(O₂C₆F₄)₂]⁻), [B(OC(CF₃)₃)₄]⁻, [B(OC(CF₃)₂(CH₃))₄]⁻, [B(OC(CF₃)₂H)₄]⁻, [B(OC(CF₃)(CH₃)H)₄]⁻, [B(O₂C₆F₄)₂]⁻, [B(OCH₂(CF₃)₂)₄]⁻, [Al(OC(CF₃)₃)₄]⁻, [Al(OC(CF₃)(CH₃)H)₄]⁻, [Al(OC(CF₃)₂H)₄]⁻, [Al(OC(CF₃)₂C₆H₄-4-i-Pr)₄]⁻, [Al(OC(CF₃)₂C₆H₄-4-SiMe₃)₄]⁻, [Al(OC(CF₃)₂C₆H₄-4-Si-i-Pr₃)₄]⁻, and [Al(OC(CF₃)₂C₆H₂-2,6-(CF₃)₂-4-Si-i-Pr₃)₄]⁻.

Thermolysis of Palladium Proinitiator

Generation of Reactive Intermediates and Palladium Hydride

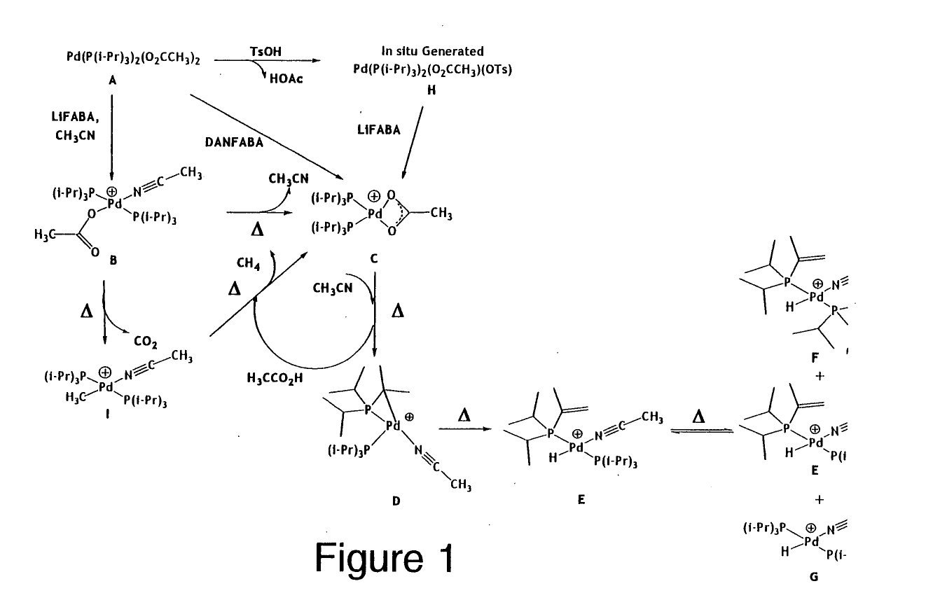

Referring to FIG. 1, a suggested mechanism for the formation of the various triisopropylphosphine derivatives (A, B, C, D, E, F, G, H, and I) of the present invention is presented. The single component proinitiator B is shown as being obtained by reacting a palladium complex A containing a Group 15 electron donating ligand, triisopropylphosphine, and an acetate ligand with a WCA salt, LiFABA etherate ([Li(OEt₂)_{2.5}][FABA]) and a Lewis base, acetonitrile. The single component proinitiaor C is shown being obtained by reacting palladium complex A with DANFABA. Thus in the presence of a Lewis base, proinitiator B is obtained and in the absence of a Lewis base proinitiator C is obtained. It is further believed that the original monodentate carboxylate ligand B is transformed into the kappa (κ) (bidentate) configuration of C upon adding heat and loss of Lewis base. What are believed to be proinitiator embodiments B and C are each isolable and each exhibits latent polymerization activity. Alternatively, as shown in FIG. 1, proinitiator complex C can be obtained by reacting palladium complex A with p-toluene sulfonic acid to form in situ complex H, where the tosylate anion has replaced an acetate ligand. Then, when complex H is reacted with LiFABA etherate, proinitiator C is obtained.

It is believed that proinitiator C is converted under thermolysis conditions and via the loss of acetic acid to yield the ligand metalated specie D, as shown. What is believed to be metalated specie D has also been isolated and under the appropriate activation conditions, i.e., heat, transformed into what is believed to be a cationic palladium hydride initiator complex, trialkylphosphine(bisalkylalkenyl)phosphine-palladium(acetonitrile)hydride, shown as E in FIG. 1. Initiator complex E, undergoes a disproportionation reaction that is believed to lead to a scrambling of the two types (saturated and unsaturated) of phosphine species at the metal centers to yield three derivatives of the cationic palladium hydride complex, the original complex E and species F and G, as shown.

Alternatively, under the appropriate activation temperature and in the presence of a Lewis base, it is believed that proinitiator B can undergo a thermolysis reaction wherein the carboxylate anion decarboxylates, (i.e., loss of CO₂), to form an active palladium hydrocarbyl (e.g., R¹=methyl) catalyst specie, depicted as I in FIG. 1. It is further believed that the active catalyst specie I can undergo further thermolysis rearrangement losing the hydrocarbyl ligand (e.g., methane) to give an active hydride initiator (not depicted). In addition, it is thought that under certain reaction conditions, specie I can re-enter the hydride formation sequence via a protonation of the palladium-methyl functionality by in situ formed acetic acid and generate proinitiator C.

Palladium Initiator Complex Preparation

Palladium complexes containing Group 15 electron donor ligands are obtainable commercially or can be synthesized via well-known synthesis routes. In one such synthesis route, a palladium compound of the formula Pd(Q)₂ is allowed to react with a Group 15 electron donor compound of the formula E(R)₃ in an inert solvent and at an appropriate temperature to form a palladium complex of the formula Pd(Q)₂(E(R)₃)₂, where Q, E, and R are as previously defined for Formula 1a. Exemplary palladium complexes of the formula Pd(Q)₂(E(R)₃)₂ are selected from, but not limited to, Pd(OAc)₂(P(i-Pr)₃)₂, Pd(OAc)₂(P(Cy)₃)₂, Pd(O₂C-t-Bu)₂(P(Cy)₃)₂, Pd(OAc)₂(P(Cp)₃)₂, Pd(O₂CCF₃)₂(P(Cy)₃)₂, Pd(O₂CPh)₂(PCy₃)₂, Pd(OAc)₂(As(i-Pr)₃)₂, and Pd(OAc)₂(As(Cy)₃)₂. In addition, Pd(OAc)₂(Sb(Cy)₃)₂ may also be useful. A representative reaction scheme for such synthesis route is set forth below: 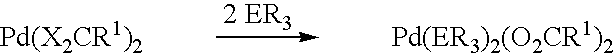
where R, ia as defined for Formula 1a and X, and R¹ are as defined for Structures B.

The following exemplary reaction scheme is starting material is Pd(Q)₂ where Q is acetate and the Group 15 ligand is triisopropylphosphine (P-i-Pr₃).

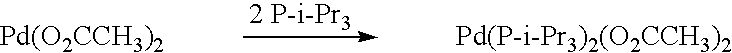

Where Pd(Q)₂ is Pd(OAc)₂, such is generally available from a commercial source. However, other palladium carboxylates, thioacetates, and dithioacetates, may not be so readily available. Advantageously, such other carboxylates, thioacetates and dithioacetates are readily prepared by the reaction of Pd(OAc)₂ with at least a two-fold equivalent of the appropriate carboxylic acid (R¹CO₂H), thiocarboxylic acid (R¹C(S)OH) or dithiocarboxylic acid (R¹CS₂H). For illustrative purposes, the reaction is generally represented as follows: 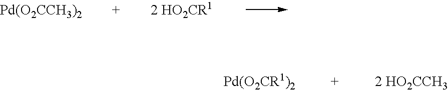
and is more specifically exemplified as follows:

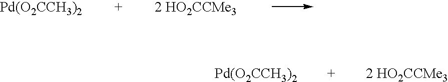

More generically, the single component proinitiator of Formula Ia can be prepared by mixing a palladium complex precursor in an appropriate solvent with a weakly coordinating anion salt, allowing the reaction to proceed to completion at a suitable reaction temperature (e.g., −78 to 25° C.), and subsequently isolating the proinitiator product. In one embodiment of the invention a palladium complex containing a Group 15 electron donor ligand of the formula [Pd(E(R)₃)ₐ(Q)₂]ₚ is reacted with a WCA salt in an inert solvent and in the absence of a Lewis base to give a single component proinitiator of the formula [Pd(κ²-Q)(E(R)₃)ₐ]ₚ[WCA]ᵣ, where Q, E, R, a, p and r are as previously defined for Formula Ia. When [Pd(Q)₂(E(R)₃)ₐ]ₚ is reacted with a WCA salt in the absence of a Lewis base or a very poorly coordinating Lewis base (i.e., readily displaced from the metal center by an oxygen or sulfur of the acetate, thioacetate, or dithioacetate), the anionic ligand contained in the palladium complex precursor is transformed from a monodentate or unidentate configuration to a bidentate or κ²-configuration in the resulting proinitiator product. An exemplary reaction scheme for this embodiment is set forth as follows:

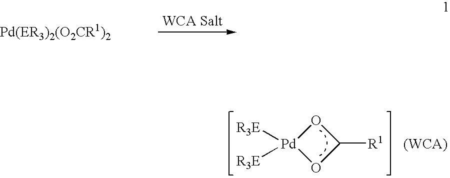

The following exemplary reaction scheme includes Pd(P-(i-Pr₃))₂(O₂CCH₃)₂ starting material and the weakly coordinating anion salt employed in the transformation is N,N-dimethylanilinium tetrakis(pentafluorophenyl)borate (DANFABA).

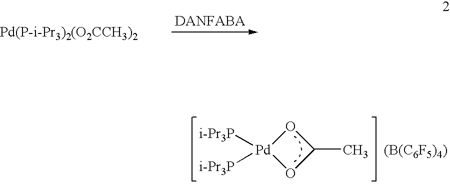

In another embodiment of the invention, the proinitiator [Pd(κ²-Q)(E(R)₃)ₐ]ₚ[WCA]ᵣ (C in FIG. 1) is generated by reacting isomeric metalated palladium species in accordance with Formula Ib ([(E(R)₃)(E(R)₂R*)Pd(LB)]ₚ[WCA]ᵣ) with a carboxylic acid, thiocarboxylic acid, or dithiocarboxylic acid. Where R and R* are as previously defined with respect to Formulae Ia and 1b, such as depicted below:

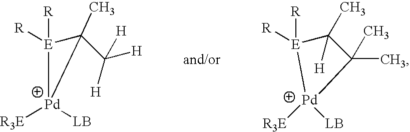

The species [Pd(LB)(ER₃)(ER₂R*)][WCA] is selected from [Pd(P-(i-Pr)₃)(κ²-P, C—P(-i-Pr)₂(C(CH₃)₂)(acetonitrile)][B(C₆F₅)₄], [Pd(P-(i-Pr)₃)(κ²-P, C—P(-i-Pr)₂(C(CH₃)₂)(pyrazine)][B(C₆F₅)₄], [Pd(P-(i-Pr)₃)(κ²-P, C—P(-i-Pr)₂(C(CH₃)₂)(pyridine)][B(C₆F₅)₄], [Pd(κ²-P, C—PCy₂(C₆H₁₀))(acetonitrile)][B(C₆F₅)₄], [Pd(κ²-P, C—PCy₂(C₆H₁₀))(pyrazine)][B(C₆F₅)₄], and [Pd(κ²-P, C—PCy₂(C₆H₁₀))(pyridine)][B(C₆F₅)₄].

In addition, the related metalated deutero species [Pd(P(C₃D₇)₃)(κ²-P, C—P(i-C₃D₇)₂(C(CD₃)₂))(acetonitrile)][B(C₆F₅)₄] and [Pd(P(C₆D₁₁)₃)(κ²-P, C—P(C₆D₁₁)₂(C₆D₁₀))(acetonitrile)][B(C₆F₅)₄] are useful.

The carboxylic acid, thiocarboxylic acid, or dithiocarboxylic acid, mentioned above, are selected from acetic acid, trifluoroacetic acid, pivalic acid (Me₃CCO₂H), thioacetic acid (CH₃C(S)OH), benzoic acid (C₆H₅CO₂H), thiobenzoic acid (C₆H₅C(S)OH), pentafluorobenzoic acid (C₆F₅CO₂H), trifluoromethylbenzoic acid (4-CF₃C₆H₄CO₂H), and 4-methoxybenzoic acid (4-CH₃OC₆H₄CO₂H) and their versions where the acid hydrogen is replaced by a deuterium.

This particular embodiment of the invention is exemplified in the following reaction scheme in which protonation of the species [Pd(LB)(ER₃)(ER₂R*)][WCA] by an organic acid generates the κ²-derivative, [Pd(ER₃)₂(Q)][WCA]:

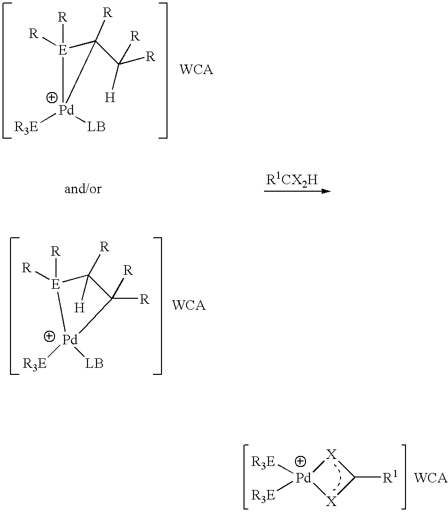

Representative [Pd(LB)(ER₃)(ER₂R*)][WCA] species based on isopropyl and cyclohexyl groups are:

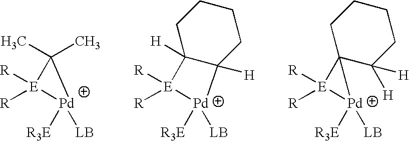

An advantageous embodiment of the present invention is illustrated by the following reaction scheme:

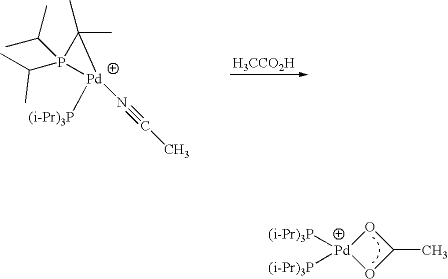

In another embodiment of the invention, a palladium complex containing a Group 15 electron donor ligand of the formula (Pd(Q)₂(E(R)₃)ₐ)ₚ (see, B in FIG. 1) is simultaneously reacted with a WCA salt and a Lewis base in an appropriate solvent to give the palladium proinitiator of Formula Ia. The Lewis base can be dissolved in the reaction solvent or the Lewis base can be utilized as the reaction solvent. An exemplary reaction scheme is as follows:

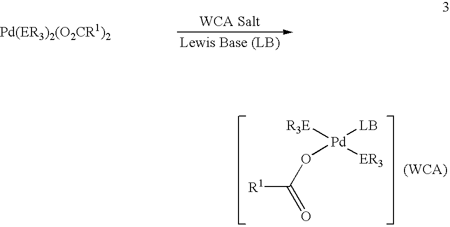

The following exemplary reaction scheme is starting material is Pd(P-i-Pr₃)₂(O₂CCH₃)₂, the Lewis base is acetonitrile, and the weakly coordinating anion salt is lithium(diethyl ether)_{2.5} tetrakis(pentafluorophenyl)borate (Li(OEt₂)_{2.5}FABA). 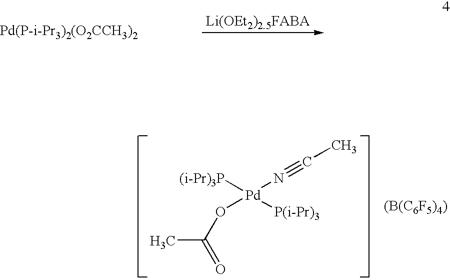
Additional LB ligand substituted proinitiator species in accordance with the present invention can be generated by reacting the obtained LB ligand substituted proinitiator with a Lewis base that is more strongly binding than the LB ligand that it is replacing.

In non-Lewis base ligated proinitiator embodiments of the invention, the synthesis reaction is carried out in an inert solvent. The reaction encompasses dissolving the selected Group 15 ligated palladium compound in the inert solvent and then adding, on a 1:1 equivalent basis, the selected WCA salt to the solution. Examples of useful inert solvents include, but are not limited to, alkane and cycloalkane solvents such as pentane, hexane, heptane, and cyclohexane; halogenated alkane solvents such as dichloromethane, chloroform, carbon tetrachloride, ethylchloride, 1,1-dichloroethane, 1,2-dichloroethane, 1-chloropropane, 2-chloropropane, 1-chlorobutane, 2-chlorobutane, 1-chloro-2-methylpropane, and 1-chloropentane; aromatic solvents such as benzene, xylene, toluene, anisole, mesitylene, chlorobenzene, o-dichlorobenzene, and fluorobenzene; and halocarbon solvents such as Freon® 112 (DuPont Corporation, Wilimngton, Del.); and mixtures thereof. Under certain experimental circumstances and certain palladium initiator generation, the use of certain ethers, such as diethyl ether, dimethyl ether, dioxane, and tetrahydrofuran, may enable the formation of the Lewis base free proinitiator embodiments, despite the fact that such ethers are often regarded as Lewis bases.

Referring to Lewis base ligated proinitiator embodiments of the present invention, the synthesis reaction with the WCA salt can be conducted in the presence of the inert solvents set forth above, or, where the selected Lewis base is also a solvent, i.e., neat. Exemplary Lewis base solvents are dimethyl ether, diethyl ether, dioxane, acetonitrile, tetrahydrofuran, pyridine, benzonitrile, and trialkylphosphines, including trimethylphosphine, triisopropylphosphine, and tricyclohexylphosphine.

Where the synthesis of the LB ligated proinitiator is carried out in an inert solvent, the Group 15 ligated palladium compound is first dissolved in the solvent and then the desired Lewis base and WCA salt added to the solution in a 1:1 to 1:1:5 equivalent basis (palladium compound:Lewis base:WCA salt). In such inert solvent, the Lewis base coordinates to the palladium as the LB ligand. As discussed above, a phosphine is considered a Lewis base when it is added during the formation of the proinitiator (i.e., when the phosphine is added during the reaction of the Group 15 ligated palladium compound with the WCA salt). Where the Lewis base is a solvent, the Group 15 ligated palladium compound and WCA salt are added to the Lewis base on a 1:1 equivalent basis (palladium compound:WCA salt); the Lewis base solvent is, of course, present in excess.

In another embodiment of the invention, the initiator [(ER₃)₂Pd(H)(LB)][FABA] (see, E, F and G in FIG. 1) is generated by heating (or otherwise supplying energy) to the metalated palladium species of the Formula 1b ([Pd(LB)(ER₃)(ER₂R*)][WCA])(see, D in FIG. 1). 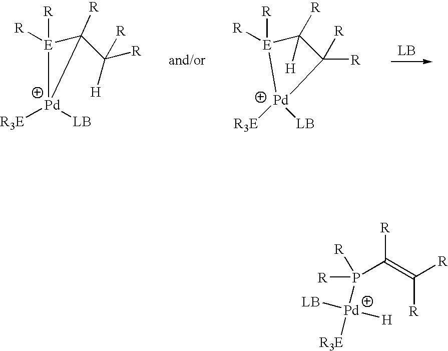
This embodiment is illustrated in the following reaction scheme. and, more specifically, for the embodiments of triisopropylphosphine 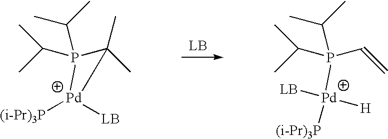
and tricyclohexylphosphine derivatives

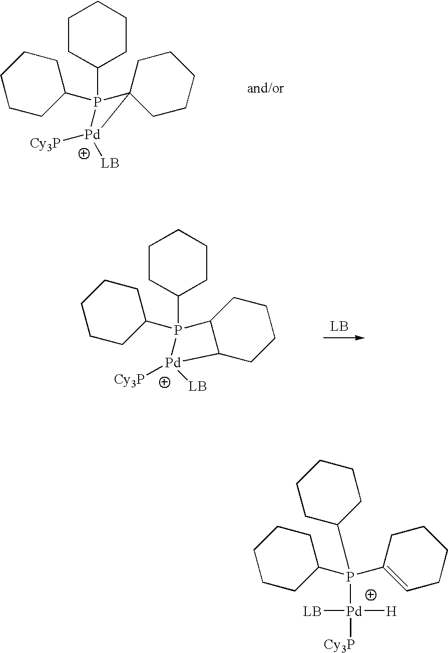

In summary, embodiments in accordance with the present invention encompass the following advantageous compounds that are represented by Formulae Ia and Ib: [Pd(OAc)(P(Cy)₃)₂(MeCN)][B(C₆F₅)₄], [Pd(OAc)(P(Cy)₂(CMe₃))₂(MeCN)][B(C₆F₅)₄], [Pd(OAc)(P(i-Pr)(CMe₃)₂)₂(MeCN)][B(C₆F₅)₄], [Pd(OAc)₂(P(i-Pr)₂(CMe₃))₂(MeCN)][B(C₆F₅)₄], [Pd(OAc)(P(i-Pr)₃)₂(MeCN)][B(C₆F₅)₄], [Pd(O₂C-t-Bu)(P(Cy)₃)₂(MeCN)][B(C₆F₅)₄], [Pd(O₂C-t-Bu)(P(Cy)₂(CMe₃))₂(MeCN)][B(C₆F₅)₄], [Pd(O₂C-t-Bu)₂(P(i-Pr)₂(CMe₃))₂, [Pd(O₂C-t-Bu)(P(i-Pr)₃)₂(MeCN)][B(C₆F₅)₄], cis-[Pd(P(i-Pr)₃)(κ²-P, C—P(i-Pr)₂(C(CH₃)₂)(MeCN)][B(C₆F₅)₄], and cis-[Pd(P(i-Pr)₃)(κ²-P, C—P(i-Pr)₂(C(CH₃)₂)(NC₅H₅)][B(C₆F₅)₄.

Other advantagous compounds exemplary of Formulae Ia and Ib include, [Pd(OAc)(P(Cp)₃)₂(MeCN)][B(C₆F₅)₄], [Pd(OAc)(P(i-Pr)₂(CMe₃))₂(MeCN)][B(C₆F₅)₄], [Pd(O₂C-t-Bu)(P(Cp)₃)₂(MeCN)][B(C₆F₅)₄], [Pd(O₂C-t-Bu₂(P(i-Pr)(CMe₃)₂)(MeCN)][B(C₆F₅)₄], [Pd(O₂C-t-Bu)(P(i-Pr)₂(CMe₃))₂(MeCN)][B(C₆F₅)₄], cis-[Pd(P(i-Pr)₃)(κ²-P,C—P(i-Pr)₂(C(CH₃)₂)(NC₅H₅)][B(C₆F₅)₄], cis-[Pd(P(i-Pr)₃)(κ²-P,C—P(i-Pr)₂(C(CH₃)₂)(2,6-Me₂py)][B(C₆F₅)₄], and cis-[Pd(P(i-Pr)₃)(κ²-P,C—P(i-Pr)₂(C(CH₃)₂)(2,6-Me₂pyz)][B(C₆F₅)₄].

Yet other compounds exemplary of Formulae Ia and Ib include, but are not limited to, [(P(Cy)₃)₂Pd(κ²-O,O′—O₂CCH₃)][B(C₆F₅)₄], [(P(Cy)₃)₂Pd(κ²-O,O′—O₂C-t-Bu)][B(C₆F₅)₄], [(P(Cy)₃)₂Pd(κ²-O,O′—O₂CC₆H₅)][B(C₆F₅)₄], [(P(Cy)₃)₂Pd(κ²-O,O′—O₂CC₆F₅][B(C₆F₅)₄], [(P(CY)₃)₂Pd(κ²-O,O′—O₂CCF₃)][B(C₆F₅)₄], [(P(Cy)₃)₂Pd(κ²-O,O′—O₂CCH₃)][B(C₆H₃-3,5-(CF₃)₂)₄], [(P(Cy)₃)₂Pd(κ²-O,O′—O₂CCH₃)][Al(OC(CF₃)₂C₆H₄CH₃)₄], [(P(Cy)₃)₂Pd(κ²O,O′—O₂CPh)][B(C₆F₅)₄], [(P(Cy-d₁₁)₃)₂Pd(κ²-O,O—OAc)][B(C₆F₅)₄], [pd(P(i-Pr)₃)₂(κ²-O,O′—O₂CCH₃)][B(C₆F₅)₄], [Pd(P(i-Pr)₃)₂(κ²-O,O′—O₂C-t-Bu)][B(C₆F₅)₄], [(P(i-Pr)₃)₂Pd(κ²-O,O—O₂CCF₃)][B(C₆F₅)₄], [(P(i-PR)₃)₂Pd(κ²-O,O—O₂CC₆F₅)][B(C₆F₅)₄], [(P(i-Pr)₃)₂Pd(κ²-O,O—O₂CC₆H₅)][B(C₆F₅)₄], [(P(i-Pr)₃)₂Pd(κ²-O,O—O₂CC₆H₄-p-(CF₃))][B(C₆F₅)₄], [(P(i-Pr)₃)₂Pd(κ²O,O—O₂CC₆H₄)-p-(OMe)][B(C₆F₅)₄], [Pd(P(Cy)₂(CMe₃))₂(κ²-O,O′—O₂CCH₃)][B(C₆F₅)₄], [Pd(P(Cy)(CMe₃)₂)₂(κ²-O,O′—O₂CCH₃)][B(C₆F₅)₄], [Pd(P(i-Pr)₂(CMe₃))₂(κ²-O,O′—O₂CCH₃)][B(C₆F₅)₄], [Pd(P(i-Pr)(CMe₃)₂)₂(κ²-O,O′—O₂CCH₃)][B(C₆F₅)₄], [Pd(κ²-O,O′—OAc)(As(Cy)₃)₂][B(C₆F₅)₄], [Pd(κ²-O,O′—OAc)(As(i-Pr)₃)₂][B(C₆F₅)₄], [Pd(As-i-Pr₃)₂(O₂CCH₃)(NCCH₃)][(B(C₆F₅)₄], [Pd(As(Cy)₃)₂(O₂CCH₃)(NCCH₃)][(B(C₆F₅)₄][(P(Cy-d₁₁)₃)₂Pd(NCMe)(O₂CCH₃)][B(C₆F₅)₄], [(P(Cy-d₁)₃)₂Pd(NCMe)(O₂CCH₃)][B(C₆F₅)₄], Pd(O₂CCH₃)(P(Cy)₃)₂(MeCN)][B(C₆F₅)₄], Pd(O₂CCH₃)(P(i-Pr)₃)₂(MeCN)][B(C₆F₅)4], [Pd(O₂CCH₃)(P(i-Pr)₃)₂(MeCN)][B(C₆H₃-3,5-(CF₃)₂)₄], [Pd(O₂CCH₃)(P(Cy)₃)₂(MeCN)][Al(OC(CF₃)₂C₆H₄CH₃)₄], [Pd(O₂CCH₃)(P(i-Pr)₃)₂(MeCN)][Al(OC(CF₃)₂C₆H₄CH₃)₄], [Pd(O₂C-t-Bu)](P(Cy)₃)₂(MeCN)[B(C₆F₅)₄], [Pd(O₂CPh)(P(Cy)₃)₂(NCMe)][B(C₆F₅)₄], [Pd(O₂CCF₃)(P(Cy)₃)₂(MeCN)][B(C₆F₅)₄], [Pd(OAc)(P(Cy)₃)₂(NC₅H₅)][B(C₆F₅)₄], [(P-i-Pr₃)₂Pd(O₂CCH₃)(NC₅H₅)][B(C₆F₅)₄], [(P(Cy-d₁)₃)₂Pd(NCMe)(O₂CCH₃)][B(C₆F₅)₄], [Pd(P(Cy)₃)₂(O₂CCH₃(4-Me₂NC₅H₄N)][B(C₆F₅)₄, Pd(P(Cy)₃)₂(O₂CCH₃)(CNC₆H₃Me₂-2,6)][B(C₆F₅)₄], trans-[(P-i-Pr₃)₂Pd(O₂CCH₃)(CNC₆H₃Me₂-2,6)][B(C₆F₅)₄], [(PCy₂-tert-butyl)₂Pd(O₂CCH₃)(MeCN)]B(C₆F₅)₄, [Pd(P(i-Pr)₂(CMe₃))₂(O₂CCH₃)(MeCN)][B(C₆F₅)₄], [Pd(PCy₂-tert-butyl)₂(O₂CCH₃)(MeCN)]B(C₆F₅)₄. cis-[Pd(P(i-Pr)₃)(κ²-P, C—P(i-Pr)₂(C(CH₃)₂)(NC₅H₅)][B(C₆F₅)₄], cis-[Pd(P(i-Pr)₃)(κ²-P, C—P(i-Pr)₂(C(CH₃)₂)(2,6-Me₂py)][B(C₆F₅)₄], cis-[Pd(P(i-Pr)₃)(κ²-P, C—P(i-Pr)₂(C(CH₃)₂)(2,6-Me₂pyz)][B(C₆F₅)₄], cis-[Pd(P(i-Pr)₃(κ²-P,C—P(i-Pr)₂(C(CH₃)₂))(4-t-BuC₅H₄N)][B(C₆F₅)₄], [Pd(κ²-P, C—PCy₂(C₆H₁₀))(acetonitrile)][B(C₆F₅)₄], [Pd(P(Cy)₃)(κ²-P,C—PCy₂(C₆H₁₀))(pyrazine)][B(C₆F₅)₄], and [Pd P(Cy)₃ (κ²-P, C—PCy₂(C₆H₁₀))(pyridine)][B(C₆F₅)₄].

Palladium Hydride Derivatives Via Thermolysis and Synthetic Routes

In one embodiment of the present invention, the palladium hydride may be generated by the decarboxylation (loss of carbon dioxide (CO₂)) of a carboxylate ligand [((R)₃E)ₐPd(Q)(LB)_{b}]ₚ[WCA]r.with elimination of small molecule (alkene or alkane) under the thermolysis reaction conditions, i.e., loss of isobutylene,.

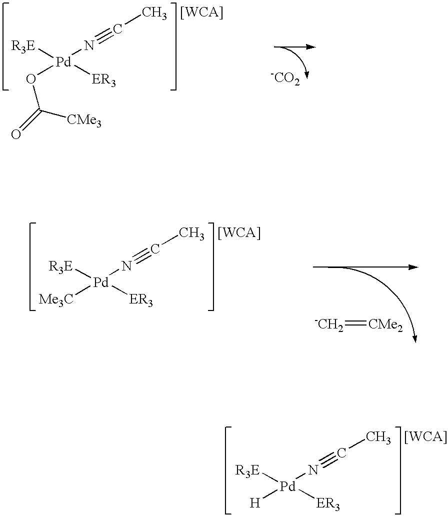

One embodiment is the species [((R)₃E)ₐPd(O₂CMe₃)(LB)_{b}]ₚ[WCA]ᵣ, and more specifically [Pd(O₂C-t-Bu)(NCCH₃)(P(Cy)₃)₂][B(C₆F₅)₄] and [Pd(O₂C-t-Bu)(NCCH₃)(P(i-Pr)₃)₂][B(C₆F₅)₄].

In one embodiment of the present invention, the palladium hydride may be generated by the decarboxylation of a carboxylate ligand [((R)₃E)ₐPd(Q)(LB)_{b}]ₚ[WCA]ᵣ. with elimination of small molecule (alkene or alkane) under the thermolysis reaction conditions.

In one embodiment of the present invention, it is advantageous to generate the palladium hydride or deuteride initiator [Pd(PR₃)₂(H)(LB)][FABA] directly via the oxidative addition of a strong acid (H⁺ or D⁺) of a WCA, i.e., H(OEt₂)_{2.5}[B(C₆F₅)₄], [HNMe₂Ph][B(C₆F₅)₄](DANFABA), or [DNMe₂Ph][B(C₆F₅)₄] to a palladium(0) species in the presence of the appropriate Lewis base (e.g., CH₃CN) to generate the cationic hydride or deuteride species of the present invention.

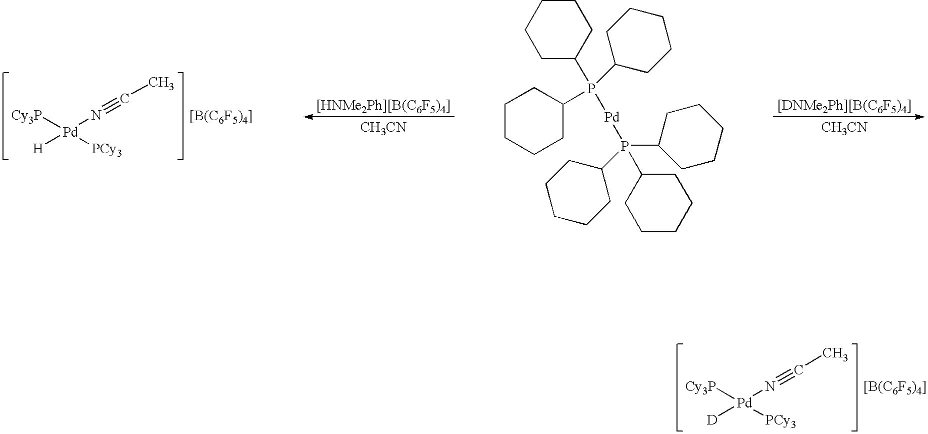

Representative Pd(0) species include, but are not limited to, Pd(ER₃)ₙ, where n=2, 3, or 4; Pd₂(dba)₃. Selected species include, but are not limited to, Pd₂(dba)₃, Pd(PPh₃)₄, Pd(P(o-tolyl₃)₄, Pd(P-i-Pr₃)₂, Pd(P-i-Pr₃)₃, and Pd(PCy₃)₂, The Lewis base may be selected from any of the Lewis bases defined for the proinitiator described in Formula 1.

### WCA Salts

In some embodiments of the invention, the salt of the weakly coordinating anion employed in the preparation of the pro initiators can be represented by the formula [C]ₑ[WCA]_{d}, where C represents a proton (H⁺), an organic group containing cation, or a cation of an alkali metal, an alkaline earth or a transition metal, WCA is as defined above and e and d represent the number of times the cation complex (C) and the weakly coordinating anion complex (WCA), respectively, are taken to balance the electronic charge on the overall salt complex.

Alkali metal cations include Group 1 metals selected from lithium, sodium, potassium, rubidium, and cesium. Alkaline earth metal cations., include Group 2 metals selected from beryllium, magnesium, calcium, strontium, and barium. Transition metal cations are selected from zinc, silver, and thallium.

The organic group cation is selected from ammonium, phosphonium, carbonium and silylium cations, i.e., [NH(R³⁰)₃]⁺, [N(R³⁰)₄]⁺, [PH(R³⁰)₃]⁺, [P(R³⁰)₄]⁺, [(R³⁰)₃C]⁺, and [(R³⁰)₃Si]⁺, where R³⁰ independently represents a hydrocarbyl, silylhydrocarbyl, or perfluorocarbyl group, each containing 1 to 24 carbon atoms, arranged in a linear, branched, or ring structure. By perfluorocarbyl is meant that all carbon bonded hydrogen atoms are replaced by a fluorine atom. Representative hydrocarbyl groups include, but are not limited to, linear and branched C₁-C₂₀ alkyl, C₃-C₂₀ cycloalkyl, linear and branched C₂-C₂₀ alkenyl, C₃-C₂₀ cycloalkenyl, C₆-C₂₄ aryl, and C₇-C₂₄ aralkyl, and organometallic cations. The organic cations are selected from trityl, trimethylsilylium, triethylsilylium, tris(trimethylsilyl)silylium, tribenzylsilylium, triphenylsilylium, tricyclohexylsilylium, dimethyloctadecylsilylium, and triphenylcarbenium (i.e., trityl). In addition to the above cation complexes, ferrocenium cations such as [(C₅H₅)₂Fe]⁺ and [(C₅(CH₃)₅)₂Fe]⁺ are also useful as the cation in the WCA salts of the invention.

Advantageous WCA salts having a weakly coordinating anion, such as described under Formulae II, III and IV, include lithium (etherate)_{2.5} tetrakis(pentafluorophenyl)borate (LiFABA etherate), dimethylanilinium tetrakis(pentafluorophenyl)borate (DANFABA), and sodium tetrakis(3,5-bis(trifluoromethyl)phenyl)borate. Other advantageous WCA salts include lithium triflimide or Li[N(SO₂C₄F₉)₂], lithium bis(pentafluoroethanesulfonyl)imide [LiN(SO₂C₂F₅)₂]; lithium 1,1,2,2,2-pentafluoroethane-N-[(trifluoromethyl)sulfonyl]sulfonamide [N(SO₂CF₃)(SO₂C₄F₉)], lithium tris(trifluoromethanesulfonyl)methane anion (Li[C(SO₂CF₃)₃]), Li[Al(OC(CF₃)₂Ph)₄], and Li[Al(OC(CF₃)₂C₆H₄CH₃)₄.

Yet other useful WCA salts in accordance with embodiments of the present invention include, but are not limited to, lithium bis(trifluoromethylsulfonyl)imide, lithium tetrakis(3,5-bis(trifluoromethyl)phenyl)borate, dimethylanilinium tetrakis(3,5-bis(trifluoromethyl)phenyl)borate, lithium tetrakis(2,3,4,5-tetrafluorophenyl)borate, lithium tetrakis(pentafluorophenoxy)borate, lithium tetrakis(3,4,5,6-tetrafluorophenyl)borate, lithium tetrakis(1,2,2-trifluoroethylenyl)borate, lithium tetrakis(4-tri-i-propylsilyltetrafluorophenyl)borate, lithium tetrakis(4-dimethyl-tert-butylsilyltetrafluorophenyl)borate, lithium (tetrakis[3,5-bis[1-methoxy-2,2,2-trifluoro-1-(trifluoromethyl)ethyl]phenyl]borate, lithium tetrakis[3-[1-methoxy-2,2,2-trifluoro-1-(trifluoromethyl)ethyl]-5-(trifluoromethyl)phenyl]borate, lithium tetrakis[3-[2,2,2-trifluoro-1-(2,2,2-trifluoroethoxy)-1-(trifluoromethyl)ethyl]-5-(trifluoromethyl)phenyl]borate, lithium tetrakis(pentafluorophenyl)aluminate, lithium tris(perfluorobiphenyl)fluoroaluminate, lithium (octyloxy)tris(pentafluorophenyl)aluminate, lithium tetrakis(3,5-bis(trifluoromethyl)phenyl)aluminate, lithium methyltris(pentafluorophenyl)aluminate, lithium bis[3,4,5,6-tetrafluoro-1,2-benzenediolato-κO,κO′]borate (Li[B(O₂C₆F₄)₂]), dimethyl anilinium(tetrakis(pentafluorophenyl)borate ([HNMe₂Ph][B(OC₆F₅)₄]), trimethylammonium(tetrakis(pentafluorophenyl)borate ([HNMe₃][B(OC₆F₅)₄]), Li[Al(OC(CF₃)₂Ph)₄], Li[Al(OC(CF₃)₂C₆H₄CH₃)₄, Li[Al(OC(CF₃)₂C₆H₄-4-t-butyl)₄], Li[Al(OC(CF₃)₂C₆H₃-3,5-(CF₃)₂)₄], Li[Al(OC(CF₃)₂C₆H₂-2,4,6-(CF₃)₃)₄]⁻, and Li[Al(OC(CF₃)₂C₆F₅)₄]⁻.

### Monomers

The proinitiators of the present invention are suitable for the preparation of a wide range of polymers comprising cyclic repeating units. The polycyclic polymers are prepared by the addition polymerization of a polycycloolefin monomer(s) in the presence of a catalytic amount of a single component proinitiator of Formula I As defined herein, the terms “polycycloolefin”, “polycyclic”, and “norbornene-type” monomer are used interchangeably and mean that the addition polymerizable monomer contains at least one norbornene moiety as shown below:

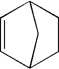

The simplest polycyclic monomer of the invention is the bicyclic monomer, bicyclo[2.2.1]hept-2-ene, commonly referred to as norbornene. The term norbornene-type monomer is meant to include norbornene, substituted norbornene(s), and any substituted and unsubstituted higher cyclic derivatives thereof so long as the monomer contains at least one norbornene or substituted norbornene moiety. The substituted norbornenes and higher cyclic derivatives thereof contain a pendant hydrocarbyl substituent(s) or a pendant functional substituent(s) containing a hetero atom. Exemplary addition polymerizable monomers are represented by the formula below: 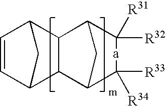
where “a” represents a single or double bond, R³¹ to R³⁴ independently represents a hydrocarbyl or functional substituent, m is an integer from 0 to 5, and when “a” is a double bond one of R³¹, R³² and one of R³³, R³⁴ is not present.

When the substituent is a hydrocarbyl group, halohydrocarbyl, or perhalocarbyl group R³¹ to R³⁴ independently represent hydrocarbyl, halogenated hydrocarbyl and perhalogenated hydrocarbyl groups selected from hydrogen, linear and branched C₁-C₁₀ alkyl, linear and branched, C₂-C₁₀ alkenyl, linear and branched C₁-C₁₀ alkynyl, C₄-C₁₂ cycloalkyl, C₄-C₁₂ cycloalkenyl, C₆-C₁₂ aryl, and C₇-C₂₄ aralkyl, R³¹ and R³² or R³³ and R³⁴ can be taken together to represent a C₁-C₁₀ alkylidenyl group. Representative alkyl groups include, but are not limited to, methyl, ethyl, propyl, isopropyl, butyl, isobutyl, sec-butyl, tert-butyl, pentyl, neopentyl, hexyl, heptyl, octyl, nonyl, and decyl. Representative alkenyl groups include, but are not limited to, vinyl, allyl, butenyl, and cyclohexenyl. Representative alkynyl groups include, but are not limited to, ethynyl, 1-propynyl, 2-propynyl, 1-butynyl, and 2-butynyl. Representative cycloalkyl groups include, but are not limited to, cyclopentyl, cyclohexyl, and cyclooctyl substituents. Representative aryl groups include, but are not limited to, phenyl, naphthyl, and anthracenyl. Representative aralkyl groups include, but are not limited to, benzyl, and phenethyl. Representative alkylidenyl groups include methylidenyl, and ethylidenyl groups.

Advantageous perhalohydrocarbyl groups include perhalogenated phenyl and alkyl groups. The halogenated alkyl groups useful in the invention are linear or branched and have the formula C_{f}X″_{2f+1} where X″ is a halogen as set forth above and f is selected from an integer of 1 to 10. Useful perfluorinated substituents include perfluorophenyl, perfluoromethyl, perfluoroethyl, perfluoropropyl, perfluorobutyl, and perfluorohexyl. In addition to the halogen substituents, the cycloalkyl, aryl, and aralkyl groups of the invention can be further substituted with linear and branched C₁-C₅ alkyl and haloalkyl groups, aryl groups and cycloalkyl groups.

When the pendant group(s) is a functional substituent, R³¹ to R³⁴ independently represent a radical selected from —(CH₂)ₙC(O)OR³⁵, —(CH₂)ₙ—C(O)OR³⁵, —(CH₂)ₙ—OR³⁵, —(CH₂)ₙ—OC(O)R³⁵, —(CH₂)ₙ—C(O)R³⁵, —(CH₂)ₙSiR³⁵, —(CH₂)ₙSi(OR³⁵)₃, and —(CH₂)ₙC(O)OR³⁶, —(CH₂)ₙ—OC(O)OR³⁵, —(CH₂)ₙSiR³⁵, —(CH₂)ₙSi(OR³⁵)₃, and —(CH₂)ₙC(O)OR³⁶, where n independently represents an integer from 0 to 10 and R³⁵ independently represents hydrogen, linear and branched C₁-C₁₀ alkyl, linear and branched, C₂-C₁₀ alkenyl, linear and branched C₂-C₁₀ alkynyl, C₅-C₁₂ cycloalkyl, C₆-C₁₄ aryl, and C₇-C₂₄ aralkyl. Representative hydrocarbyl groups set forth under the definition of R³⁵ are the same as those identified above under the definition of R³¹ to R³⁴. As set forth above under R³¹ to R³⁴, the hydrocarbyl groups defined under R³⁵ can be halogenated and perhalogenated. The R³⁶ radical represents a moiety selected from —C(CH₃)₃, —Si(CH₃)₃, —CH(R³⁷)OCH₂CH₃, —CH(R³⁷)OC(CH₃)₃ or the following cyclic groups: 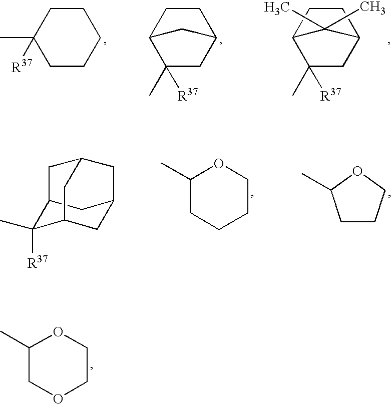
where R³⁷ represents hydrogen or a linear or branched (C₁-C₅) alkyl group. The alkyl groups include methyl, ethyl, propyl, i-propyl, butyl, i-butyl, t-butyl, pentyl, t-pentyl and neopentyl. In the above structures, the single bond line projecting from the cyclic groups indicates the position where the cyclic group is bonded to the acid substituent. Examples of R³⁶ radicals include 1-methyl-1-cyclohexyl, isobornyl, 2-methyl-2-isobornyl, 2-methyl-2-adamantyl, tetrahydrofuranyl, tetrahydropyranoyl, 3-oxocyclohexanonyl, mevalonic lactonyl, 1-ethoxyethyl, and 1-t-butoxy ethyl.

The R³⁶ radical can also represent dicyclopropylmethyl (Dcpm), and dimethylcyclopropylmethyl (Dmcp) groups which are represented by the following structures:

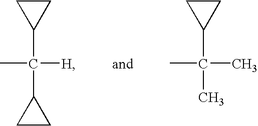

In Formula IV above, R³¹ and R³⁴ together with the two ring carbon atoms to which they are attached can represent a substituted or unsubstituted cycloaliphatic group containing 4 to 30 ring carbon atoms or a substituted or unsubstituted aryl group containing 6 to 18 ring carbon atoms or combinations thereof. The cycloaliphatic group can be monocyclic or polycyclic. When unsaturated the cyclic group can contain monounsaturation or multiunsaturation, with monounsaturated cyclic groups being found useful. When substituted, the rings contain monosubstitution or multisubstitution wherein the substituents are independently selected from hydrogen, linear and branched C₁-C₅ alkyl, linear and branched C₁-C₅ haloalkyl, linear and branched C₁-C₅ alkoxy, halogen, or combinations thereof. The radicals R³¹ and R³⁴ can be taken together to form the divalent bridging group, —C(O)-G-(O)C—, which when taken together with the two ring carbon atoms to which they are attached form a pentacyclic ring, where G represents an oxygen atom or the group N(R³⁸), and R³⁸ is selected from hydrogen, halogen, linear and branched C₁-C₁₀ alkyl, and C₆-C₁₈ aryl. A representative structure is shown in below. 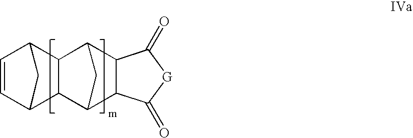
where m is an integer from 0 to 5.

### Polymerization of Monomers

The polycycloolefin monomers of the invention can be polymerized in solution or in mass. A catalytic amount of the preformed single component proinitiator is added to the reaction medium containing at least one polycycloolefin monomers. Exemplary polycycloolefin monomers are set forth but not limited to the monomers identified supra under formula IV. The proinitiator of the invention is added to the reaction medium containing the desired monomer or mixture of monomers and allowed to polymerize at the appropriate proinitiator activation temperature (i.e., the temperature at which the proinitiator begins to initiate the polymerization of monomer). If latency is desired, the temperature of the reaction medium must be kept below the activation temperature of the particular proinitiator employed. Exemplary activation temperatures can range from about ambient room temperature to about 250° C. In another embodiment the activation temperature ranges from about 40 to about 180° C. In a further embodiment the activation temperature ranges from about 60 to about 130° C., and in a still further embodiment the activation temperature is 100° C. One of ordinary skill in the art can readily determine the ideal activation temperature to employ based on the particular proinitiator compound utilized, the monomer reactivity, and the monomer to proinitiator concentration employed in the polymerization reaction without undue experimentation.

The latency and/or storage stability of the proinitiator/monomer composition can be extended by reducing the temperature of the composition to below ambient room temperature. Typically, such temperatures range from about −150° C. to about just below ambient room temperature (i.e., about 15° C.).

In one embodiment of the invention, exemplary monomer to proinitiator ratios (i.e., monomer:palladium metal) employed range from about 250,000:1 to about 50:1. In another embodiment, the monomer to proinitiator ratio employed range from about 100,000:1 to about 100:1. In a further embodiment, the monomer to proinitiator ratio employed range from about 50,000:1 to about 500:1, and in yet another embodiment the ratio is about 25,000:1.

Pressure has not been observed to be critical but may depend on the boiling point of the solvent employed, i.e. sufficient pressure to maintain the solvent in the liquid phase. The reactions are preferably carried out under inert atmosphere such as nitrogen or argon.

In an exemplary embodiment of the invention, the polymers formed have a weight average molecular weight (Mw) of from about 150,000 to about 1,000,000. The molecular weights being measured by use of a gel permeation chromatograph (GPC) using polynorbornene standards (a modification of ASTM D3536-91). Instrument: Alcot 708 Autosampler; Waters 515 Pump; Waters 410 Refractive Index Detector. Columns: Phenomenex Phenogel Linear Column (2) and a Phenogel 10⁶ Å Column (all columns are 10 micron packed capillary columns). Samples are run in monochlorobenzene. The absolute molecular weight of the polynorbornene standards was generated utilizing a Chromatics CMX 100 low angle laser light scattering instrument.

If desired, the molecular weight of the polymer can be controlled by mixing an α-olefin chain transfer agent such as is disclosed in U.S. Pat. No. 6,136,499, the pertinent parts of are incorporated herein by reference. In one embodiment of the invention useful α-olefin chain transfer agents are selected from ethylene, propylene, 1-butene, 1-hexene, 1-octene, 1-decane, 4-methyl-1-pentene, cyclopentene, and cyclohexene.

### Solution Process

In a solution process, the polymerization reaction can be carried out by adding a desired single component proinitiator to a solution of a cycloolefin monomer or mixtures of monomers to be polymerized. In one embodiment, the amount of monomer in the solvent ranges from about 10 to about 50 weight percent, and in another embodiment from about 20 to about 30 weight percent. After the single component proinitiator is added to the monomer solution, the reaction medium is agitated (e.g., stirred) to ensure the complete mixing of proinitiator and monomer components.

Exemplary solvents for the polymerization reaction include, but are not limited to, alkane and cycloalkane solvents such as pentane, hexane, heptane, and cyclohexane; halogenated alkane solvents such as dichloromethane, chloroform, carbon tetrachloride, ethylchloride, 1,1-dichloroethane, 1,2-dichloroethane, 1-chloropropane, 2-chloropropane, 1-chlorobutane, 2-chlorobutane, 1-chloro-2-methylpropane, and 1-chloropentane; aromatic solvents such as benzene, xylene, toluene, anisole, mesitylene, chlorobenzene, and o-dichlorobenzene, Freon® 112 halocarbon solvent, and mixtures thereof.

### Mass Process

The term mass polymerization refers to a polymerization reaction which is generally carried out in the substantial absence of a solvent. In some cases, however, a small proportion of solvent can be present in the reaction medium. Small amounts of solvent can be conveyed to the reaction medium if it is desired to pre-dissolve the proinitiator in solvent before its addition to the monomer. Solvents also can be employed in the reaction medium to reduce the viscosity of the polymer at the termination of the polymerization reaction to facilitate the subsequent use and processing of the polymer. In one embodiment of the invention, the amount of solvent that can be present in the reaction medium ranges from about 0 to about 20 percent weight percent. In another embodiment, from about 0 to about 10 weight percent, and in still another embodiment from about 0 to about 1 weight percent, based on the weight of the monomer(s) present in the reaction mixture. Exemplary solvents include, but are not limited to, alkane and cycloalkane solvents such as pentane, hexane, heptane, and cyclohexane; halogenated alkane solvents such as dichloromethane, chloroform, carbon tetrachloride, ethylchloride, 1,1-dichloroethane, 1,2-dichloroethane, 1-chloropropane, 2-chloropropane, 1-chlorobutane, 2-chlorobutane, 1-chloro-2-methylpropane, and 1-chloropentane; aromatic solvents such as benzene, xylene, toluene, mesitylene, chlorobenzene, and o-dichlorobenzene; and halocarbon solvents such as Freon® 112; and mixtures thereof.

The single component proinitiator in accordance with embodiments of the present invention is added to the desired monomer or mixture of monomers. The reaction components are mixed and heated to the activation temperature of the proinitiator employed. Alternatively, the monomer mixture is pre-heated to the activation temperature of the proinitiator and the proinitiator added to the pre-heated monomer(s). The polymerization reaction is then allowed to proceed to completion. Following the initial polymerization reaction, the polymer product obtained can be post cured, if desired, to drive off any remaining solvent or un-reacted monomer.

Without wishing to be bound by theory of invention it is believed that post curing is desirable from the standpoint of maximizing monomer to polymer conversion. In a mass process the monomer is essentially the diluent for the catalyst system components. As monomer is converted to polymer a plateau is reached beyond which conversion of monomer to polymer is slowed or halted due to loss of mobility as the reaction medium becomes converted to a polymeric matrix (vitrification) and the catalyst system components and unconverted monomer become segregated. It is believed that post curing at elevated temperatures increases the mobility of the reactants in the matrix allowing for the further conversion of monomer to polymer.

In embodiments of the present invention that employ post curing, such post curing cycle is conducted for 1 to 2 hours over a temperature range of from about 100 to about 300° C. In another embodiment from about 125 to about 200° C., and in still another embodiment from about 140 to about 180° C. The cure cycle can be at a constant temperature or the temperature can be ramped (e.g., incrementally increasing the curing temperature from a desired minimum temperature to a desired maximum temperature during a desired curing cycle time period).

In some embodiments of the present invention, it is advantageous to employ an excess of a weakly coordinating anion salt to effect polymerization in both mass and solution reactions. An appropriate molar ratio of such an excess of weakly coordination anion salt to palladium proinitiator (i.e., [C]ₑ[WCA]_{d}:Pd proinitiator) is in the range of 0.1 to 100 molar equivalents for some embodiments and in the range of 0.5 to 50 molar equivalents or in the range of 1 to 10 molar equivalents for other embodiments. Advantageous WCA salts ([C]ₑ[WCA]_{d}) are found to include lithium(diethyl ether)_{2.5}tetrakis(pentafluorophenyl)borate, dimethylanilinium tetrakis(pentafluorophenyl)borate, dimethylanilinium tetrakis(3,5-bis(trifluoromethyl)phenyl)borate, H(OEt₂)ₓ tetrakis(pentafluorophenyl)borate, tetrakis[4-methyl)-α, α-bis(trifluoromethyl)benzenemethanolato-κO]aluminate, sodium tetrakis(3,5-bis (trifluoromethyl)phenyl)borate, trialkyl and triarylphosphonium tetrakis/pentafluorophenyl)borate, and trityl tetrakis(pentafluorophenyl)borate.

### EXAMPLES

The following examples are detailed descriptions of methods of preparation and use of certain compositions of the present invention. The detailed preparation descriptions fall within the scope of, and serve to exemplify, the more generally described methods set forth above. The examples are presented for illustrative purposes only, and are not intended to restrict or otherwise limit the scope of the invention.

### Examples 1-10

### Preparation of Palladium Complex Precursors

### Example 1

### Preparation of Pd(OAc)₂(P(i-Pr)₃)₂

In a N2 filled flask equipped with an addition funnel, a CH₂Cl₂ solution (20 mL) of P(i-Pr)₃ (8.51 mL, 44.6 mmol) was added dropwise to a −78° C. stirring reddish brown suspension of Pd(OAc)₂ (5.00 g, 22.3 mmol) in CH₂Cl₂ (30 mL). The suspension gradually cleared to a yellow green solution which was allowed to warm to room temperature, stirred for two hours and then filtered through a 0.45 μm filter. Concentration of the filtrate to approximately 10 mL followed by addition of hexanes (20 mL) afforded yellow solids which were filtered off (in air), washed with hexanes (5×5 mL) and dried in vacuo. Yield 10.94 g (89%). NMR data: ¹H NMR (δ, CD₂Cl₂): 1.37 (dd, 36H, CHCH₃), 1.77 (s, 6H, CCH₃), 2.12 (m, 6H, CH) ³¹P NMR (δ, CD₂Cl₂): 32.9 (s).

### Example 2

### Preparation of Pd(OAc)₂(P(Cy)₃)₂

In a two-neck round bottom flask equipped with an addition funnel, a reddish brown suspension of Pd(OAc)₂ (5.00 g, 22.3 mmol) in CH₂Cl₂ (50 mL) was set to stir at −78° C. The addition funnel was charged with a CH₂Cl₂ solution (30 mL) of P(Cy)₃ (13.12 g, 44.6 mmol) which was then added dropwise to the stirring suspension over the course of 15 minutes resulting in a gradual change from reddish brown to yellow. After 1 hour of stirring at −78° C. the suspension was allowed to warm to room temperature, stirred for an additional two hours and then diluted with hexanes (20 mL). The yellow solids were then filtered off in air, washed with pentane (5×10 mL) and dried in vacuo. A second crop was isolated by cooling the filtrate to 0° C. and filtering, washing and drying as previously described. Yield 15.42 g (88%). NMR data: ¹H NMR (δ, CD₂Cl₂): 1.18-1.32 (br m, 18H, Cy), 1.69 (br m, 18H, Cy), 1.80 (br m, 18H, Cy) 1.84 (s, 6H, CH₃), 2.00 (br d, 12H, Cy). ³¹P NMR (δ, CD₂Cl₂): 21.2 (s).

### Example 3

### Preparation of trans-Pd(O₂C-t-Bu)₂(P(Cy)₃)₂

Pd(O₂C-t-Bu)₂(1.3088 g, 4.2404 mmol) was dispersed in CH₂Cl₂ (10 mL) in a 100 mL Schlenk flask, the contents of the flask was cooled to −78° C. and stirred. To the above solution was slowly added the CH₂Cl₂ (15 mL) solution of P(Cy)₃ (2.6749 g, 9.5382 mmol) via a syringe, stirred for an hour at −78° C. and at room temperature for 2 hours. Hexane (20 mL) was added to the above reaction mixture to give the title complex as a yellow solid (1.39 g). The solid was filtered, washed with hexane (10 mL) and dried under reduced pressure. Solvent was removed from the filtrate to give an orange solid which was then dissolved in CHCl₃/hexane mixture (1/1: v/v) and the resulting solution was evaporated inside a fume hood to give more of the title complex (648 mg). Total yield=2.04 g (2.345 mmol), 55%. Analysis Calcd for C₄₆H₈₄O₄P₂Pd: C, 63.54; H, 9.74%.

### Example 4

### Preparation of Pd(OAc)₂(P(Cp)₃)₂

In a N₂ filled flask, a reddish brown suspension of Pd(OAc)₂ (2.00 g, 8.91 mmol) in CH₂Cl₂ (˜25 mL) was set to stir at −78° C. With a cannula, P(Cp)₃ (4.25, 17.83 mmol) in CH₂Cl₂ (˜20 mL) was added drop wise to the stirring suspension over the course of 10 minutes resulting in a gradual change from orange brown to yellow. The suspension was allowed to warm to room temperature and stirred for an additional 1 hour. Concentration of the solvent (˜5 mL) followed by addition of hexanes (˜15 mL) afforded yellow solids which were filtered off in air, washed with hexanes (5×10 mL) and dried in vacuo. A second crop was isolated by cooling the filtrate to 0° C. and filtering, washing, and drying as set forth in Example 3. Yield 4.88 g (85%). NMR data: ¹H NMR (δ, CD₂Cl₂): 1.52-1.56 (br m, 12H, Cp₃), 1.67-1.72 (br m, 12H, Cp₃), 1.74 (s, 6H, CH₃), 1.85-1.89 (br m, 12H, Cp₃), 1.96-1.99 (br d, 6H, Cp₃), 2.03-2.09 (br m, 12H, Cp₃). ³¹P NMR (δ, CD₂Cl₂): 22.4 (s).

### Example 5

### Preparation of Pd(O₂CCF₃)₂(P(Cy)₃)₂

Pd(O₂CCF₃)₂ (1.5924 g, 4.790 mmol) was dispersed in CH₂Cl₂ (10 mL) in a 100 mL Schlenk flask, the contents of the flask was cooled to −78° C. and stirred. To the above solution was slowly added the CH₂Cl₂ (16 mL) solution of P(Cy)₃ (2.8592 g, 10.1954 mmol) via a syringe, the contents of the flask was stirred for an hour at −78° C. and at room temperature for 2 hours. Hexane (20 mL) was added to the above reaction mixture to give a yellow solid. The solid was filtered, washed with hexane (10 mL) and dried under reduced pressure to furnish the title complex (2.48 g). Solvent was removed from the filtrate to give an orange solid which was then dissolved in THF and the resulting solution was evaporated inside the fume hood to give more of the title complex (380 mg). Total yield=2.86 g (3.201 mmol), 67%. Elemental analysis Calcd for C₄₀H₆₆O₄P₂F₆Pd: C, 53.78; H, 7.45%. Found: Trial 1. C, 53.90; H, 7.24; Trial 2. C, 53.84; H, 7.08.

### Example 6

### Preparation of Pd(O₂CPh)₂(PCy₃)₂

Pd(O₂CPh)₂ (0.742 g, 2.126 mmol) was dispersed in CH₂Cl₂ (10 mL) in a 100 mL Schlenk flask, the contents of the flask was cooled to −78° C. and stirred. To the above solution was slowly added the CH₂Cl₂ (7 mL) solution of P(Cy)₃ (1.2814 g, 4.569 mmol) via a syringe, the contents of the flask was stirred for an hour at −78° C. and then at room temp for 2 hours. The volume of the reaction mixture was reduced to ca 7.0 mL and diluted with hexane (18 mL) that furnished the title complex as a yellow solid (602 mg). More of the title complex was recovered from the filtra by the following method. The mother liquor was allowed to evaporate slowly inside a fume hood during which time, the title complex deposited as yellow powder (550 mg). Total yield=60% (1.152 g, 1.266 mmol). Elemental analysis Calcd for C₅₀H₇₆O₄P₂Pd: C, 66.03; H, 8.42%.

### Example 7

### Pd(OAc)₂(P(Cy)₂(CMe₃))₂

A solution of PCy₂^{t}Bu (35.42 g, 155 mmol) in toluene (50 mL) and CH₃CN (100 mL) was added dropwise to a suspension of Pd(OAc)₂ (17.3 g, 77.3 mmol) in CH₃CN (400 mL) chilled to −78° C. After 10 minutes, the cryo-bath was removed and the reddish brown mixture was warmed to RT with stirring. The solution turned orange and a yellow precipitate formed. After stirring for 15 h, the solvent was removed by rotary evaporation at 25° C. and the resulting oil was taken up in Et₂O (130 ml) and solids were precipitated by addition of pentane (300 mL). The solvent was decanted away and the solids isolated by filtration. A second crop of Pd(OAc)₂(PCy₂t-Bu)₂ can be isolated by cooling the mother liquor to −30° C. for several hours. The material is isolated as an air-stable yellow solid (56.6 g, 77.3 mmol).

### Example 8

### Pd(OAc)₂(P(i-Pr)(CMe₃)₂)₂

In a N₂-filled flask a reddish brown suspension of Pd(OAc)₂ (1.00 g, 4.45 mmol) in CH₂Cl₂ (25 mL) was set to stir at −78° C. as a CH₂Cl₂ (25 mL) solution of P^{t}Bu₂ⁱPr (1.68 g, 8.90 mmol) was added (also at −78° C.) dropwise via cannula over the course of 15 minutes resulting in a gradual change from reddish brown to orange. The suspension was allowed to warm to room temperature and stir for one hour at which time the solution was reduced to dryness leaving a yellow solid. Yield 2.2 g (82%).

### Example 9

### Pd(OAc)₂(P(i-Pr)₂(CMe₃))₂

In a N₂-filled flask a reddish brown suspension of Pd(OAc)₂ (1.00 g, 4.45 mmol) in CH₂Cl₂ (15 mL) was set to stir at 0° C. as a CH₂Cl₂ (10 mL) solution of P^{t}BuⁱPr₂ (1.55 g, 8.90 mmol) was added (also at 0° C.) dropwise via cannula over the course of 15 minutes resulting in a gradual change from reddish brown to orange. The suspension was allowed to warm to room temperature and stir for two hours at which time the solution was concentrated to approximately 5 mL affording some yellow solids. The addition of petroleum ether (5 mL) afforded more solids which were filtered off, washed with hexanes (3×3 mL) and dried in vacuo. Yield 1.6 g (63%). A second crop was isolated by cooling the filtrate to −15° C. and isolating the precipitated materials as above.

### Example 10

### Reaction of Pd(OAc)₂ with Tricyclopropylphosphine (P(c-Pr)₃) and LiFABA

In a N₂-filled flask a reddish brown suspension of Pd(OAc)₂ (0.50 g, 2.23 mmol) in CH₂C₁₂ (15 mL) was set to stir at −35° C. as a CH₂Cₗ₂ (5 mL) solution of PcPr₃ (0.69 g, 2.23 mmol) was added (also at −35° C.) dropwise over the course of 5 minutes resulting in a color change from reddish brown to orange. The suspension was allowed to warm to room temperature and stir for one hour at which time the solution was filtered through a 0.45 □m Teflon filter and the filtrate reduced approximately 2-3 mL affording yellow solids. The addition of petroleum ether (4 mL) afforded more solids which were filtered off, washed with petroleum ether (2×2 mL) and dried in vacuo. Yield 0.80 g (68%).

### EXAMPLES 11-19

### Preparation of Palladium Proinitiator Compounds Without LB Adducts

### Example 11

### Pd(P(Cy)₃)₂(κ²-O,O′—OAc)][B(C₆F₅)₄

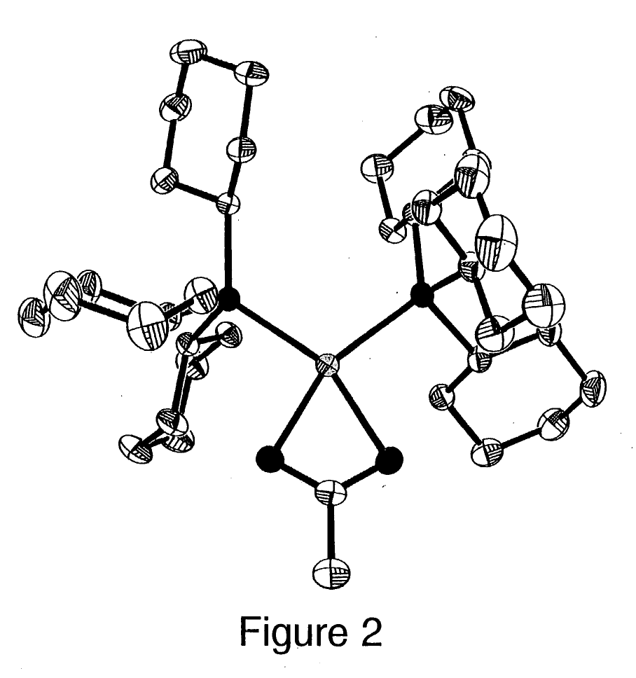

Method 1: The methylene chloride solution (25 mL) of PhN(Me)₂HB(C₆F₅)₄ (DANFABA) (1.025 g, 1.2793 mmol) was slowly added to the methylene chloride solution (50 mL) of Pd(OAc)₂(P(Cy)₃)₂ (1.004 g, 1.2729 mmol) and stirred at room temperature for 21 hours. During the course of the above reaction the color of the reaction mixture became deep orange. Volatiles from the reaction mixture were removed under reduced pressure to give a paste to which was added diethyl ether (ca 30 mL) that resulted in the formation of an orange powder. The orange powder was filtered, washed with acetonitrile and vacuum dried to furnish the title compound (1.020 g, 0.726 mmol) as an air and moisture stable orange solid. Yield=57%. Crystals were grown by diffusing ether or acetonitrile into the THF solution of the title compound (see FIG. 2 for X-ray structural analysis).

Method 2: Methylene chloride (5 mL) was syringed into the mixture of Pd(P(Cy)₃)₂(OAc)₂ (333 mg, 424 μmol) and 4-toluenesulfonic acid monohydrate (85 mg, 446 μmol) and stirred for 22 hours. The ³¹P NMR spectrum of the reaction mixture revealed a new peak at δP=59.0 and no peak was observed for Pd(OAc)₂(P(Cy)₃)₂ (δP=21.3). Therefore, methylene chloride (2 mL) solution of Li(Et_{2O})_{2.5}B(C₆F₅)₄ (Li(OEt₂)_{2.5}FABA) (400 mg, 459 μmol) was introduced into the above reaction mixture, stirred for 5 min, filtered through the medium porosity frit. Solvent was removed from the filtrate under reduced pressure to give foam that was then triturated with hexane (5 mL) and dried under reduced pressure to give a yellow solid (577 mg). This solid was washed with acetonitrile (2×3 mL) to remove unreacted Li(Et_{2O})_{2.5}B(C₆F₅)₄ and dried under reduced pressure to give the title compound (471 mg, 335 μmol) in 79% yield. Elemental analysis Calcd for C₆₂H₆₉O₂P₂BF₂₀Pd: C, 52.99; H, 4.95% Found, Trial 1: C, 53.30; H, 5.03; Trial 2: C, 53.29; H, 5.05.

### Example 12

### Preparation of [(P(Cy-d₁₁)₃)₂Pd(κ²-O,O—OAc)][B(C₆F₅)₄]

Pd(OAc)₂(P(Cy-d₁₁)₃)₂ (111 mg, 0.130 mmol ) and p-toluenesulfonic acid (28 mg, 0.147 mmol) were stirred in 2 mL CH₂Cl₂ for 12 hours. A solution of Li(Et₂O)_{2.5}[B(C₆F₅)₄] (133 mg, 0.153 mmol) in 1 mL CH₂Cl₂ was added, the solution stirred for 15 min, and the mixture filtered. Volatiles was removed in vacuo to give [(P(Cy-d₁₁)₃)₂Pd(κ²-O,O—OAc)][B(C₆F₅)₄] as a light orange powder, 0.166 g, 85%. ¹P{H} NMR (C₆D₆): δ 36.9 ppm.

### Example 13

### Pd(κ²-O,O′—OAc)(P(i-Pr)₃)₂][B(C₆F₅)₄

Methylene chloride (7 mL) was syringed into the mixture of Pd(OAc)₂(P(i-Pr)₃)₂ (378 mg, 694 μmol) and 4-toluenesulfonic acid monohydrate (137 mg, 720 μmol) and stirred for 22 hours. The ³¹P NMR spectrum of the reaction mixture revealed a new peak at δp=70.1 and other unidentified products [δP=37.1, 54.0 (s)] and no peak was observed for Pd(OAc)₂(P(i-Pr)₃)₂(δP=33.0). Therefore, methylene chloride (4 mL) solution of Li(Et₂O)_{2.5} FABA (628 mg, 720 μmol) was introduced into the above reaction mixture, stirred for 5 minutes and solvent removed under reduced pressure to give an orange solid. The orange solid was sonicated with diethyl ether (3×5 mL). During the course of sonication, a yellow powder deposited which was filtered and dried under reduced pressure to give the title compound (645 mg, 0.554 mmol). Yield=80%. Pd-1165 is a yellow solid. Elemental analysis Calcd for C₄₄H₄₅O₂P₂PdBF₂₀: C, 45.36; H, 3.89%. Found C, 45.37; H, 3.88.

### Example 14

### Pd(κ²-O,O′—OAc)(P(Cp)₃)₂][B(C₆F₅)₄

In a 25 mL Schlenk reaction flask Pd(OAc)₂(P(Cp)₃)₂ (500 mg, 0.71 mmol) and 4-toluenesulfonic acid-monohydrate (80 mg, 0.73 mmol) were added and dissolved in 10 mL CH₂Cl₂. The orange solution was allowed to stir for 22 hours after which time it turned a dark purple/brown color. With a cannula Li(OEt₂)_{2.5}FABA (640 mg, 0.73 mmol) dissolved in 5 mL CH₂Cₗ₂ was added drop-wise over 5 minutes. The solution was allowed to stir for 5 minutes then the solvent was removed under vacuum. The resulting orange/purple crystals were then redissolved in CH₂Cl₂ and filtered with a syringe filter. The filtrate was then reduced under vacuum to orange brown crystals. Yield: 0.68 g (72%)

### Example 15

### Pd(κ²-O,O′—O₂C-t-Bu)(P(Cy)₃)₂[]B(C₆F₅)₄

Methylene chloride (18 mL) was syringed into the mixture of Pd(O₂C-t-Bu)₂(P(Cy)₃)₂ (448 mg, 515 mmol) and 4-toluenesulfonic acid monohydrate (107 mg, 563 mmol) and stirred for 24 hours. The ³¹P NMR spectrum of the reaction mixture revealed a new peak at δP=58.6 and no peak was observed for Pd(O₂C-t-Bu)₂(P(Cy)₃)₂ (δP=17.6). Therefore, methylene chloride (4 mL) solution of Li(Et₂O)_{2.5}FABA (512 mg, 588 mmol) was introduced into the above reaction mixture, stirred for 10 min and filtered. Volatiles were removed from the filtrate to give a gum that was triturated with hexane (7 mL) and hexane removed under reduced pressure to give a yellow solid. The solid was dissolved in minimum amount of acetonitrile (3×5 mL) and the resulting solution was sonicated for 10 minutes. During the course of sonication, a yellow powder deposited which was filtered and dried under reduced pressure to give the title compound in 69% yield (517 mg, 0.357 mmol). Elemental analysis Calcd for C₆₅H₇₅O₂P₂PdBF₂₀: C, 53.94; H, 5.22%. Found; Trial 1. C, 53.78, H, 4.98. Trial 2. C, 53.85; H, 4.90.

### Example 16

### Pd(κ²O,O′—O₂CPh)(P(Cy)₃)₂][B(C₆F₅)₄

Method 1: DANFABA (162 mg, 0.203 mmol) was added in portions to the palladium complex of Example 6 (0.179 g, 0.197 mmol) dispersed in diethyl ether (30 mL) and stirred for 72 hours. The volume of the reaction mixture was reduced to 10 mL and diluted with hexane (15 mL) that resulted in the formation of a grey solid. The solid was washed with acetonitrile (3×6 mL) and dried under reduced pressure to furnish the title compound as a yellow solid (150 mg, 0.1022 mmol) in 52% yield. Elemental analysis Calcd. for C₆₇H₇₁O₂P₂PdBF₂₀: C, 54.84; H, 4.88%. Found; Tr 1. C, 54.58; H, 4.89. Tr 2. C, 54.72; H, 4.71.

Method 2: Methylene chloride (6 mL) was syringed into the mixture of Pd(O₂CPh)₂(P(Cy)₃)₂ (128 mg, 0.141 mmol) and 4-toluenesulfonic acid monohydrate (0.032 mg, 0.170 mmol) and stirred for 24 h. Subsequently, methylene chloride (3 mL) solution of Li(Et₂O)_{2.5}FABA(154 mg, 0.177 mmol) was introduced into the above reaction mixture, stirred for 10 minutes and filtered. Volatiles were removed from the filtrate to give a yellow solid (0.192 mg) of the title compound which was contaminated with trace amounts of unidentified product.

### Example 17

### Reaction of [Pd(OAc)(P(c-Pr)₃)]₂(μ-OAc)₂ with Li(OEt₂)_{2.5}[B(C₆F₅)₄]

In a N₂-filled flask a yellow solution of [Pd(OAc)(P(c-Pr)₃)]₂(μ-OAc)₂ (0.25 g, 0.47 mmol) in CH₂Cl₂ (10 mL) was set to stir as a CH₂Cl₂ (10 mL) solution of p-toluenesulfonic acid (0.09 g, 0.47 mmol) was added resulting in a gradual change from yellow to slightly orange. The solution was allowed to stir for 15 minutes at which time a solution of Li(OEt₂)_{2.5}[B(C₆F₅)₄] (0.41 g, 0.47 mmol) in CH₂Cl₂ (10 mL) was added. The resulting yellow/brown suspension was stirred for 15 minutes and then filtered through a 0.45 μm Teflon filter and the yellow filtrate dried, affording a yellow foam. Yield 0.42 g. When a solution of this material (0.0004 g) in CH₂Cl₂ (0.1 mL) was added to a pan containing a mixture of decylnorbornene (1.63 g) and trimethoxysilylnorbornene (0.37 g) and heated to 130° C., the resulting mixture formed a gel within 15 minutes. After 1 hour a solid mass was obtained.

### Example 18

### (P(i-Pr₃))₂Pd(κ²-O,O—O₂CCMe₃)][B(C₆F₅)₄

300 mg of cis-[(P(i-Pr₃))₂Pd(κ²-P,C—PⁱPr₂CMe₂)(NCMe)][B(C₆F₅)₄](Example 60) (8.7 μmol) was dissolved by 3 mL CDCl₃, then 1 eq of t-BuCO₂H (27 mg) was added. The reaction mixture was stirred for 5 minutes after which time the volatile components were removed to afford a powder product of [(P(i-Pr₃))₂Pd(κ²-O,O—O₂CCMe₃)][B(C₆F₅)₄] (95% yield which was characterized by ³¹P NMR and ¹H spectroscopies. ³¹P{H} NMR (CDCl₃): δ 31.4 ppm.

### Examples 19a-19e

### [(P(i-Pr₃)₂Pd(κ²-O,O—OR)][B(C₆F₅)₄],

The title series of k²-O,O′—OAc derivatives, 19-a -19e, were prepared using the following generalized procedure. 100 mg of cis-[(P(i-Pr)₃)Pd(κ²-P,C—P(i-Pr)₂CMe₂)(NCMe)][B(C₆F₅)₄] (Example 60) (8.7 μmol) was dissolved by 3 mL CDCl₃; 1 eq of RCOOH was added. Volatiles were removed after 5 min of reaction to afford powder product which was characterized by ³¹P NMR and ¹H spectroscopies. For each of 19a-19e, below, R is identified, with the weight of product and characterization data provided.

### 19a R═—CF₃

10 mg CF₃—COOH (8.8 μmol); 98 mg 19a afforded, 92% yield. ³¹P{H} NMR (CDCl₃): δ 70.8 ppm; ¹H NMR (CDCl₃): δ 1.51 (d, 9H, CH₃); δ 1.45 (d, 9H, CH₃); δ 2.39 (m, 6H, CH).

### 19b R═—C₆F₅

19 mg C₆F₅—COOH (8.9 μmol); 110 mg 19b afforded, 96% yield. ³¹P{H} NMR (CDCl₃): δ 75.4 ppm; ¹H NMR (CDCl₃): δ 1.51 (d, 9H, CH₃); δ 1.45 (d, 9H, CH₃); δ 2.38 (m, 6H, CH).

### 19c R=-p-(CF₃)C₆H₄

17 mg p-CF₃—C₆H₄—COOH (8.9 μmol); 101 mg 19c afforded, 89% yield. ³¹P{H} NMR (CDCl₃) δ 71.7 ppm. ¹H NMR (CDCl₃): δ 1.52 (d, 9H, CH₃); δ 1.47 (d, 9H, CH₃); δ 2.39 (m, 6H, CH).

### 19d R═—C₆H₆

11 mg C₆H₅—COOH (9.0 μmol); 100 mg 19d afforded, 93% yield. 3³¹P{H} NMR (CDCl₃): δ 69.8 ppm. ¹H NMR (CDCl₃): δ 1.51 (d, 9H, CH₃); δ 1.46 (d, 9H, CH₃); δ 2.41 (m, 6H, CH); δ 7.46 (t, 2H, C₆H₅); δ 7.62 (t, 1H, C₆H₅); δ 7.92 (d, 2H, C₆H₅).

### 19e R=-p-(OMe)C₆H₄

13 mg p-(OMe)C₆H₄—COOH (8.5 μmol); 103 mg 19e afforded, 94% yield. ³¹P{H} NMR (CDCl₃): δ 68.7 ppm. ¹H NMR (CDCl₃): δ1.50 (d, 9H, CH₃); δ 1.45 (d, 9H, CH₃); δ 2.38 (m, 6H, CH); δ 3.86 (s, 3H, OCH₃); δ 6.91 (d, 2H, C₆H₄); δ 7.88 (d, 2H, C₆H₄).

### Examples 20-35

### Preparation of Proinitiator Compounds with LB Adducts

### Example 20

### trans-[Pd(OAc)(P(Cy)₃)₂(MeCN)][B(C₆F₅)₄]

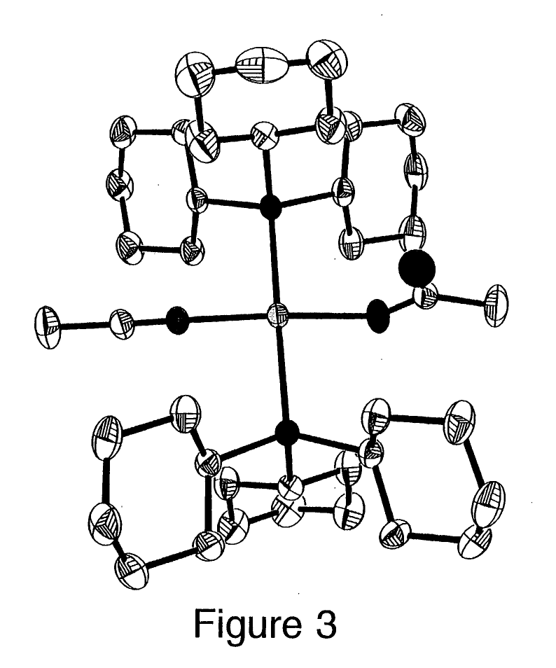

The acetonitrile (5 mL) solution of Li(Et₂O)_{2.5}B(C₆F₅)₄ (0.864 mg, 0.992 mmol) was slowly added to Pd(OAc)₂(P(Cy)₃)₂ (764 mg, 0.972 mmol) that was also dispersed in acetonitrile (40 mL). The reaction mixture was stirred for 3 hours, filtered through 0.45μ filter and solvent removed under reduced pressure to give a solid of the title compound in quantitative yield. Crystals suitable for X-ray data collection were obtained by vapor diffusion of diethyl ether into the toluene or benzene solution of the title compound at room temperature. AN ORTEP structural representation of trans-[Pd(OAc)(P(Cy)₃)₂(MeCN)][B(C₆F₅)₄] is shown in FIG. 3. Elemental analysis Calcd. for C₆₄H₇₂NO₂P₂BF₂₀Pd.1 Et₂O: C, 53.71; H, 5.44; N, 0.92%. Found: Trial 1. C, 54.13; H, 5.43; N, 0.91. Trial 2. C, 53.85; H, 5.18; N, 0.93.

### Example 21

### (P(Cy-d₁₁)₃)₂Pd(NCMe)OAc][B(C₆F₅)₄

To 4 mL CH₃CN solution of Pd(OAc)₂(P(Cy-d₁₁)₃)₂ (76 mg, 0.089 mmol ), Li(Et₂O)_{2.5}[B(C₆F₅)₄] (86 mg, 0.099 mmol) in 0.5 mL CH₃CN was added drop wise. Reaction mixture was stirred for 3 hours. Precipitated salt was filtered out through micropore filter. 0.118 g (81% yield) solid [(P(Cy-d₁₁)₃)₂Pd(NCMe)OAc][B(C₆F₅)₄] was obtained upon removal of volatiles in vacuo. ¹P{H} NMR (THF): δ 29.2 ppm.

### Example 22

### (P(Cy-d₁)₃)₂Pd(NCMe)(OAc)][B(C₆F₅)₄

To 4 mL CH₃CN solution of Pd(OAc)₂(P(Cy-d₁)₃)₂ (75 mg, 0.095 mmol), Li(Et₂O)_{2.5}[B(C₆F₅)₄] (84 mg, 0.097 mmol) in 0.5 mL CH₃CN was added drop wise. Reaction mixture was stirred for 3 hours. Precipitated salt was filtered out through micropore filter. 0.120 g (87.0% yield) light orange solid [(P(Cy-d₁)₃)₂Pd(NCMe)(OAc)][B(C₆F₅)₄] was obtained upon removal of volatiles in vacuo. ¹P{H} NMR (THF): δ 31.5 ppm.

### Example 23

### Pd(OAc)(P(i-Pr)₃)₂(MeCN)][B(C₆F₅)₄

A solution of Li(OEt₂)_{2.5}FABA (0.960 g, 1.102 mmol) in acetonitrile (10 mL) was slowly added to a stirring solution of Pd(OAc)₂(P(i-Pr)₃)₂ (0.600 g, 1.10 mmol) in acetonitrile (20 mL). The resulting yellow/orange solution was stirred for 4 hours over which time solids formed. The mixture was filtered through a 0.45 μm filter and the filtrate reduced to dryness leaving a yellow solid. Yield 1.224 g (93%). ¹H NMR (δ, CD₂Cl₂): 1.38 (m, 36H, —CH₃), 1.92 (s, 3H, —CCH₃), 2.25 (m, 6H, —CH) 2.42 (s, 3H, CH₃). ³¹P NMR (δ, CD₂C₂): 44.5 (s).

### Example 24

### trans-[Pd(OAc)(P(i-Pr)₃)₂(NC₅H₅)][B(C₆F₅)₄]

Complex trans-[Pd(OAc)(P(i-Pr)₃)₂(NC₅H₅)][B(C₆F₅)₄] was prepared by reacting [Pd(OAc)(P(i-Pr)₃)₂(MeCN)][B(C₆F₅)₄] (173 mg, 0.143 mmol) and pyridine (48 mg, 0.60 mmol) in dichloromethane (10 mL) at ambient temperature for 100 minutes. The volatiles were removed from the reaction mixture to give a residue that was triturated with hexane and collected by filtration. The solid was dried under vacuum to give the title complex in 100% yield (177 mg, 0.142 mmol). ³¹P{¹H} NMR (CD₂Cl₂): δ 33.4. ¹H NMR (CD₂Cl₂): δ 1.27 (m, 36H, CH(CH₃)₂), 1.91 (s, 3H, O₂CCH₃), 1.98 (m, 6H, CH(CH₃)₂), 7.57 (t, ³J_{HH}=7.2 Hz, ²H, C₅H₅N), 7.96 (t, ³J_{HH}=7.8 Hz, ¹H, C₅H₅N), 8.78 (d, ³J_{HH}=4.8 Hz, ²H, C₅H₅N). ¹³C{¹H} NMR (CD₂Cl₂): δ 19.6, 23.5, 24.9 (virtual t, ¹J_{CP}+³J_{CP}=9.7 Hz, 6C, CHMe₂), 124.2 (br), 128.0, 136.9 (d, ¹J_{CF}=244.9 Hz), 138.8 (d, ¹J_{CF}=243.0 Hz), 141.3, 148.7 (d, ¹J_{CF}=236.8 Hz), 154.2, 176.7. Anal. Calcd. for C₄₉H₅₀NO₂P₂PdBF₂₀.C₅H₅N: C, 49.01; H, 4.19; N, 2.12%. Found: C, 48.45; H, 3.93; N, 1.81.

### Example 25

### trans-[(PCy₃)₂Pd(O₂¹³C¹³CH₃)(MeCN)I[B(C₆F₅)₄]

The title complex was prepared in quantitative yield from trans-[(PCy₃)₂Pd(O₂¹³C¹³CH₃)₂] (100 mg, 0.127 mmol) and [Li(OEt₂)_{2.5}][B(C₆F₅)₄] (113 mg, 0.130 mmol) in acetonitrile by a procedure similar to that of Example 20. ³¹P{¹H} NMR (CDCl₃): δ 32.3. ¹H NMR (CDCl₃): δ1.17 (q, J=13.2 Hz, 12H, C₆H₁₁), 1.28 (q, J=13.2 Hz, 6H, C₆H₁₁), 1.62 (q, J=12.6 Hz, 12H, C₆H₁₁), 1.77 (br d, J=12.6 Hz, 6H, C₆H₁₁), 1.91 (q, J=13.2 Hz, ³⁰H, C₆H₁₁), 2.00 (dd, ¹J_{CH}=128.1 Hz, ³J_{HH}=5.70 Hz, ³H, O₂¹³C¹³CH₃), 2.38 (s, ³H, CH₃CN). ¹³C{¹H} NMR (CDCl₃): δ 3.31, 23.4 (d, ¹J_{CC}=54.4 Hz, ¹C, O₂¹³C¹³CH₃), 26.3, 27.9 (virtual t, ²J_{PC}+⁴J_{PC}=5.4 Hz), 29.9, 33.7 (virtual t, ¹J_{PC}+³J_{PC}=9.4 Hz), 124.6 (br), 127.2, 136.4 (d, ¹J_{CF}=242.2 Hz), 138.4 (d, ¹J_{CF}=241.6 Hz), 148.4 (d, ¹J_{CF}=242.8 Hz), 175.5 (d, ¹J_{CC}=54.4 Hz, ¹C, O₂¹³C¹³CH₃). Using the ¹H NMR signals (600 MHz) for the O₂¹³C¹³CH₃ methyl group that give rise to a large doublet of doublets, in conjunction with the much smaller singlet centered at the midpoint of the doublet of doublets for the unlabeled O₂CCH₃ methyl group, an estimate of 94% for the ¹³C incorporation could be made by relative integration (value is subject to some uncertainty, as there was some overlap with cyclohexyl resonances).

### Example 26

### Pd(OAc)(P(Cp)₃)₂(MeCN)][B(C₆F₅)₄

In a 50 mL Schlenk reaction flask a solution of Li(OEt₂)_{2.5}FABA (0.77 g, 0.88 mmol) in acetonitrile (20 mL) was slowly added via cannula to a stirring solution of Pd(OAc)₂(P(Cp)₃)₂ (0.62 g, 0.88 mmol) in acetonitrile (20 mL) at 0° C. The resulting yellow solution was allowed to warm to room temperature and stirred for an additional hour over which time solids formed. The mixture was filtered through syringe filters and the filtrate reduced to dryness leaving yellow foam. Yield: 0.94 g (78%).

### Example 27

### trans-[Pd(O₂C-t-Bu)(P(Cy)₃)₂(MeCN)][B(C₆F₅)₄]

The acetonitrile solution (6 mL) of Li(OEt₂)_{2.5}FABA (87.0 mg, 0.100 mmol) was slowly added to the CH₂Cl₂ (6 mL) solution of Pd(O₂C-t-Bu)₂(P(Cy)₃)₂ (83.6 mg, 0.096 mmol) with stirring. Stirring was continued for 5 hours and the reaction mixture was filtered through 0.45μ filter. Volatiles were removed under reduced pressure and the resulting material was triturated with pentane (10 mL) and dried under reduced pressure to give the title compound in quantitative yield. Elemental analysis Calcd for C₆₇H₇₈NO₂P₂BF₂₀Pd: C, 54.06; H, 5.28; N, 0.94%.

### Example 28

### trans-[Pd(O₂CPh)(P(Cy)₃)₂(MeCN)][B(C₆F₅)₄]

The acetonitrile solution (10 mL) of Li(OEt₂)_{2.5}FABA (142 mg, 0.164 mmol) was slowly added to the CH₂Cl₂ (6 mL) solution of Pd(O₂CPh)₂(P(Cy)₃)₂ (146 mg, 0.161 mmol) with stirring. Stirring was continued for 15 hours and the reaction mixture was filtered through 0.45μ filter. Volatiles were removed under reduced pressure to give the title compound in quantitative yield. Elemental analysis Calcd. for C₆₉H₇₄NO₂P₂PdBF₂₀: C, 54.94; H, 4.94; N, 0.93%. Found: Trial 1. C, 54.75; H, 4.75; N, 0.94. Trial 2. C, 54.97; H, 4.62; N, 0.96.

### Example 29

### trans-[Pd((O₂C)CF₃)(P(Cy)₃)₂(MeCN)][B(C₆F₅)₄]

The acetonitrile solution (3 mL) of Li(OEt₂)_{2.5}FABA (264 mg, 0.303 mmol) was slowly added to the acetonitrile (20 mL) solution of Pd((O₂C)CF₃)₂(P(Cy)₃)₂(266 mg, 0.297 mmol) with stirring. Stirring was continued for 21 hours and the reaction mixture was filtered through 0.45μ filter. The volume of the solution was reduced to 5.0 mL that produced a pale brown powder of the title compound (263 mg, 0.175 mmol) in 59% yield. Elemental analysis Calcd. for C₆₄H₆₉NO₂P₂PdBF₂₀.CD₃CN: C, 51.28; H, 4.47; N, 1.81%. Found: Trial 1. C, 51.00; H, 4.59; N, 2.12. Trial 2. C, 50.99; H, 4.58; N, 2.12.

### Example 30

### trans-[Pd(OAc)(P(Cy)₃)₂(NC₅H₅)][B(C₆F₅)₄]

trans-[Pd(PCy₃)₂(O₂CMe)(MeCN)][B(C₆F₅)₄] (198 mg, 0.137 mmol) and pyridine (61 mg, 0.77 mmol) were separately dissolved in toluene (4.0 and 1.0 mL respectively) and cooled to −35° C. The toluene solution of pyridine was added to the toluene solution of palladium complex at ambient temperature and stirred at the same temperature for 100 minutes. The volatiles from the reaction mixture were removed under vacuum to furnish a residue that was subsequently triturated with hexane (3×10 mL) and collected by filtration. The solid was dried under vacuum to give trans-[Pd(OAc)(P(Cy)₃)₂(NC₅H₅)][B(C₆F₅)₄] in 99% yield (202 mg, 0.136 mmol). ³¹P{¹H} NMR (CDCl₃): δ 22.1. ¹H NMR (CDCl₃): δ 1.04 (m, 12H, C₆H₁₁), 1.22 (m, 6H, C₆H₁₁), 1.50-1.70 (m, 18H, C₆H₁₁), 1.71-1.90 (m, 30H, C₆H₁₁), 2.00 (s, 3H, O₂CCH₃), 7.54 (t, ³J_{HH}=7.0 Hz, 2H, C₅H₅N), 7.98 (t, ³J_{HH}=7.8 Hz, 1H, C₅H₅N), 8.77 (d, ³J_{HH}=4.8 Hz, 2H, C₅H₅N). ¹³C{¹H} NMR (CDCl₃): δ 23.6, 26.7, 28.2 (virtual t, ²J_{CP}+⁴J_{CP}=5.0 Hz, C₆H₁₁), 30.2, 34.6 (virtual t, ¹J_{CP}+³J_{CP}=8.8 Hz, C₆H₁₁), 124.5 (br), 127.8, 136.8 (d, ¹J_{CF}=253.5 Hz), 138.8 (d, ¹J_{CF}=244.3 Hz), 140.8, 148.7 (d, ¹J_{CF}=237.3 Hz), 154.3, 176.0. Anal. Calcd. for C₆₇H₇₄NO₂P₂PdBF₂₀: C, 54.21; H, 5.02; N, 0.94%. Found: C, 54.34; H, 4.92; N, 0.83.

### Example 31

### trans-[Pd(OAc)(P(Cy)₃)₂(4-Me₂NC₅H₄N)][B(C₆F₅)₄]

The title complex trans-[Pd(OAc)(P(Cy)₃)₂(4-Me₂NC₅H₄N)][B(C₆F₅)₄] was prepared from trans-[Pd(PCy₃)₂(O₂CMe)(MeCN)][B(C₆F₅)₄] (210 mg, 0.145 mmol) and 4-(dimethylamino)pyridine (20 mg, 0.16 mmol) in THF (6.0 mL) in quantitative yield (221 mg). ³¹P{¹H} NMR (CDCl₃): δ 21.8. ¹H NMR (CDCl₃): δ 0.95-1.36 (m, 18H, C₆H₁₁), 1.48-1.95 (m, 48H, C₆H₁₁), 1.97 (s, ³H, O₂CCH₃), 3.03 (s, 6H, N(CH₃)₂), 6.55 (d, ³J_{HH}=6.6 Hz, ²H, 4-Me₂NC_{□}H₄N), 8.01 (d, ³J_{HH}=6.6 Hz, ²H, 4-Me₂NC₅H₄N). ¹³C{¹H} NMR (CDCl₃): δ 23.7, 26.3, 27.9 (virtual t, ²J_{CP}+⁴J_{CP}=5.4 Hz, C₆H₁₁), 29.8, 34.0 (virtual t, ¹J_{CP}+³J_{CP}=8.8 Hz, C₆H₁₁), 39.4, 108.8, 124.2 (br), 136.4 (d, ¹J_{CF}=242.2 Hz), 138.3 (d, ¹J_{CF}=243.6 Hz), 148.4 (d, ¹J_{CF}=237.9 Hz), 151.6, 154.7, 176.0. Anal. Calcd. for C₆₉H₇₉N₂O₂P₂PdBF₂₀: C, 54.25; H, 5.21; N, 1.83%. Found: C, 54.17; H, 5.03; N, 1.78.

### Example 32

### trans-[Pd(OAc)(P(Cy)₃)₂(CNC₆H₃Me₂-2,6)][B(C₆F₅)₄]

The title complex trans-[Pd(OAc)(P(Cy)₃)₂(CNC₆H₃Me₂-2,6)][B(C₆F₅)₄] was obtained in quantitative yield (316 mg) from trans-[Pd(PCy₃)₂(O₂CMe)(MeCN)][B(C₆F₅)₄] (298 mg, 0.206 mmol) and 2,6-dimethylphenyl isocyanide (28 mg, 0.21 mmol) in THF (6.0 mL). ³¹P{¹H} NMR (CDCl₃): δ 40.6. ¹H NMR (CDCl₃): δ 1.10-1.38 (m, 18H, C₆H₁₁), 1.60-1.80 (m, 18H, C₆H₁₁), 1.87 (br d, J=12.0 Hz, 12H, C₆H₁₁), 2.03 (br d, J=12.0 Hz, 12H, C₆H₁₁), 2.06 (s, 3H, O₂CCH₃), 2.16 (m, 6H, C₆H₁₁), 2.47 (s, 6H, C₆H₃(CH₃)₂-2,6), 7.24 (d, ³J_{HH}=7.3 Hz, ²H, C₆H₃(CH₃)₂-2,6), 7.37 (t, ³J_{HH}=7.3 Hz, ¹H, C₆H₃(CH₃)₂-2,6). ¹³C{¹H} NMR (CDCl₃): δ 18.9, 24.4, 26.6, 28.1 (virtual t, ²J_{CP}+⁴J_{CP}=5.3 Hz, C₆H₁₁), 30.7, 35.6 (virtual t, ¹J_{CP}+³J_{CP}=9.4 Hz, C₆H₁₁), 124.4 (br), 125.7, 129.8, 132.1, 135.4, 136.8 (d, ¹J_{CF}=249.9 Hz), 138.8 (d, ¹J_{CF}=252.4 Hz), 148.7 (d, ¹J_{CF}=243.7 Hz), 176.0. Anal. Calcd. for C₇₁H₇₈NO₂P₂PdBF₂₀.THF: C, 55.99; H, 5.39; N, 0.87%. Found: C, 56.23; H, 5.38; N, 0.78.

### Example 33

### trans-[(P(i-Pr)₃)₂Pd(O₂CCH₃)CNC₆H₃Me₂-2,6)][B(C₆F₅)₄]

trans-[(P(i-Pr)₃)₂Pd(O₂CCH₃)(CNC₆H₃Me₂-2,6)][B(C₆F₅)₄]was prepared from the reaction of 2,6-dimethylphenyl isocyanide with [Pd(κ²-OAc)(P(i-Pr)₃)₂)][B(C₆F₅)₄] or [Pd(OAc)(P(i-Pr)₃)₂(MeCN)][B(C₆F₅)₄].

From [Pd(κ²-OAc)(P(i-Pr)₃)₂][B(C₆F₅)₄] Complex [Pd(κ²-OAc)(P(i-Pr)₃)₂][B(C₆F₅)₄] (98 mg, 84.1 μmol) and 2,6-dimethylphenyl isocyanide (13 mg, 99 μmol) were separately dissolved in THF (4.0 and 1.0 mL respectively) and cooled to −35° C. The THF solution of 2,6-dimethylphenyl isocyanide was added to the THF solution of [Pd(κ²-OAc)(P(i-Pr)₃)₂][B(C₆F₅)₄] and stirred at ambient temperature for 2 hours. The volatiles from the reaction mixture were removed under vacuum to furnish trans-[(ⁱPr₃P)₂Pd(O₂CCH₃)(CNC₆H₃Me₂-2,6)][B(C₆F₅)₄] in quantitative yield (108 mg, 83.4 μmol).

From [Pd(OAc)(P(i-Pr)₃)₂(MeCN)][B(C₆F₅)₄] Complex [Pd(OAc)(P(i-Pr)₃)₂(MeCN)][B(C₆F₅)₄] (197 mg, 0.163 mmol) and 2,6-dimethylphenyl isocyanide (23 mg, 0.175 mmol) were separately dissolved in dichloromethane (6.0 and 4.0 mL respectively). The dichloromethane solution of 2,6-dimethylphenyl isocyanide was added to the dichloromethane solution of [Pd(OAc)(P(i-Pr)₃)₂(MeCN)][B(C₆F₅)₄] at ambient temperature and stirred at the same temperature for 3 hours. The volatiles from the reaction mixture were removed under vacuum to furnish trans-[(ⁱPr₃P)₂Pd(O₂CCH₃)(CNC₆H₃Me₂-2,6)][B(C₆F₅)₄] as a light brown solid in quantitative yield (210 mg, 0.162 mmol). ³¹P{¹H} NMR (CD₂Cl₂): δ 53.8. ¹H NMR (CD₂Cl₂): δ 1.42 (m, 36H, CH(CH₃)₂), 1.96 (s, 3H, O₂CCH₃), 2.43 (s, 6H, C₆H₃(CH₃)₂-2,6), 2.47 (m, 6H, CH(CH₃)₂), 7.22 (d, ³J_{HH}=7.5 Hz, ²H, C₆H₃(CH₃)₂-2,6), 7.36 (t, ³J_{HH}=7.5 Hz, ¹H, C₆H₃(CH₃)₂-2,6). ¹³C{¹H} NMR (CD₂Cl₂): δ 19.1, 20.1, 24.1, 26.0 (virtual t, ¹J_{CP}+³J_{CP}=10.6 Hz, CHMe₂), 124 (br), 125.5, 129.7, 132.1, 135.7, 136.9 (d, ¹J_{CF}=243.0 Hz), 138.8 (d, ¹J_{CF}=242.4 Hz), 148.7 (d, ¹J_{CF}=239.9 Hz), 176.6. Anal. Calcd. for C₅₃H₅₄NO₂P₂PdBF₂₀: C, 49.10; H, 4.20; N, 1.08%. Found: C, 48.94; H, 3.88; N, 1.52.

### Example 34

### trans-[Pd(OAc)(P(i-Pr)₂(CMe₃))₂(MeCN)][B(C₆F₅)₄]

In a N₂-filled flask a reddish brown suspension of Pd(OAc)₂ (1.00 g, 4.45 mmol) in CH₃CN (15 mL) was cooled to 0° C. and set to stir as a CH₃CN (10 mL) solution of P^{t}BuⁱPr₂ (1.55 g, 8.90 mmol) was added resulting in a gradual change to a yellow. The solution was allowed to warm to room temperature and stir for 30 minutes at which time a solution of Li(OEt₂)_{2.5}[B(C₆F₅)₄] (0.41 g, 0.47 mmol) in CH₃CN (10 mL) was add The resulting yellow/brown suspension was stirred for 1 hour and then filtered through a 0.45 μm Teflon filter and the yellow filtrate reduced dryness affording a yellow foam.

### Example 35

### Preparation of [Pd(OAc)(MeCN)(P(Cy₂)t-butyl)₂]B(C₆F₅)₄

A solution of P(Cy₂)t-butyl (35.42 g, 155 mmol) in CH₃CN (100 mL) was added dropwise to a suspension of Pd(OAc)₂ (17.3 g, 77.3 mmol) in CH₃CN (400 mL) chilled to −78° C. After 10 minutes, the cryo-bath was removed and the reddish brown mixture was warmed to RT with stirring. The solution turned orange and a yellow precipitate formed. After stirring for 3 h, a solution of Li(Et₂O)_{2.5}[B(C₆F₅)₄] (LiFABA) (67.3 g, 77.3 mmol) in CH₃CN (150 mL) was added. The suspension was stirred for 5 h, diluted with toluene (100 mL), and then filtered through a ¼ inch pad of Celite™ filtering aid to remove the lithium acetate by-product. The yellow/orange filtrate was concentrated in vacuo to a golden syrup consistency, washed with a 1:5 v/v mixture of ether and pentane (2×300 mL), pentane (2×300 mL), and concentrated using the rotary evaporator (35° C.). Pumping in vacuo for 24 hours afforded [Pd(OAc)(MeCN)(P((Cy₂)t-butyl)₂]B(C₆F₅)₄ (100 g, 72 mmol, 93%) as an amorphous yellow solid.

### Examples 36-39

### Solution Polymerization

### Example 36

### Solution Polymerization of Decylnorbornene

Stock solutions of the compounds were made by dissolving known amounts of materials indicated in Table 1 in dichloromethane (10 mL). From these solutions, 0.1 mL was syringed into a toluene solution of 5-decylnorbornene (which was previously sparged with nitrogen), and the resulting solution was heated to 63° C. in sealed vials. The contents of each vial were heated 3 h, and then cooled under nitrogen, and poured into a beaker that contained methanol (125 mL) in air. The resulting methanol insoluble colorless polymers were isolated and dried in the oven for 20 hr at 65° C. All runs were carried out in toluene (17 mL) for 3 h at 63° C. (±3) at 10.7 mM of 5-decylnorbornene and 0.4 μM of initiator concentrations unless stated otherwise. Molecular weights were determined using polystyrene standard. 5-decyl norbornene/Initiator ratio: 26700.

TABLE 1

| | Conver- | | | |
|---|---|---|---|---|
| | sion | | | |
| Proinitiator/Initiator | (%) | Mw | Mn | Mw/Mn |
| [Pd(P(Cy)₃)₂(k²-O, | 86 | 1615000 | 94300 | 1.7 |
| O′-OAc)][B(C₆F₅)₄] | | | | |
| [Pd(OAc)(P(Cy)₃)₂(NCMe)] | 74 | 1965000 | 1245000 | 1.6 |
| [B(C₆F₅)₄] | | | | |
| [Pd(OAc)(P(i-Pr)₃)₂ | 66 | 1924000 | 617000 | 3.1 |
| (MeCN)][B(C₆F₅)₄] | | | | |
| [Pd(H)(P(Cy₃)₂(NCCH₃)] | 98 | 1311000 | 737000 | 1.8 |
| [B(C₆F₅)₄] | | | | |
| [Pd(H)(P(i-Pr)₃)₂(NCCH₃)] | 92 | 1369000 | 768000 | 1.8 |
| [B(C₆F₅)₄] | | | | |

The above polymerization details indicate that the palladium precursors of emdodiments of this invention generate in situ hydride species that possess essentially the same activity as the Pd-H+ initiators of Examples 66 and 70.

### Example 37

### Solution Polymerization of Decylnorbornene/trimethoxysilylnorbornene with 1-Hexene

In a stainless steel reactor, decylnorbornene (146.5 g), trimethoxysilylnorbornene (33.5 g) and 1-hexene (12.2 mL) were mixed with toluene (1170 mL), sparged with N₂ and set to stir at 80° C. A solution of [Pd(OAc)(MeCN)((P(i-Pr)₃)₂]B(C₆F₅)₄] (0.038 g) in toluene (10 mL) was added and the solution was stirred for three hours. The resulting viscous polymer solution was then precipitated by slow addition of methanol. The resulting white solid polymer was washed with methanol and dried in vacuo. Yield 144.8 g (80%) Mn=61868, Mw=152215, PDI=2.46.

### Example 38

### Solution Polymerization of Decylnorbornene/trimethoxysilylnorbornene with Ethylene

In a stainless steel reactor, decylnorbornene (146.5 g) and trimethoxysilylnorbornene (33.5 g) were mixed with toluene (1170 mL) and sparged with N₂. Ethylene was added (300 cc) and the solution was set to stir at 80° C. A solution of [Pd(OAc)(P(i-Pr)₃)₂(MeCN)][B(C₆F₅)₄] (0.038 g) in toluene (10 mL) was added and the solution was stirred for three hours. The resulting viscous polymer solution was then precipitated by slow addition of methanol. The resulting white solid polymer was washed with methanol and dried in vacuo. Yield 146.7 g (82%) Mn=37,815, Mw=100,055, PDI=2.65.

### Example 39

### Solution Polymerization of Decylnorbornene with 1-Hexene

In a stainless steel reactor, decylnorbornene (180.0 g) and 1-hexene (12.2 mL) were mixed with toluene (1170 mL), sparged with N₂ and set to stir at 80° C. A solution of [Pd(OAc)(P(i-Pr)₃)₂(MeCN)][B(C₆F₅)₄] (0.038 g) in toluene (10 mL) was added and the solution was stirred for three hours. The resulting viscous polymer solution was then precipitated by slow addition of methanol. The resulting white solid polymer was washed with methanol and dried in vacuo. Yield 144.8 g (80%) Mn=225,000, Mw=677,000, PDI=3.00.

### Example 40

### Mass Polymerization of Butylnorbornene

A solution of [Pd(κ²-O,O′—OAc)P(Cy)₃)₂][B(C₆F₅)₄] (0.002 g) in CH₂Cl₂ (0.1 mL) was added to a pan containing butylnorbornene (5.00 g) heated to 130° C. Within 10 minutes, the liquid monomer cured to yield a solid material.

### Example 41

### Mass Polymerization of Butylnorbornene

A solution of [Pd(OAc)(P(Cy)₃)₂(MeCN)][B(C₆F₅)₄] (0.002 g) in CH₂Cl₂ (0.1 mL) was added to a pan containing butylnorbornene (5.00 g) heated to 130° C. Within 10 minutes, the liquid monomer cured to yield a solid material.

### Example 42

### Mass Polymerization of Butylnorbornene

A solution of [Pd(κ²-O,O′—OAc)(P(i-Pr)₃)₂][B(C₆F₅)₄] (0.002 g) in CH₂Cl₂ (0.1 mL) was added to a pan containing butylnorbornene (5.00 g) heated to 130° C. Within 10 minutes, the liquid monomer cured to yield a solid material.

### Example 43

### Mass Polymerization of Butylnorbornene

A solution of [Pd(OAc)(P(i-Pr)₃)₂(MeCN)][B(C₆F₅)₄] (0.002 g) in CH₂Cl₂ (0.1 mL) was added to a pan containing butylnorbornene (5.00 g) heated to 130° C. Within 10 minutes, the liquid monomer cured to yield a solid material.

The polymerizations exemplified in Examples 38-43 each employ the proinitiator of Formula 1, where p=r=1. Such proinitiators have a 1:1 WCA:Pd equivalent ratio. To evaluate whether or not the use of an excess of a weakly coordinating anion for the polymerization is advantageous, the mass polymerizations of Examples 44-47, below, were performed where the additional WCA was provided. In addition, a solution polymerization was carried out, Example 48 to evaluate the effect of an excess of the WCA on polymer yield.

### Examples 44-47

### Effect of an Excess of WCA in Mass Polymerizations

TABLE 2

| | # of Excess | | |
|---|---|---|---|
| Example | Equiv. of | | |
| No. | DANFABA | ΔH (J/g) | Peak Temp. (° C.) |
| 44 | 0 | 224.6 | 116.3 |
| 45 | 1 | 261.4 | 107.9 |
| 46 | 2 | 257.9 | 109.4 |
| 47 | 4 | 255.9 | 83.8 |

For each of Examples 44-47, an 80:20 (mol %) mixture of decylnorbornene and trimethoxysilylnorbornene (10 g, 43 mmol) was charged with the proinitiator [Pd(OAc)(P(i-Pr)₃)₂(NCMe)][B(C₆F₅)₄] (2.1 mg, 1.74 μmol) and the excess number of equivalents of the WCA salt, PhN(Me)₂HB(C₆F₅)₄ (DANFABA) indicated in Table 2 (equivalents relative to Pd in the proinitiator). The reaction mixture was then heated from room temperature to 300° C. at a rate of 10° C./minute and ΔH and peak temperature measured using a Differential Scanning Calorimeter (DSC). In all cases, the thermoset materials obtained were essentially fully cured.

Result: As shown in Table 1, the addition of excess WCA salt results in a lowering of the peak temperature of the polymerization (a lowering of the activation temperature of the polymerization) compared to the Example 44 control. Therefore, formulations containing an excess of a WCA salt can be fully cured at a lower temperature than a similar formulation absent such an excess of a WCA salt.

### Example 48

### Effect of an Excess of a WCA Salt in Solution Polymerizations

In a stainless steel reactor decylnorbornene (146.5 g), trimethoxysilylnorbornene (33.5 g), PhN(Me)₂HB(C₆F₅)₄ (DANFABA; 0.075 g) and 1-hexene (12.2 mL) were mixed with toluene (1170 mL), sparged with N₂ and set to stir at 80° C. A solution of [Pd(OAc)(MeCN)(PⁱPr₃)₂]B(C₆F₅)₄ (0.038 g) in toluene (10 mL) was added and the solution was stirred for three hours. The resulting viscous polymer solution was then precipitated by slow addition of methanol. The resulting white solid polymer was washed with methanol and dried in vacuo. Yield 174.8 g (97%). Result: In comparison to the polymerization conducted without added WCA (Example 37) an improvement in yield of almost 20% is observed.

### Examples 49-50 (Comparative)

### In situ Polymerization of Decylnorbornene/trimethoxysilylnorbornene Two Component Initiator System

In a vial, a mixture of decylnorbornene (8.6 g) and trimethoxysilylnorbornene (1.9 g) was charged with Pd(OAc)₂(P(i-Pr)₃)₂ (0.001 g) and Li(OEt₂)_{2.5}FABA (0.006 g) and set to stir at room temperature (−20° C.). The solution gelled within 30 minutes.

### Example 50 (Comparative)

In a vial, a mixture of decylnorbornene (8.6 g) and trimethoxysilyl-norbornene (1.9 g) was charged with Pd(OAc)₂((P(i-Pr)₃)₂ (0.001 g) and DANFABA (0.006 g) and set to stir at room temperature (−20° C.). The solution gelled within 30 minutes.

### Example 51

### Single Component Proinitiator

In a vial, a mixture of decylnorbornene (8.6 g) and trimethoxysilyl-norbornene (1.9 g) was charged with [Pd(OAc)(MeCN)(P(i-Pr)₃)₂]B(C₆F₅)₄ (0.002 g) in CH₂Cl₂ (0.1 mL) and set to stir at room temperature (−20° C.). The solution showed only minimal increase in viscosity over a period of 48 hours.

### Example 52

### (Comparative)

### Reaction of Pd(OAc)2(P(Ph)3)2 with tritylFABA

A solution of Pd(OAc)₂(P(Ph)₃)₂ (25 mg, 33.4 μmol) in CD₂Cl₂ (0.5 mL) was stirred as a solution of tritylFABA (31 mg, 33.4 μmol) in CD₂Cl₂ (0.5 mL) was added drop-wise via pipet. The resulting deep red/black solution was sealed in an NMR tube and subjected to NMR analysis. Result: The ¹H and ³¹P NMR analysis showed the formation of at least 6 products including an orthometalated product.

### Example 53

### (Comparative)

### Reaction of Pd(OAc)₂(P(Ph)₃)₂ with Li(OEt₂)_{2.5}FABA

A solution of Pd(OAc)₂(PPh₃)₂ (25 mg, 33.4 μmol) in CD₂Cl₂ (0.5 mL) was stirred as a solution of Li(OEt₂)_{2.5}FABA (29 mg, 33.4 μmol) in CD₂Cl₂ (0.5 mL) was added drop-wise via pipet. The resulting deep red solution was sealed in an NMR tube and subjected to NMR analysis. Result: The ¹H and ³¹P NMR analysis showed the formation of at least 6 products including an orthometalated product.

### Example 54

### (Comparative)

### Reaction of Pd(OAc)₂(P(Ph)₃)₂ with DANFABA

A solution of Pd(OAc)₂(P(Ph)₃)₂ (25 mg, 33.4 μmol) in CD₂Cl₂ (0.5 mL) was stirred as a solution of DANFABA (27 mg, 33.4 μmol) in CD₂Cl₂ (0.5 mL) was added drop-wise via pipet. The resulting deep red solution was sealed in an NMR tube and subjected to NMR analysis. Result: The ¹H and ³¹P NMR analysis showed the formation of at least 6 products including an orthometalated product.

### Example 55

### (Comparative)

### Reaction of Pd(OAc)₂(P(Ph)₃)₂ with Li(OEt₂)_{2.5}FABA in CD₃CN to Yield [Pd(OAc)(P(Ph)₃)₂(CD₃CN)][FABA]

A solution of Pd(OAc)₂(P(Ph)₃)₂ (25 mg, 33.4 μmol) in CD₃CN (0.5 mL) was stirred as a solution of Li(OEt₂)_{2.5}FABA (29 mg, 33.4 μmol) in CD₃CN (0.5 mL) was added drop-wise via pipet. The resulting yellow solution was sealed in an NMR tube and subjected to NMR analysis. Result: Both ¹H and ³¹P NMR analysis showed the formation of a single product. ³¹P{¹H} NMR (CD₃CN, δ): 32.8 (s).

From Comparative Examples 49 to 51, it can be concluded that the reaction of Pd(OAc)₂(P(Ph)₃)₂ with a number of weakly coordinating anion salts does not lead to an isolable proinitiator product. The selection or addition of a Lewis base, i.e., acetonitrile, into the reaction results in the formation of a stable triarylphosphine complex of the type trans-[Pd(P(Ph)₃)₂(OAc)(MeCN)]FABA.

### Example 56

### (Comparative)

### Reaction of Pd(OAc)₂(P(i-Pr)₃)₂ with Trityl FABA at Room Temperature

Light yellow Pd(OAc)₂(P(i-Pr)₃)₂ (40 mg) was measured into an NMR tube. To this tube, 68 mg (1 eq) tritylFABA dissolved in 0.75 mL CD₂Cl₂ was added dropwise via syringe. Immediately the yellow solution turned dark golden brown in color. The solution was mixed thoroughly then submitted for NMR. Result: The presence of [Pd(κ²-O—O′—OAc)(P(i-Pr)₃)₂][(B(C₆F₅)₄] was identified as a very minor product (one of twelve signal in the ³¹P NMR).

### Example 57

### (Comparative)

### Reaction of Pd(OAc)₂(P(Cy)₃)₂ and Trityl FABA at Room Temperature to Yield [Pd(κ²-O,O′—OAc)(P(Cy)₃)₂][FABA]

Light yellow, Pd(OAc)₂(PCy₃)₂ (40 mg) was measured out in an NMR tube. To this tube, 47 mg (1 eq) tritylFABA dissolved in 0.75 mL, CD₂Cl₂ was added dropwise via syringe. Immediately the yellow solution turned black in color. The solution was mixed thoroughly then submitted for NMR. Result: ³¹P NMR identified [Pd(κ²-O,O′—Ac)₂(PCy₃)₂]FABA as the sole product. ³¹P{¹H} NMR (CD₃CN, δ): 58.9 (s).

### Example 58

### (Comparative)

### Reaction of Pd(OAc)2(P(i-Pr)3)2 with Trityl FABA at Room Temperature in Acetonitrile to Yield [Pd(OAc)(P(i-Pr)3)2(NCCH3)][FABA]

30 mg of light yellow, Pd(OAc)₂(P(i-Pr)₃)₂ was measured out in an NMR tube. To this tube, 51 milligrams (1 eq) tritylFABA dissolved in 0.75 mL MeCN-d₃ was added drop-wise via syringe. Immediately the solution turned dark brown then yellow in color with a light precipitate. Four drops of toluene-d₈ was added to dissolve the precipitate. The solution was mixed thoroughly then submitted for NMR. Result: Both ¹H and ³¹P NMR analysis showed the formation of a single product. ³¹P{¹H} NMR (CD₃CN, δ): 44.8 (s).

### Example 59

### (Comparative)

### Reaction of Pd(OAc)₂(P(Cy)₃)₂ with Trityl FABA at Room Temperature in Acetonitrile to Yield [Pd(OAc)(P(Cy)₃)₂(NCMe-d₃)]FABA

30 mg of the light yellow Pd(OAc)₂(P(Cy)₃)₂ was measured out in an NMR tube. To this tube, 35 milligrams (1 eq) tritylFABA dissolved in 0.75 mL MeCN-d₃ was added drop-wise via syringe. Immediately the solution turned dark brown then yellow in color. The solution was mixed thoroughly then submitted for NMR. Result: ³¹P NMR identified [Pd(OAc)(P(Cy)₃)₂(NCMe-d₃)][FABA] as the sole product. ³¹P{¹H} NMR (CD₃CN, δ): 32.7 (s).

From Comparative Examples 58 to 59, it can be concluded that trityl FABA can be used with the appropriate trialkylphosphine in the absence of a Lewis base to yield a stable complex. The combination of trityl FABA and a Lewis base is also an advantageous method for those complexes containing the trialkylphosphines.

### Example 60

### Preparation of cis-[Pd(κ²-P,C—P(i-Pr)₂(C(CH₃)₂)(P(i-Pr)₃) (d₃-MeCN)][B(C₆F₅)₄]

Sodium carbonate (0.1914 g, 1.8058 mmol) was added to an acetonitrile-d₃ solution (3.5 mL) of [Pd(κ²-O,O′—OAc)(P(i-Pr)₃)₂][B(C₆F₅)₄] (0.1625 g, 0.1395 mmol) and the resulting heterogeneous mixture was stirred for 15 h at room temperature. The reaction mixture was filtered and volatiles from the filtrate were removed under reduced pressure to give a waxy material (0.1546 g) of cis-[Pd(κ²-P,C—P(i-Pr)₂(C(CH₃)₂)(P(i-Pr)₃) (d₃-MeCN)][B(C₆F₅)₄]. ³¹P{¹H} NMR (CD₃CN): δ 51.7 (d, non-metalated phosphorus), 43.2 (d, metalated phosphorus), ²J_{PP}=30.23 Hz. ³¹P{¹H} NMR (THF-d₈): δ 52.4 (br, non-metalated phosphorus), 44.0 (br, metalated phosphorus). ¹H NMR (THF-d₈): δ 1.29 (m, 18H, CH(CH₃)₂), 1.46 (dd, J=17.4 Hz; 15.3 Hz, 12H, CH(CH₃)₂ and d, J=17.4 Hz, 6H, C(CH₃)₂), 1.63 (dd, J=12.75 Hz; 9.75 Hz, 6H, CH(CH₃)₂), 2.21,(m, 3H, CH(CH₃)₂), 2.65 (m, ²H, CH(CH₃)₂). ¹³C{¹H} NMR (THF-d₈): δ 1.33 (m), 20.1, 20.4 (d, J=5.1 Hz), 20.5 (m), 21.9, 23.8 (br), 45.7 (br), 125.4 (br), 137.1 (d, ¹J_{CF}=242.40 Hz), 139.1 (d, ¹J_{CF}=243.00 Hz), 149.2 (d, ¹J_{CF}=240.60 Hz). No peak was observed for CD₃CN.

In similar fashion, cis-[Pd(κ²-P,C—P(i-Pr)₂(C(CH₂)CH₃)(P(i-Pr)₃)(MeCN)][B(C₆F₅)₄] can be prepared in proteo-acetonitrile.

### Example 61

### Preparation of cis-[Pd(κ²-P,C—P(i-Pr)₂(C(CH₃)₂)(P(i-Pr)₃)(NC₅H₅)][B(C₆F₅)₄]

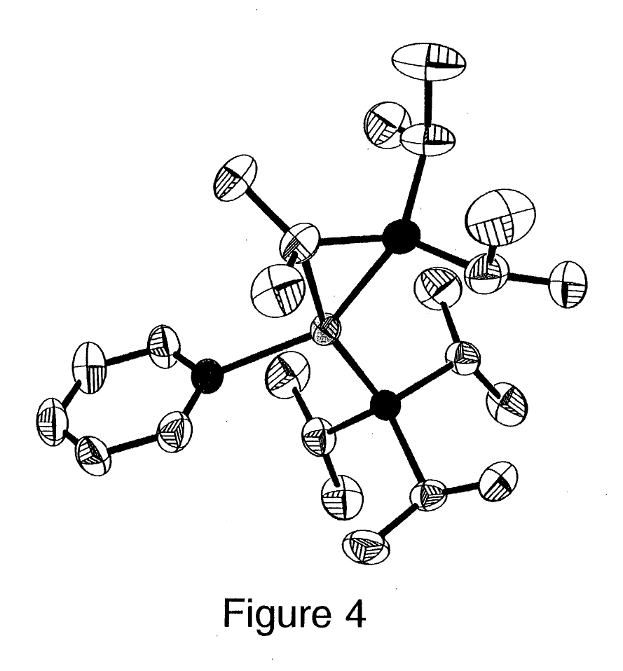

The compound of the formula [Pd(κ²-O,O′—OAc)(P(i-Pr)₃)₂][(B(C₆F₅)₄] (0.5079 g, 0.4360 mmol) was dissolved in dichloromethane (6.0 mL) and stirred. To the above solution was added dichloromethane (6 mL) solution of pyridine (0.164 g, 2.073 mmol) in air and stirred for 5 hours. The initial light orange color slowly disappeared with the development of a colorless solution. Volatiles were removed under reduced pressure to furnish the title compound in 95% yield (490 mg). Crystals were grown by vapor diffusion of pentane (or heptane) into the ether solution of cis-[Pd(κ²-P,C—P(i-Pr)₂(C(CH₃)₂)(P(i-Pr)₃)(NC₅H₅)][B(C₆F₅)₄] in a NMR tube (5 mm, 9 inch) over a period of 3 days (see FIG. 4 for X-ray structure). Assignments of the ¹H and ¹³C peaks were unambiguously made with the aid of two dimensional HMQC, HMBC and COSY NMR spectroscopic measurements. ³¹P{¹H} NMR (CDCl₃): δ 49.1 (d), 37.2 (d); ²J_{PP}=29.28 Hz. ¹H NMR (CDCl₃): δ 1.14-1.21 (m, 24H, CH(CH₃)₂, ring-C(CH₃)₂), 1.41-1.47 (m, 12H, ring-CH(CH₃)₂), 2.00 (m, 3H, CH(CH₃)₂), 2.52 (m, 2H, ring-CH(CH₃)₂), 7.50 (t, ³J_{HH}=6.30 Hz, 2H, C₅H₅N), 7.87 (t, ³J_{HH}=7.20 Hz, ¹H, C₅H₅N), 8.51 (d, ³J_{HH}=4.20 Hz, ²H, C₅H₅N). ¹³C{¹H} NMR (CDCl₃): δ 20.1 20.3, 21.8, 22.5, 24.6 (d, ¹J_{CP}=13.8 Hz), 24.8 (d, ¹J_{CP}=26.77 Hz), 40.9 (dd, ²J_{PC}=45.98, 28.27 Hz, ¹C, ring-C(CH₃)₂), 124.1 (br), 126.2, 136.4 (d, ¹J_{CF}=245.40 Hz), 138.4 (d, ¹J_{CF}=244.20 Hz), 138.8, 148.4 (d, ¹J_{CF}=237.30 Hz), 151.1. Anal. Calcd. for C₄₇H₄₆NP₂PdBF₂₀: C, 47.68; H, 3.92; N, 1.18%. Found: C, 47.67; H, 3.63; N, 1.17. See FIG. 4 for structural representation.

### Example 62

### Preparation of cis-[Pd(κ²-P,C—P(i-Pr)₂(C(CH₃)₂)P(i-Pr)₃)(2,6-Me₂py)][B(C₆F₅)₄]

In a vial, Pd(P(i-Pr)₃)₂(κ²-O,O′—OAc)][(B(C₆F₅)₄] (0.102 g) was dissolved in dichloromethane (1.0 mL) to which was added 2,6-dimethylpyridine (0.0095 g). The solution was stirred at room temperature for one hour and then the solution filtered and the product obtained by evaporation of the solvent. ³¹P{¹H} NMR (CD₂Cl₂): δ 46.71 (d), 33.53 (d); ²J_{PP}=31.30 Hz.

### Example 63

### Preparation of cis-[Pd(κ²-P,C—P(i-Pr)₂(C(CH₃)₂)P(i-Pr)₃)(2,6-Me₂py)][B(C₆F₅)₄]

In a vial, Pd(P(i-Pr)₃)₂(κ²-O,O′—OAc)][(B(C₆F₅)₄] (0.102 g) was dissolved in dichloromethane (1.0 mL) to which was added 2,6-dimethylpyridine (0.0095 g). The solution was stirred at room temperature for one hour and then the solution filtered and the product obtained by evaporation of the solvent. ³¹P{¹H} NMR (CD₂Cl₂): δ 47.18 (d), 35.92 (d); ²J_{PP}=31.65 Hz.

### Example 64

### Preparation of cis-[Pd(κ²-P,C—P(i-Pr)₂(C(CH₃)₂)P(i-Pr)₃)(4-t-BuC₅H₄N)][B(C₆F₅)₄]

The title complex was prepared in 95% yield from [Pd(P(i-Pr)₃)₂(κ²-O,O′—OAc)][(B(C₆F₅)₄] (0.5034 g, 0.4321 mmol) and 4-tert-butylpyridine (0.2282 g, 1.6877 mmol) in dichloromethane (10 mL) by a procedure similar to that adopted to prepare compound of Example 61. ³¹P{¹H} NMR (CDCl₃): δ 49.2 (d), 36.4 (d); ²J_{PP}=32.94 Hz. ¹H NMR (CDCl₃): δ 1.11-1.25 (m, ²⁴H, CH(CH₃)₂, ring-C(CH₃)₂), 1.33 (s, 9H, C(CH₃)₃), 1.40 (dd, ³J_{HH}=7.10 Hz; ³J_{PH}=4.95 Hz, 6H, ring-CH(CH₃)₂), 1.46 (dd, ³J_{HH}=7.20 Hz, ³J_{PH}=5.10 Hz, 6H, ring-CH(CH₃)₂), 1.99 (m, 3H, CH(CH₃)₂), 2.50 (m, ²H, ring-CH(CH₃)₂), 7.48 (d, ³J_{HH}=6.00 Hz, ²H, 4-Bu^{t}C₅H₄N), 8.36 (d, ³J_{HH}=6.00 Hz, ²H, 4-t-BuC₅H₄N). ¹³C{¹H} NMR (CDCl₃): δ 20.2, 20.4 (d, ²J_{PC}=3.15 Hz), 21.9 (d, ²J_{PC}=2.55 Hz), 22.6 (m), 24.6 (d, ¹J_{CP}=13.95 Hz), 24.7 (dd, ¹J_{CP}=25.20 Hz; ³J_{CP}=3.15 Hz), 30.3, 35.4, 40.5 (dd, ²J_{PC}=46.20; 29.30 Hz, ¹C, ring-C(CH₃)₂), 123.3, 124.0 (br), 136.4 (d, ¹J_{CF}=245.40 Hz), 138.4 (d, ¹J_{CF}=244.80 Hz), 148.4 (d, ¹J_{CF}=240.30 Hz), 150.6, 164.1. Anal. Calcd. for C₅₁H₅₄NP₂PdBF₂₀: C, 49.39; H, 4.39; N, 1.13%. Found: C, 49.54; H, 4.15; N, 1.44.

### Example 65

### Polymerization of Decylnorbornene and Trimethoxysilylnorbornene Using Metalated Triisopropylphosphine Palladium Proinitiators

### Effect of an Lewis Base in Pd Metalated Species in Mass Polymerizations

TABLE 2

| Example | Identity of Lewis | ΔH | Peak Temp. |
|---|---|---|---|
| No. | Base (LB) | (J/g) | (° C.) |
| 60 | MeCN | 232.5 | 114.3 |
| 61 | NC₅H₅ | 261.4 | 142.4 |
| 62 | 2,6-Me₂py | 249.5 | 141.7 |
| 63 | 2,6-Me₂pyz | 232.3 | 132.2 |

For each of Examples 60 to 63, an 80:20 (mol %) mixture of decylnorbornene and trimethoxysilylnorbornene (10 g) were charged with the proinitiator cis-[Pd(κ²-P,C—P(i-Pr)₂(C(CH₂)CH₃)P(i-Pr)₃)(LB)][B(C₆F₅)₄] at a molar ratio of 25,000:1. The reaction mixture was then heated from room temperature to 300° C. at a rate of 10° C./minute and ΔH and peak temperature measured using a Differential Scanning Calorimeter (DSC). In all cases, the thermoset materials obtained were essentially fully cured. The residual monomer was determined by performing a mass polymerization (80° C. for 30 minutes/130° C. for 30 minutes) and running a DSC. Result: As shown in Table 2, as the strength of the Lewis base increases the peak temperature of the polymerization (a higher of the activation temperature of the polymerization) compared to the Example 60 control. Therefore, the latency of formulations containing cis-[Pd(κ²-P,C—P(i-Pr)₂(C(CH₂)CH₃)P(i-Pr)₃)(LB)][B(C₆F₅)₄] species can be improved (extended pot or working life) by the addition of appropriate Lewis bases.

### Examples 66-67

### Preparation of Hydride and Deuterium Derivatives of Cationic Palladium Hydride Initiators

### Example 66

### Preparation of trans-[(Cy₃P)₂Pd(H)(MeCN)][B(C₆F₅)₄]

To an acetonitrile (30.0 mL) solution of Pd(H)Cl(PCy₃)₂ (300 mg, 0.43 mmol) kept at 0° C. was added a solution of [Ag(toluene)₃][B(C₆F₅)₄] (415 mg, 0.43 mmol) in acetonitrile (20 mL) via cannula. The resulting mixture was stirred for 1 hour and then filtered to remove precipitated AgCl. The volatiles were then removed under vacuum to yield a yellow foam. Yield 520 mg (88%). ¹H NMR (CDCl₃): δ-15.34 (t, ²JPH=6.9 Hz, ¹H, PdH), 1.10-1.53 (m, 33H, C₆H₁₁), 1.70-2.05 (m, 33H, C₆H₁₁), 2.28 (s, 3H, CH₃CN). ³¹P{¹H} NMR (CDCl₃): δ 43.6. Anal. Calcd. for C₆₂H₇₀NP₂PdBF₂₀: C, 53.64; H, 5.08; N, 1.01%. Found: C, 53.64; H, 5.07; N, 0.96. Alternatively, the title compound was prepared in quantitative yield by the reaction of [Me₂(H)NC₆H₅][B(C₆F₅)₄] and [Pd(PCy₃)₂] in acetonitrile at room temperature.

### Example 67

### Preparation of trans-[(Cy₃P)₂Pd(²H)(MeCN)][B(C₆F₅)₄]

A green suspension of HN(CH₃)₂Ph[B(C₆F₅)₄ (2.50 g, 3.1 mmol) in a 1:1 mixture of toluene and CH₂Cl₂ (50 mL) was stirred as rigorously degassed D₂O (2 mL) was added. Almost immediately the suspension cleared to a biphasic mixture of a clear aqueous layer and a soluble, pale green organic layer. The mixture was stirred for 2 hours and the organic layer was decanted via cannula and reduced to dryness leaving a very slightly pale green solid. Yield 2.32 g. ¹H NMR showed only 15% residual N—H while ²H NMR clearly showed the incorporation of ²H into the N—H bond.

A suspension of Pd(PCy₃)₂ (0.50 g, 7.5 mmol) and ²HN(CH₃)₂Ph[B(C₆F₅)₄] (0.60 g, 7.5 mmol) in d₃-MeCN (5 mL) was stirred for 2 hours at which time an aliquot was removed for analysis. ¹H and 31P NMR indicated the formation of [Pd(²H)(MeCN)(PCy₃)₂][B(C₆F₅)₄] and that no starting material remained so the aliquot was returned to the parent suspension which was subsequently filtered to removed the remaining solids. The filtrate was then concentrated to dryness leaving a beige foam. Yield 0.73 g. ¹H, ²H and ³¹P NMR showed the desired product had formed with approximately 50% incorporation of ²H into the Pd—H bond. Some ²H incorporation into the PCy₃ groups was also observed.

### Examples 68 and 69

### Effect of Isotopic Labeling on Latency

### Example 68

### Polymerization of Decylnorbornene and Trimethoxysilylnorbornene Using PCy₃ and d₃₃-PCy₃ Based Palladium Proinitiators

Into each of two separate vials was charged an 80:20 (mol %) mixture of decylnorbornene and trimethoxysilylnorbornene (2 g, 8.7 mmol) and a magnetic stir bar. To one of the vials (vial 68a) was added a CH₂Cl₂ solution (100 μL) of [Pd(OAc)(MeCN)(PCy₃)₂][B(C₆F₅)₄] (Pd 1446; 0.5 mg, 3.5×10⁻⁷ mol) while to the other vial (vial 68b) was added a CH₂Cl₂ solution (100 μL) of [Pd(OAc)(MeCN)(d₃₃-PCy₃)₂][B(C₆F₅)₄](d₆₆-Pd 1446; 0.5 mg, 3.5×10⁻⁷ mol). Both vials were sealed and set to stir at ambient temperature (21° C.). After 48 hours the solution in vial 68a was noticeably more viscous than that in vial 68b. After 100 hours the solution in vial 68a was barely flowing while the solution in vial 68b flowed much more readily. Both samples were placed in a 130° C. oven for 1 hour. Both samples cured to a solid mass.

### Example 69

### Polymerization of Decylnorbornene and Trimethoxysilylnorbornene Using Pd—H and Pd-D Based Palladium Proinitiators

Into each of two separate vials was charged an 80:20 (mol %) mixture of decylnorbornene and trimethoxysilylnorbornene (2 g, 8.7 mmol) and a magnetic stir bar. To one of the vials (vial 69a) was added a CH₂Cl₂ solution (100 μL) of [Pd(H)(MeCN)(PCy₃)₂][B(C₆F₅)₄] (Pd 1388; 0.5 mg, 3.5×10⁻⁷ mol) while to the other vial (vial 69b) was added a CH₂Cl₂ solution (100 μL) of [Pd(²H)(MeCN)(PCy₃)₂][B(C₆F₅)₄] (d₁-Pd 1388; 0.5 mg, 3.5×10⁻⁷ mol). Both vials were sealed and set to stir at ambient temperature (21° C.). After 24 hours the solution in vial 69a was noticeably more viscous than that in vial 69b. Both samples were placed in a 130° C. oven for 1 hour. Both samples cured to a solid mass.

### Example 70

### Preparation of trans-[(P-i-Pr₃)₂Pd(H)(MeCN)][B(C₆F₅)₄]

trans-[(P-i-Pr₃)₂Pd(H)Cl] (292 mg, 0.630 mmol) was stirred in acetonitrile (6.0 mL) and cooled to −35° C. To this suspension was slowly added a chilled solution (−35° C.) of [Ag(toluene)₃][B(C₆F₅)₄] (683 mg, 0.642 mmol) in dichloromethane (6.0 mL). The resulting reaction mixture within 15 min afforded a precipitate (presumably AgCl) and was stirred for additional 2 h at room temperature. This solution was then filtered through a 0.45 μm filter, and the volatileswere removed under vacuum to furnish 723 mg of trans-[(P-i-Pr₃)₂Pd(H)(MeCN)][B(C₆F₅)₄] in quantitative yield (99%). Anal. Calcd. for C₄₄H₄₆NP₂PdBF₂₀: C, 46.04; H, 4.04; N, 1.22%. Found: C, 45.88; H, 3.71; N, 1.02. ³¹P{1H} NMR (CDCl₃): δ 55.5. ¹H NMR (CDCl₃): δ-15.26 (t, ²JPH=7.35 Hz, 1H, PdH), 1.23 (m, 36H, CH(CH₃)₂), 2.14-2.26 (m, 6H, CHMe₂), 2.28 (s, 3H, CH₃CN). ¹³C{¹H} NMR (CDCl₃): δ 2.5, 20.2, 24.9 (virtual t, ¹J_{CP}+³J_{CP}=11.0 Hz), 124.0 (br), 125.3, 136.4 (d, ¹J_{CF}=238.3 Hz), 138.4 (d, ¹J_{CF}=239.7 Hz), 148.4 (d, ¹J_{CF}=236.5 Hz).

### Examples 71-74

### Preparation and Reactivity of Arsine Derivatives

### Example 71

### Pd(As-i-Pr₃)₂(O₂CCH₃)₂

Triisopropyl arsine (As-i-Pr₃) was prepared by the method of Dyke, W. J. C.; Jones, W. J. (J. Chem. Soc. 1930, 2426-2430). The reaction of AsCl3 (21.6 mmol) with i-PrMgCl (76 mmol) in diethyl ether and distilled in vacuo (b.p. 37° C./3 mmHg), 2.90 g, 65.7% yield. ¹H NMR (CDCl₃): δ 1.18 ppm (d, 18H, CH₃, JHH=7.2 Hz); δ 1.86 (m, 3H, CH).

To a stirred chloroform solution (10 mL) of Pd(OAc)₂ (0.229 g, 1.20 mmol), As-i-Pr₃ (0.420 g, 2.06 mmol) was added under a nitrogen atmosphere and stirred for 1 hour. The solvent was removed in vacuo, and the residue was washed with hexanes. 0.630 g (97.5%) pale yellow powder was obtained. ¹H NMR (400 MHz, CDCl₃): δ 1.41 ppm (d, 36H, CH₃); δ 2.26 (m, 6H, CH); δ 1.79 (s, 6H, CH₃COO).

### Example 72

### Pd(As-i-Pr₃)₂(κ²-O₂CCH₃)₂)][(B(C₆F₅)₄

Pd(As-i-Pr₃)₂(O₂CCH₃)₂ (0.321 g, 0.507 mmol) and p-toluenesulfonic acid (HOTs) (0.102 g, 0.536 mmol) were dissolved by 10 mL dichloromethane. The mixture was stirred under nitrogen at room temperature for 22 hours. 5 mL dichloromethane solution of Li(Et₂O)_{2.5}[B(C₆F₅)₄] (0.470 g, 0.539 mmol) was added, and keep stirring for 15 min at room temperature. Precipitated salt LiOAc was filtered out and the volatiles were removed in vacuo. The sticky residue was washed with hexanes and diethyl ether; 0.175 g (yield 28%) bright yellow powder product was collected after filtration and dried in vacuo. ¹H NMR (400 MHz, CDCl₃): δ 1.47 ppm (d, 36H, CH₃); δ 2.50 (m, 6H, CH); δ 2.03 (s, 3H, CH₃COO), CH).

### Example 73

### Pd(As-i-Pr₃)₂(O₂CCH₃)(NCCH₃)][(B(C₆F₅)₄

Pd(OAc)₂(As-i-Pr₃)₂ (0.191 g, 0.302 mmol) and Li(Et₂O)_{2.5}[B(C₆F₅)₄] (0.263 g, 0.302 mmol) were dissolved in CH₃CN of 10 mL. Reaction mixture was stirred for 4 hours at room temperature under nitrogen atmosphere, and then the solvent was removed in vacuo to afford the product, as brown, very sticky oil. This residue was washed with 2×3 mL hexanes, and then dried in vacuo, giving a dry, yellow powder, 0.354 g (91%). ¹H NMR (400 MHz, CDCl₃): δ 1.43 ppm (d, 36H, CH₃); δ 2.45 (m, 6H, CH); δ 1.92 (s, 3H, CH₃COO), δ 2.35 (s, 3H, CH₃CN).

### Example 74

### Polymerization of Decylnorbornene/Trimethoxysilylnorbornene

A solution of [Pd(As-i-Pr₃)₂(O₂CCH₃)(NCCH₃)][(B(C₆F₅)₄] (0.0005 g) in CH₂Cl₂ (0.1 mL) was added to a pan containing a mixture of decylnorbornene (1.63 g) and trimethoxysilylnorbornene (0.37 g) and heated to 130° C., the resulting mixture formed a gel within 4 minutes. After 1 hour a solid mass was obtained. A sample of the solution was also heated from room temperature to 300° C. at a rate of 10° C./minute and ΔH and peak temperature measured using a Differential Scanning Calorimeter (DSC). The results of the DSC experiment ΔH=200.8 J/g; Peak Temp=89.0° C.

### Example 75

### trans-[Pd(CH₃)(P(i-Pr)₃)₂(NCCH₃)][FABA]

In a N₂-filled flask a grey suspension of Pd(CH₃)Cl(PⁱPr₃)₂ (0.29 g, 0.61 mmol) in CH₃CN (20 mL) was set to stir as a CH₃CN solution (10 mL) of Ag(toluene)₂[B(C₆F₅)₄] (0.59 g, 0.61 mmol) was added resulting in an immediate clearing and reformation of grey solids. The suspension was allowed to stir for 15 minutes and then filtered through a 0.45 μm Teflon filter and the pale yellow filtrate reduced dryness affording an off-white foam. Yield 0.43 g (62%). 31P NMR (CD₂Cl₂) δ=40.2 ppm.

### Thermolysis Experiments

### Example 76

### trans-[Pd(OAc)(P(R)₃)₂(MeCN)][B(C₆F₅)₄] (R=Cy, i-Pr)

trans-[Pd(OAc)(P(Cy)₃)₂(MeCN)][B(C₆F₅)₄](26.5 mg, 0.0183 mmol) and trans-[Pd(OAc)(P(i-Pr)₃)₂(MeCN)][B(C₆F₅)₄] (22.2 mg, 0.0184 mmol) were dispersed in C₆D₆ (0.6 mL) in Wilmad Young valve NMR tubes (tubes 75A and 75B, respectively). The contents of each NMR tube were heated to 58-62° C., cooled to room temperature, and ³¹P and ¹H NMR recorded after 3 and 18 hour time intervals. Tubes 75A and 75B contained the hydride of each proinitiator species confirming that the titled proinitiators underwent thermolysis to form a palladium hydride.

### Example 77

### In Situ Generation of cis-[(P(i-Pr)₃)Pd(κ²-P,C—P(i-Pr₂)CMe₂) (CD₃CN)][B(C₆F₅)₄]

Complex [Pd (κ²-O,O′—OAc)(P(i-Pr)₃)₂][B(C₆F₅)₄] (55 mg, 47 μmol) was dissolved in acetonitrile-d₃ (0.79 mL) in air and stored in the same solvent until cyclometalation was complete as revealed by ³¹P NMR spectroscopy. Subsequently, acetonitrile-d₃ was removed under vacuum to furnish the oil. NMR (¹H and ³¹P) spectrum of the above oil reveal the presence of starting material and cis-[(P(i-Pr)₃)Pd(κ²-P,C—P(i-Pr₂)CMe₂) (CD₃CN)][B(C₆F₅)₄] in approximately 70 and 30% yield. Thus, thne formation of metallated species from [Pd(κ²-O,O′—OAc) (P(i-Pr)₃)₂][B(C₆F₅)₄] can occur at mild temperature and conditions. Likewise, an equivalent sample of [Pd(κ²-O,O′—OAc)(P(i-Pr)₃)₂][B(C₆F₅)₄] dissolved in d₈-THF in the presence of 1 eq. of CH₃CN converted to cis-[(P(i-Pr)₃)Pd(κ²-P,C—P(i-Pr₂)CMe₂)(CD₃CN)][B(C₆F₅)₄] at room temperature.

### Example 78

### Thermolysis of trans-[Pd(P(i-Pr)₃)₂(OAc)(MeCN)][B(C₆F₅)₄]

trans-[Pd(P(i-Pr)₃)₂(OAc)(MeCN)][B(C₆F₅)₄] (40 mg) was dissolved in dried and deoxygenated tetrahydrofuran-d₈ (0.79 mL) under nitrogen. The tube was then heated at 55° C. and the thermolysis reaction continuously monitored by ³¹P NMR spectroscopy for 120 minutes. Through the course of the reaction, the signal for trans-[Pd(P(i-Pr)₃)₂(OAc)(MeCN)][B(C₆F₅)₄] disappears with the concomitant formation of a signal attributable to the formation of mixed palladium hydride species of E, F, and G of FIG. 1. Additionally, a small signal for transient intermediates of [Pd(κ²-O,O′—OAc)(P(i-Pr)₃)₂][B(C₆F₅)₄] (<2%) (C in FIG. 1, Example 13) and trans-[Pd(CH₃)(P(i-Pr)₃)₂(NCCH₃)][FABA] (≦15%) (I in FIG. 1, (Example 74)). The overall conversion of trans-[Pd(P(i-Pr)₃)₂(OAc)(MeCN)][B(C₆F₅)₄] to a mixture of the hydride species (E, F, and G) was approximately 50%.

### Example 79

### Conversion of cis-[(P(i-Pr)₃)Pd(κ²-P,C—P(i-Pr₂)CMe₂)(CD₃CN)][B(C₆F₅)₄] to trans-[(P(i-Pr)₃(P-i-Pr₂(isopropenyl)Pd(H)(MeCN)][B(C₆F₅)₄]

Complex cis-[(P(i-Pr)₃)Pd(κ²-P,C—P(i-Pr₂)CMe₂) (CD₃CN)][B(C₆F₅)₄ (40 mg) was dissolved in chloroform-d₃ (1 mL) under nitrogen. At room temperature, the complex converted quantitatively from starting material into a new hydride species trans-[(P(i-Pr)₃)(P(i-Pr)₂(isopropenyl)Pd(H) (MeCN)][B(C₆F₅)₄] (³¹P{¹H} NMR (CDCl₃): δ 52.53 and 46.45 (J_{P-P}=320 Hz)) (Complex E in FIG. 1). The proton NMR exhibited an AB pattern at δ-15.25 ppm with analogous new vinylic resonances in the region of 5.90 to 5.60 confirming that a propenyl group was generated via a β-hydride elimination to generate a bound isopropenyldiisopropylphosphine ligand. Further monitoring of the reaction lead to a broadening of the resonances in both the ³¹P and ¹H spectra indicating that phosphine exchange was occurring. The intensity of the signal for the Pd—H resonance (ca. δ15.2 ppm) remained constant during the experiment indicating there was no depletion of the product.

### Example 80

### Conversion of [Pd(κ²-O,O′—OAc)(P(i-Pr)₃)₂][B(C₆F₅)₄] to Cationic Palladium Hydride Species

Complex [Pd(κ²-O,O′—OAc)(P(i-Pr)₃)₂][B(C₆F₅)₄] (40 mg) was dissolved in tetrahydrofuran-d₈ (1 mL) containing 1 equivalent of acetonitrile under nitrogen. The solution was heated to 55° C. and monitoring the reaction by ³¹P NMR, the presence of cis-[Pd(κ²-P,C—P(i-Pr)₂(C(CH₃)₂)(P(i-Pr)₃)(MeCN)][B(C₆F₅)₄] was observed and the mixture converted into a mixture of palladium hydride species, E, F, and G in FIG. 1 in approximately 50% yield after 180 minutes. The product was characterized by a Pd—H resonance with a single phosphorus signal at δ 56.8 ppm (singlet) and a broad proton signal at δ-15.2 ppm

### Example 81

### Conversion of [Pd(O₂CCMe₃)(P(i-Pr)₃)₂(NCCH₃)][B(C₆F₅)₄] to Cationic Palladium Hydride Species

Complex [Pd(O₂CCMe₃)(P(i-Pr)₃)₂(NCCH₃)][B(C₆F₅)₄] (40 mg) was dissolved in tetrahydrofuran-d₈ (1 mL) under nitrogen. The solution was heated to 55° C. and monitoring the reaction by ³¹P NMR. During 180 minutes of heating, the presence of [Pd(κ²-O,O′—CMe₃)(P(i-Pr)₃)₂][B(C₆F₅)₄] was observed and the mixture was fully converted into a mixture of palladium hydride species, E, F, and G in FIG. 1 in approximately 55% yield. The product was characterized by a Pd—H resonance with a single phosphorus signal at δ 56.2 ppm (singlet) and a broad proton signal at δ-15.4 ppm.

### Examples 82a and 82b

### Latency Comparison of Pyridine- vs. Acetonitrile-Supported Proinitiators

Two vials were charged an 80:20 (mol %) mixture of decylnorbornene and trimethoxysilylnorbornene (2 g, 8.7 mmol) and a magnetic stir bar. Into the first vial (82a) was added a CH₂Cl₂ solution (100 μL) of [Pd(P-i-Pr₃)₂(OAc)(MeCN)][B(C₆F₅)₄] (Pd 1206; 0.4 mg, 3.5×10-7 mol) while to the other (82b) was added a CH₂Cl₂ solution (100 μL) of [Pd(P-i-Pr₃)₂(OAc)(NC₅H₅)][B(C₆F₅)₄] (0.4 mg, 3.5×10-7 mol). The vials were sealed and set to stir at ambient temperature (21° C.). After 70 hours, Example 82a was much more viscous than Example 82b. A sample of each vial was also heated from room temperature to 300° C. at a rate of 10° C./minute and ΔH, on-set and peak temperature measured using a Differential Scanning Calorimeter (DSC). The remainder of each sample was placed in a 130° C. oven for 1 hour and cured to a solid mass.

| | On-set Temp. | | |
|---|---|---|---|
| Example | (° C.) | ΔH (J/g) | Peak Temp. (° C.) |
| 82a | 68 | 216.8 | 109.8 |
| 82b | 88 | 195.0 | 126.3 |

This comparative example demonstrates that the pot life in formulations can be extended by the selection of an appropriate Lewis base.

### Example 83a and 83b

### Latency Comparison of Pyridine- vs. Acetonitrile-Supported Metalated Proinitiators

Two vials were charged an 80:20 (mol %) mixture of decylnorbornene and trimethoxysilylnorbornene (2 g, 8.7 mmol) and a magnetic stir bar. Into the first vial (83a) was added a CH₂Cl₂ solution (100 μL) of [(P-i-Pr₃)Pd(κ²-P,C—P-i-Pr₂CMe₂)(NC₅H₅)][B(C₆F₅)₄] (0.4 mg, 3.5×10⁻⁷ mol) while to the other (83b) was added a CH₂Cl₂ solution (100 μL) of [(P-i-Pr₃)Pd(κ²-P,C—P-i-Pr₂CMe₂)(CH₃CN)][B(C₆F₅)₄] (0.4 mg, 3.5×10 ⁻⁷ mol). Both vials were sealed and set to stir at ambient temperature (21° C.). After 23 hours, Example 83b was much more viscous than Example 83a After 70 hours, Example 83b was barely flowing while Example 83a flowed freely. A sample of each of vial was also heated from room temperature to 300° C. at a rate of 10° C./minute and ΔH, on-set and peak temperature measured using a Differential Scanning Calorimeter (DSC). The remainder of each sample was placed in a 130° C. oven for 1 hour and cured to a solid mass.

| | On-set Temp. | | |
|---|---|---|---|
| Example | (° C.) | ΔH (J/g) | Peak Temp. (° C.) |
| 83a | 82 | 226.2 | 139.9 |
| 83b | 38 | 232.5 | 114.3 |

This comparative example demonstrates that the pot life in formulations can be extended by the selection of an appropriate Lewis base.

By now it should be realized that embodiments in accordance with the present invention have been described that are advantageous one part, latent catalyst systems (i.e., a single component proinitiator in monomer that can be triggered to start substantial polymerization). Additionally, it should be realized that embodiments of the present invention have been described that also provide methods for forming such one part, latent catalyst systems, and that such catalyst systems are useful for both mass and solution polymerizations.

It has also been seen that such catalyst system embodiments of the present invention have considerable advantages over currently known two part systems for mass polymerization in that these systems do not require the mixing multiple parts (Examples 44-47, among others) and could be dispensed over a longer period of time without significant viscosity change (Example 51, among others). In addition, such a one part system would not suffer from the attendant difficulties associated with the formulation of two separate parts, errors in mixing those parts just prior to use, and the potentially excessive waste that results when the working life of the mixture expires before the amount mixed is consumed. It should also be apparent that an isolable, latent proinitiator for use in solvent polymerization systems can be advantageous (Examples 36-39, among others). For example, such an isolable proinitiator could be made in large quantities thus reducing manufacturing costs, and its activity could be determined before its use to initiate a polymerization thereby reducing the cost of the desired polymer by eliminating the need to employ excess initiator to insure the desired conversion ratio. Further, such a single component proinitiator would allow for better control of metered polymerizations. Accordingly, there is a need for such a single component latent proinitiator system to at least provide the advantages mentioned above.

Finally, it shold be realized that the catalyst systems in accordacne with the present invention are useful for preparing polymers for a broad range of applications and or uses. Such applications include, but are not limited to, microelectronic, optoelectronic and optical applications, and include molded and otherwise formed constructs and/or devices where at least a portion of the constructs/devices are formed from a polymer that utilizes the catalyst systems of the present invention.

Such microelectronic applications/uses include, but are not limited to, dielectric films (i.e., multichip modules and flexible circuits), chip attach adhesives, underfill adhesives, chip encapsulants, glob tops, near hermetic board and chip protective coatings, embedded passives, laminating adhesives, capacitor dielectrics, high frequency insulator/connectors, high voltage insulators, high temperature wire coatings, conductive adhesives, reworkable adhesives, photosensitive adhesives and dielectric film, resistors, inductors, capacitors, antennas and printed circuit board substrates. As known to the art and to the literature, the definition of a chip includes an “integrated circuit” or “a small wafer of a semiconductor material that forms the base for an integrated circuit”, Mirriam Webster's Collegiate Dictionary, 10th Ed, 1993, Merriam-Webster, Inc., Springfield, Mass., USA. Thus the above electronic applications such as multichip modules, chip encapsulants, chip protective coatings, and the like relate to semiconductor substrates or components and/or to integrated circuits containing the optical polymers of the present invention which encapsulate the same, coat the same, and the like. The optical coating or encapsulant thus readily serves as a covering or packaging material for a chip or an integraed circuit, or a semiconductor, which is a part of an optical semiconductor component.

In optical applications, uses include but are not limited to optical films, ophthalmic lenses, wave guides, optical fiber, photosensitive optical film, specialty lenses, windows, high refractive index film, laser optics, color filters, optical adhesives, and optical connectors. Other optical applications include the use of the above copolymers as coatings, encapsulants, and the like for numerous types of light sensors including, but not limited to, charge coupled device (CCD) image sensors, and complimentary metal oxide semi-conductors (CMOS) as well as imaging CMOS (IMOS). IMOS can be utilized to encapsulate arrays of chips, semiconductors, and the like. As known to the art and to the literature, sensors can generally be described as devices which have an optical component, in the path of a light source, which transmits light thereto to a converter which transmits light patterns, color, and the like to electronic signals which can be sent and stored on a processor or computer. Other end uses include sensors such as for cameras, for eample web and digital, and surveillance, sensors for telescopes, microscopes, various infra-red monitors, bar code readers, personal digital assistants, image scanners, digital video conferencing, cellular phones, electronic toys, and the like. Other sensor uses include various biometric devices such as iris scanners, retina scanners, finger and thumb print scanners, and the like.

Other optical end uses include various light emitting diodes which are coated, encapsulated, etc. with the optical cycloolefin polymer. Exemplary LEDs include visible light LEDs, white light LEDs, ultraviolet light LEDs, laser LEDs, and the like. Such LEDs can be utilized for lighting systems in automobiles, a backlight source in displays, for general illumination, replacement of light bulbs, traffic lights and the like.

1. A composition of matter comprising a palladium compound represented by the Formula Ia or Ib:
[(E(R)₃)ₐPd(Q)(LB)_{b}]ₚ[WCA]ᵣ (Ia)
[(E(R)₃)(E(R)₂R*)Pd(LB)]ₚ[WCA]ᵣ (Ib)
where E(R)₃ is a Group 15 neutral electron donor ligand where E is selected from a Group 15 element of the Periodic Table of the Elements, each R independently is hydrogen, deuterium or an anionic hydrocarbyl containing moiety; R* is an anionic hydrocarbyl containing moiety bonded to Pd and having a β hydrogen with respect to the Pd, Q is an anionic ligand selected from a carboxylate, thiocarboxylate, and dithiocarboxylate group; LB is a Lewis base; WCA represents a weakly coordinating anion; a represents an integer of 1, 2, or 3; b represents an integer of 0, 1, or 2, where the sum of a+b is 1, 2, or 3; and p and r are integers appropriately selected to balance the electronic charge of the compound.

2-4. (canceled)

5. The palladium compound of claim 1, where E is phosphorus (P) or arsenic (As) and each R is a linear and branched (C₁-C₂₀) alkyl, (C₃-C₁₂) cycloalkyl, (C₂-C₁₂) alkenyl, (C₃-C₁₂) cycloalkenyl, (C₅-C₂₀) poly-cycloalkyl, (C₅-C₂₀) polycycloalkenyl or (C₆-C₁₂) aryl group.

6. The palladium compound of claim 5, where R* is a linear and branched (C₂-C₂₀) alkyl, (C₃-C₁₂) cycloalkyl, (C₂-C₁₂) alkenyl, (C₃-C₁₂) cycloalkenyl, (C₅-C₂₀) polycycloalkyl or (C₅-C₂₀) polycycloalkenyl group.

7. (canceled)

8. The palladium compound of claim 1, where the neutral electron donor ligand E(R₃) is di-t-butylcyclohexylphosphine, dicyclohexyl-t-butylphosphine, tricyclohexylphosphine, tricyclopentylphosphine, dicyclohexyl-adamantylphosphine, cyclohexyldiadamantylphosphine, triisopropylphosphine, di-tertbutylisopropylphosphine, or diisopropyl-tert-butylphosphine.

9-10. (canceled)

11. The palladium compound of claim 1, where the neutral electron donor ligand E(R₃) is tricyclohexylarsine, tricyclopentylarsine, di-t-butyl-cyclohexylarsine, dicyclohexyl-t-butylarsine, triisopropylarsine, di-tert-butylisopropyl arsine, or diisopropyl-tert-butylarsine.

12-19. (canceled)

20. The palladium compound of claim 1, where Q is a carboxylate anion represented by the formulae: 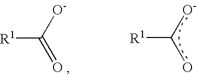
where R¹ is independently hydrogen, linear and branched C₁-C₂₀ alkyl, C₁-C₂₀ haloalkyl, substituted and unsubstituted C₃-C₁₂ cycloalkyl, substituted and unsubstituted C₂-C₁₂ alkenyl, substituted and unsubstituted C₃-C₁₂ cycloalkenyl, substituted and unsubstituted C₅-C₂₀ polycycloalkyl, substituted and unsubstituted C₆-C₁₄ aryl, and substituted or unsubstituted C₇-C₂₀ aralkyl.

21. The palladium compound of claim 20, where R¹ is methyl, trifluoromethyl, propyl, isopropyl, butyl, tert-butyl, isobutyl, neopentyl, cyclohexyl, norbornyl, adamantyl, phenyl, pentafluorophenyl, or benzyl and where Q is CH₃CO₂— or Me₃CCO₂—.

22-24. (canceled)

25. The palladium compound of claim 5, where Q is a carboxylate anion represented by the formulae: 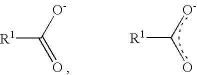
where R¹ is independently hydrogen, linear and branched C₁-C₂₀ alkyl, C₁-C₂₀ haloalkyl, substituted and unsubstituted C₃-Cl₂ cycloalkyl, substituted and unsubstituted C₂-C₁₂ alkenyl, substituted and unsubstituted C₃-C₁₂ cycloalkenyl, substituted and unsubstituted C₅-C₂₀ polycycloalkyl, substituted and unsubstituted C₆-C₁₄ aryl, and substituted or unsubstituted C₇-C₂₀ aralkyl.

26-29. (canceled)

30. The palladium compound of claim 1, where the Lewis base is water, dimethyl ether, diethyl ether, tetrahydrofuran, dioxane, acetone, benzophenone, acetophenone, methanol, isopropanol, benzonitrile, adamantane carbonitrile, tert-butylnitrile, tert-butylisocyanide, xylylisocyanide, dimethyl-aminopyridine, 4-dimethyl-aminopyridine, tetramethylpyridine, 4-methylpyridine, tetramethylpyrazine, triisopropyl-phosphite, triphenylphosphite or triphenyl-phosphine oxide.

31-32. (canceled)

33. The palladium compound of claim 1, where the weakly coordinating anion is a borate, an aluminate or a triflimide anions.

34. The palladium compound of claim 33, where the weakly coordinating anion is a borate or aluminate of the formulae:
[M(R¹⁰)(R¹¹)(R¹²)(R¹³)] or [M(OR¹⁴)(OR¹⁵)(OR¹⁶)(OR¹⁷)]
where M is boron or aluminum and R¹⁰, R¹¹, R¹², and R¹³ independently represent fluorine, linear and branched C₁-C₁₀ alkyl, linear and branched C₁-C₁₀ alkoxy, linear and branched C₃-C₅ haloalkenyl, linear and branched C₃-C₁₂ trialkylsiloxy, C₁₈-C₃₆ triarylsiloxy, substituted and unsubstituted C₆-C₃₀ aryl, and substituted and unsubstituted C₆-C₃₀ aryloxy groups where R¹⁰ to R¹³ can not simultaneously represent alkoxy or aryloxy groups and where R¹⁰ to R¹³ is a substituted aryl or aryloxy group, such group can be monosubstituted or multisubstituted, where the substituents are independently a linear and branched C₁-C₅ alkyl, linear and branched C₁-C₅ haloalkyl, linear and branched C₁-C₅ alkoxy, linear and branched C₁-C₅ haloalkoxy, linear and branched C₁-C₁₂ trialkylsilyl, C₆-C₁₈ triarylsilyl, chlorine, bromine, iodine and fluorine; and R¹⁴, R¹⁵, R¹⁶, and R¹⁷ are independently a linear and branched C₁-C₁₀ alkyl, linear and branched C₁-C₁₀ haloalkyl, C₂-C₁₀ haloalkenyl, substituted and unsubstituted C₆-C₃₀ aryl, and substituted and unsubstituted C₇-C₃₀ aralkyl groups, subject to the proviso that at least three of R¹⁴ to R¹⁷ contain a halogen containing substituent, and when R¹⁴ to R¹⁷ is a substituted aryl or aryloxy group, such group can be monosubstituted or multisubstituted, where the substituents are a linear and branched C₁-C₅ alkyl, linear and branched C₁-C₅ haloalkyl, linear and branched C₁-C₅ alkoxy, linear and branched C₁-C₁₀ haloalkoxy, chlorine, bromine, and fluorine, and where OR¹⁴ and OR¹⁵ can be taken together to form a chelating substituent represented by —O—R¹⁸—O—, where the oxygen atoms are bonded to M, and R¹⁸ is a divalent radical such as a substituted and unsubstituted C₆-C₃₀ aryl and substituted and unsubstituted C₇-C₃₀ aralkyl.

35. The weakly coordinating anion (WCA) of claim 34 where when M is boron, such WCA is tetrakis(pentafluorophenyl)borate or tetrakis(3,5-bis (trifluoromethyl)phenyl)borate.

36-37. (canceled)

38. The weakly coordinating anion (WCA) of claim 34 where when M is aluminum, such WCA is tetrakis(pentafluorophenyl)aluminate or tetrakis(3,5-bis(trifluoromethyl)phenyl)aluminate.

39-41. (canceled)

42. The palladium compound of claim 33, where the weakly coordinating anion is bis(trifluoromethylsulfonyl)imide, triflimide ([N(S(O)₂C₄F₉)₂]⁻), bis(pentafluoroethanesulfonyl)imide ([N(S(O)₂C₂F₅)₂]⁻), or 1,1,2,2,2-pentafluoroethane-N-[(trifluoromethyl)sulfonyl]sulfonamide ([N(S(O)₂CF₃)(S(O)₂C₄F₉)]⁻).

43. (canceled)

44. The palladium compound of claim 1, where [(E(R)₃)ₐPd(Q)(LB)_{b}]ₚ[WCA] is:
[Pd(OAc)(P(Cy)₃)₂(MeCN)][B(C₆F₅)₄],
[Pd(OAc)(P(Cy)₂(CMe₃))₂(MeCN)][B(C₆F₅)₄],
[Pd(OAc)(P(i-Pr)(CMe₃)₂)₂(MeCN)][B(C₆F₅)₄],
[Pd(OAc)₂(P(i-Pr)₂(CMe₃))₂(MeCN)][B(C₆F₅)₄],
[Pd(OAc)(P(i-Pr)₃)₂(MeCN)][B(C₆F₅)₄],
[Pd(O₂C-t-Bu)(P(Cy)₃)₂(MeCN)][B(C₆F₅)₄],
[Pd(O₂C-t-Bu)(P(Cy)₂(CMe₃))₂(MeCN)][B(C₆F₅)₄],
[Pd(O₂C-t-Bu)₂(P(i-Pr)₂(CMe₃))₂,
[Pd(O₂C-t-Bu)(P(i-Pr)₃)₂(MeCN)][B(C₆F₅)₄],
[Pd(OAc)(P(Cp)₃)₂(MeCN)][B(C₆F₅)₄],
[Pd(O₂C-t-Bu)(P(Cp)₃)₂(MeCN)][B(C₆F₅)₄].

45-46. (canceled)

47. The palladium compound of claim 1, where
[(E(R)₃)(E(R)₂R*)Pd(LB)]ₚ[WCA]ᵣ is
[Pd(P-(i-Pr)₃)(κ²—P,C—P(-i-Pr)₂(C(CH₃)₂)(acetonitrile)][B(C₆F₅)₄],
[Pd(P-(i-Pr)₃)(κ²—P,C—P(-i-Pr)₂(C(CH₃)₂)(pyrazine)][B(C₆F₅)₄],
[Pd(P-(i-Pr)₃)(κ²—P,C—P(-i-Pr)₂(C(CH₃)₂)(pyridine)][B(C₆F₅)₄.

48-49. (canceled)

50. A method for forming a palladium proinitiator complex comprising:
providing a palladium complex of the formula:
Pd(ER₃)ₐ(Q)_{b}
where E is an element from Group 15 of the Periodic Table of Elements, each R is independently hydrogen, deuterium or an anionic hydrocarbyl containing moiety, Q is an anionic ligand, a is 1, 2 or 3 and b is 1 or 2; and
mixing a weakly coordinating anion (WCA) salt with the palladium complex at a first temperature for a first period of time to react therewith.

51. (canceled)

52. The method of claim 50 where E is phosphorus and Q is a carboxylate anion.

53-54. (canceled)

55. The method of claim 50 where E is phosphorus, Q is a carboxylate anion and each R is independently a cyclohexyl group or an isopropyl group.

56-61. (canceled)

62. A method for solution polymerization of norbornene-type monomers, comprising:
providing a first solution, the first solution comprising a single component palladium complex represented by [(E(R)₃)ₐPd(Q)(LB)_{b}]ₚ[WCA]ᵣ or [(E(R)₃)(E(R)₂R*)Pd(LB)]ₚ[WCA]ᵣ dissolved in a first liquid carrier material;
providing a second solution, the second solution comprising one or more norbornene-type monomers dissolved in a second liquid carrier material;
combining the first and second liquid carrier materials in a reaction vessel and heating the combined liquid carrier materials in the reaction vessel to a first temperature for a period of time, the first temperature sufficient to cause polymerization of the one or more monomers in the presence of the palladium complex; and
after the period of time, isolating the product of the polymerization.

63. A method for mass polymerization of norbornene-type monomers, comprising:
providing a solution comprising a single component palladium complex represented by [(E(R)₃)ₐPd(Q)(LB)_{b}]ₚ[WCA]ᵣ or [(E(R)₃)(E(R)₂R*)Pd(LB)]ₚ[WCA]ᵣ dissolved in a liquid carrier material;
providing one or more norbornene-type monomers;
adding the solution to the monomers to form a polymerizable mixture; and
heating the mixture to a first temperature for a period of time, the first temperature sufficient to cause polymerization of the one or more monomers in the presence of the palladium complex.

64. (canceled)

65. A norbornene-type polymer forming composition comprising a single component palladium complex represented by [(E(R)₃)ₐPd(Q)(LB)_{b}]ₚ[WCA]ᵣ or [(E(R)₃)(E(R)₂R*)Pd(LB)]ₚ[WCA]ᵣ dissolved in a liquid carrier material; and
one or more types of norbornene-type monomers.

66. A microelectronic, optoelectronic or optical device comprising the polymer of claim 65.
